(19) United States
(12) Patent Application Publication
(10) Pub. No.: US 2022/0309566 A1
(43) Pub. Date: Sep. 29, 2022

(54) TECHNOLOGIES FOR SIMULATING A TRADESHOW EXPERIENCE OVER AN INDEFINITE TIME PERIOD

(71) Applicant: CampfireSocial Inc., Chicago, IL (US)

(72) Inventor: Erica L. Bishaf, Chicago, IL (US)

(21) Appl. No.: 17/672,096

(22) Filed: Feb. 15, 2022

Related U.S. Application Data
(60) Provisional application No. 63/165,239, filed on Mar. 24, 2021.

(51) Int. Cl. G06Q 30/06; G06Q 20/38; G06Q 30/02; G06Q 20/10; H04L 67/306

(52) U.S. Cl. CPC G06Q 30/0641; G06Q 20/386; G06Q 30/0269; G06Q 30/0256; G06Q 20/10; H04L 67/306

(57) ABSTRACT

Technologies for simulating a tradeshow experience over an indefinite time period may include a compute device. The compute device may include circuitry configured to obtain a set of roles for users to be associated with a platform for connections, content, and commerce. The roles may include a hosting organization, a vendor, and a professional. The circuitry may be further configured to present, in a user interface that includes a visual reference to the hosting organization, content items provided by the vendor to be viewed by one or more professionals.

### CROSS-REFERENCE TO RELATED APPLICATION

This application claims the benefit, under 35 U.S.C. § 119(e), of U.S. Provisional Patent Application No. 63/165,239, filed Mar. 24, 2021, the entirety of each of which is hereby expressly incorporated by reference herein.

### BACKGROUND

Professionals operating in a given industry benefit from networking with other professionals or vendors operating in the same or related industry. For example, a chief software architect for a company in the information technology (IT) industry may benefit from meeting software developers who may have experience or knowledge regarding a particular software development framework that the chief software architect is in charge of utilizing to build a software platform. Similarly, the chief software architect may benefit from meeting vendors of middleware usable to more efficiently build and deploy software. Likewise, vendors may benefit from meeting with professionals in their industry to learn about customer needs and industry trends, and potentially sell products or services to one or more of the professionals. Similar scenarios play out across virtually all other industries, such as electronic devices, industrial equipment, medical devices, and pharmaceuticals, to name just a few. Tradeshows, which are hosted by industry trade groups (also known as trade associations, business associations, sector associations, or industry bodies) associated with corresponding industries may facilitate interactions between professionals and vendors. However, tradeshows have many shortcomings, including their relatively short time span (e.g., typically less than a week) and requirement that people physically travel to a set location to participate.

### SUMMARY

According to one aspect of the present disclosure, a compute device may include circuitry configured to obtain a set of roles for users to be associated with a platform for connections, content, and commerce. The roles may include a hosting organization, a vendor, and a professional. The circuitry may be further configured to present, in a user interface that includes a visual reference to the hosting organization, content items provided by the vendor to be viewed by one or more professionals.

In another aspect of the present disclosure, a method may include obtaining, by a compute device, a set of roles for users to be associated with a platform for connections, content, and commerce. The roles may include a hosting organization, a vendor, and a professional. The method may additionally include presenting, by the compute device and in a user interface that includes a visual reference to the hosting organization, content items provided by the vendor to be viewed by one or more professionals.

In yet another aspect of the present disclosure, one or more computer-readable storage media may include a plurality of instructions that, when executed, cause a compute device to obtain a set of roles for users to be associated with a platform for connections, content, and commerce. The roles may include a hosting organization, a vendor, and a professional. The instructions may additionally cause the compute device to present, in a user interface that includes a visual reference to the hosting organization, content items provided by the vendor to be viewed by one or more professionals.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified diagram of at least one embodiment of a system for simulating a tradeshow experience over an indefinite time period;

FIG. 2 is a simplified block diagram of at least one embodiment of a server compute device of the system of FIG. 1;

FIGS. 3-9 are simplified block diagrams of at least one embodiment of a method for simulating a tradeshow experience over an indefinite time period that may be performed by the system of FIG. 1; and

FIGS. 10-69 are diagrams of user interfaces that may be provided by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

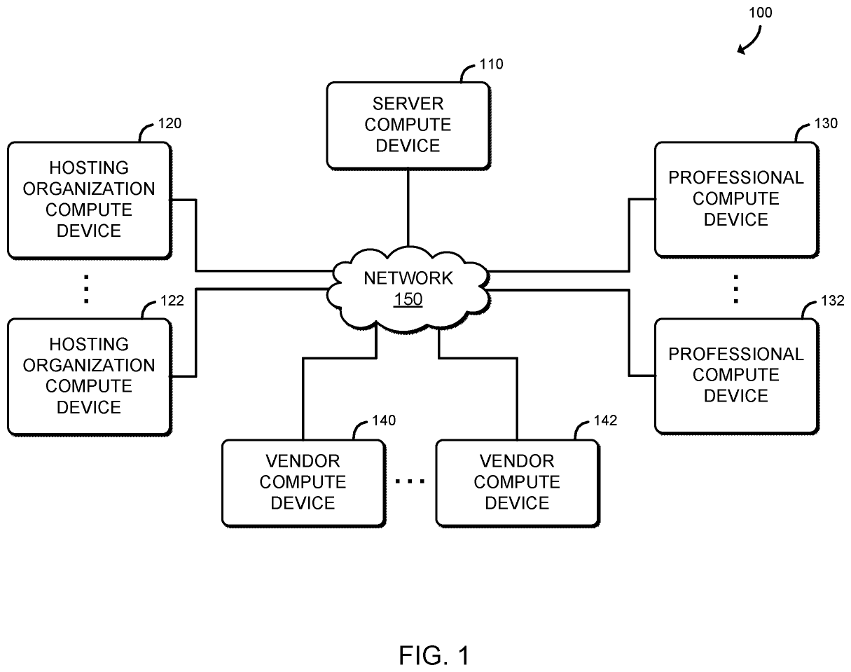

Referring now to FIG. 1, a system 100 for simulating a tradeshow experience includes a server compute device 110 (e.g., a rack-mounted server, a blade server, a desktop computer, etc.), a set of hosting organization compute devices 120, 122, a set of professional compute devices 130, 132, and a set of vendor compute devices 140, 142. Each compute device 120, 122, 130, 132, 140, 142 may be embodied as a desktop computer, laptop computer, tablet computer, notebook, netbook, cellular phone, smartphone, personal digital assistant, mobile Internet device, wearable computing device, hybrid device, and/or any other compute/communication device. While two hosting organization devices 120, 122 are shown for clarity and simplicity, the number of hosting organization devices may vary across embodiments and many number in the tens, hundreds, thousands, or more. Likewise, the number of professional compute devices and vendor compute devices may vary across embodiments. In operation, the system 100 functions as a platform on which a hosting organization (e.g., operating one of the hosting organization compute devices 120, 122) may host (e.g., organize, sponsor, etc.) a tradeshow experience in which professionals (e.g., users of the professional compute devices 130, 132) and vendors (e.g., users of the vendor compute devices 140, 142) may interact, to form connections, communicate, and perform commercial transactions. In the illustrative embodiment, the server compute device 110 performs operations to manage interactions (e.g., forming connections, communicating, performing commercial transactions) among the users, based on a set of defining characteristics provided by the hosting organization, to provide the benefits of a tradeshow that may last for an indefinite time period and that does not require users (e.g., professionals and vendors) to travel to a particular geographic location in order to receive those benefits.

In doing so, and as described in more detail herein, the server compute device 110 obtains data from the hosting organization indicative of roles (e.g., segments, such as professionals, vendors, staff, students, etc.) of users that are to participate in the simulated tradeshow. Further, in the illustrative embodiment, the server compute device 110 provides the tradeshow experience under white label associated with the hosting organization. That is, information (e.g., messages, user interfaces, etc.) provided to users (e.g., users of the professional compute devices 130, 132, the vendor compute devices 140, 142) associated with a particular simulated tradeshow includes references to the hosting organization (e.g., a visual reference, such as a logo of the hosting organization) to create the appearance that the tradeshow experience is provided by hosting organization. Furthermore, the server compute device 110 may concurrently provide multiple simulated tradeshow experiences, each associated with a corresponding hosting organization and set of professionals and vendors. In doing so and as discussed herein, the server compute device 110 “presents” or “provides” user interfaces to corresponding recipient compute devices (e.g., the compute devices 120, 122, 130, 132, 140, 142), by sending (e.g., through a network 150) one or more instructions to the recipient compute device to present the user interface. That is, the server compute device 110 may send data defining the user interface (e.g., Hypertext Transfer Markup Language (HTML), JavaScript, image data, video data, etc.) and/or a request for the recipient compute device to present the corresponding user interface. In some embodiments, the recipient compute device may present the user interface through a web browser while in other embodiments, the recipient compute device may present the user interface in a native application (e.g., an “app”) dedicated to interacting with the platform provided by the system 100.

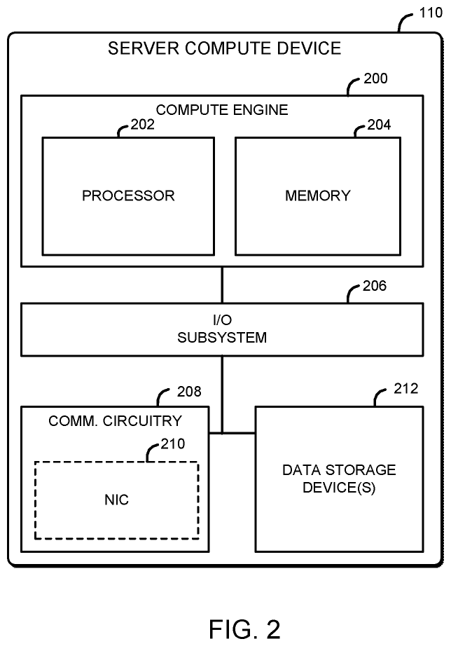

Referring now to FIG. 2, the illustrative server compute device 110 includes a compute engine 200, an input/output (I/O) subsystem 206, communication circuitry 208, and a data storage subsystem 212. Of course, in other embodiments, the server compute device 110 may include other or additional components, such as those commonly found in a computer (e.g., display, peripheral devices, etc.). Additionally, in some embodiments, one or more of the illustrative components may be incorporated in, or otherwise form a portion of, another component.

The compute engine 200 may be embodied as any type of device or collection of devices capable of performing various compute functions described below. In some embodiments, the compute engine 200 may be embodied as a single device such as an integrated circuit, an embedded system, a field-programmable gate array (FPGA), a system-on-a-chip (SOC), or other integrated system or device. Additionally, in some embodiments, the compute engine 200 includes or is embodied as a processor 202 and a memory 204. The processor 202 may be embodied as any type of processor capable of performing the functions described herein. For example, the processor 202 may be embodied as a single or multi-core processor(s), a microcontroller, or other processor or processing/controlling circuit. In some embodiments, the processor 202 may be embodied as, include, or be coupled to an FPGA, an application specific integrated circuit (ASIC), reconfigurable hardware or hardware circuitry, or other hardware to facilitate performance of the functions described herein.

The main memory 204 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 204 may be integrated into the processor 202. In operation, the main memory 204 may store various software and data used during operation such as user accounts, user profile data which may be embodied as any data indicative of characteristics of a user (e.g., professional interest(s), company name, job title, industry, geographic location, experience, professional accomplishments, etc.), connection data (e.g., which users are connected to each other), communications among users (e.g., posts, chat messages, etc.), user group data indicative of names of groups, professional interests associated with the groups, and users that are members of the groups, data usable for generating user interfaces, applications, libraries, and drivers.

The compute engine 200 is communicatively coupled to other components of the server compute device 110 via the I/O subsystem 206, which may be embodied as circuitry and/or components to facilitate input/output operations with the compute engine 200 (e.g., with the processor 202 and the main memory 204) and other components of the server compute device 110. For example, the I/O subsystem 206 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 206 may form a portion of a system-on-a-chip (SoC) and be incorporated, along with one or more of the processor 202, the main memory 204, and other components of the server compute device 110, into the compute engine 200.

The communication circuitry 208 may be embodied as any communication circuit, device, or collection thereof, capable of enabling communications over a communication link between the server compute device 110 and another device (e.g., a hosting organization compute device 120, 122, a professional compute device 130, 132, a vendor compute device 140, 142, etc.). The communication circuitry 208 may be configured to use any one or more communication technology (e.g., wired or wireless communications) and associated protocols (e.g., serial communication, Ethernet, Bluetooth®, Wi-Fi®, WiMAX, etc.) to effect such communication.

The illustrative communication circuitry 208 may include a network interface controller (NIC) 210. The NIC 210 may be embodied as one or more add-in-boards, daughter cards, network interface cards, controller chips, chipsets, or other devices that may be used by the server compute device 110 to connect with another device (e.g., a hosting organization compute device 120, 122, a professional compute device 130, 132, a vendor compute device 140, 142, etc.). In some embodiments, the NIC 210 may be embodied as part of a system-on-a-chip (SoC) that includes one or more processors, or included on a multichip package that also contains one or more processors. In some embodiments, the NIC 210 may include a local processor (not shown) and/or a local memory (not shown) that are both local to the NIC 210. In such embodiments, the local processor of the NIC 210 may be capable of performing one or more of the functions of the compute engine 200 described herein. Additionally or alternatively, in such embodiments, the local memory of the NIC 210 may be integrated into one or more components of the server compute device 110 at the board level, socket level, chip level, and/or other levels.

Each data storage device 212, may be embodied as any type of device configured for short-term or long-term storage of data such as, for example, memory devices and circuits, memory cards, hard disk drives, solid-state drives, or other data storage device. Each data storage device 212 may include a system partition that stores data and firmware code for the data storage device 212 and one or more operating system partitions that store data files and executables for operating systems.

While a single server compute device 110 is shown for simplicity, it should be understood that the server compute device 110 may be embodied as multiple compute devices or portions thereof (e.g., in a cloud data center). Further, it should be understood that one or more components of the server compute device 110 may be distributed across any distance, and are not necessarily housed in the same physical unit. Furthermore, one or more of the components of the server compute device 110 may be virtualized (e.g., in a virtual machine). The hosting organization compute devices 120, 122, the professional compute devices 130, 132, and the vendor compute devices 140, 142 may have components similar to those described with reference to the compute device 110. The description of those components of the server compute device 110 is equally applicable to the description of components of the compute devices 120, 122, 130, 132, 140, 142. Further, it should be appreciated that any of the server compute device 110 and the compute devices 120, 122, 130, 132, 140, 142 may include other components, sub-components, and devices commonly found in a computing device, which are not discussed above in reference to the server compute device 110 and not discussed herein for clarity of the description.

The server compute device 110, the hosting organization compute devices 120, 122, the professional compute devices 130, 132, and the vendor compute devices 140, 142 are illustratively in communication via a network 150. The network 150 may be embodied as any set of communication link(s) including local area networks (LANs) or wide area networks (WANs), digital subscriber line (DSL) networks, cable networks (e.g., coaxial networks, fiber networks, etc.), global networks (e.g., the Internet), cellular networks (e.g., Global System for Mobile Communications (GSM), 3G, Long Term Evolution (LTE), Worldwide Interoperability for Microwave Access (WiMAX), 4G, 5G, etc.), a radio access network (RAN), an edge network, or any combination thereof.

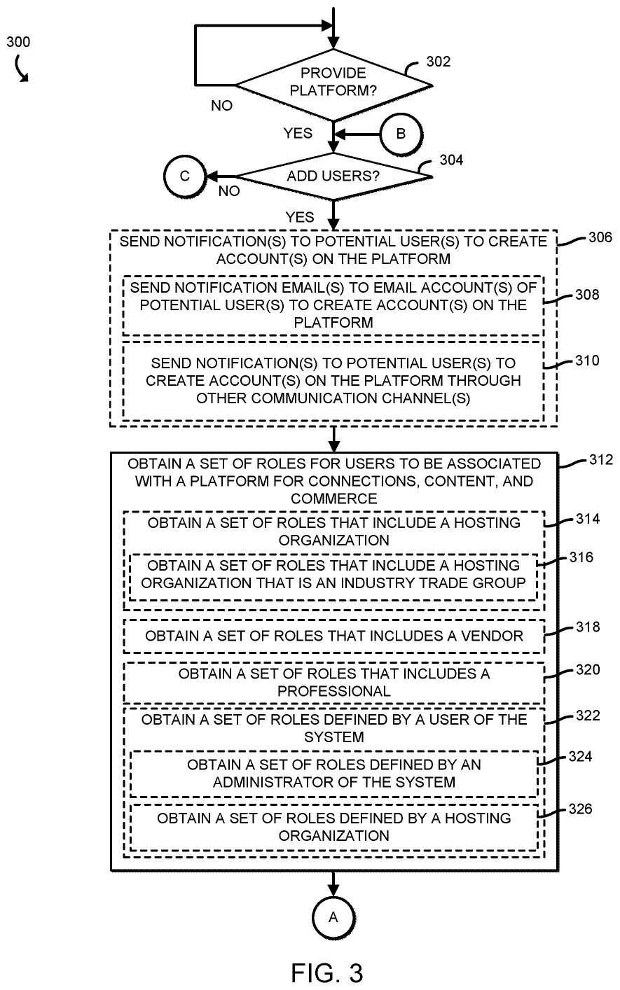

Referring now to FIG. 3, the system 100 (e.g., the server compute device 110) may perform a method 300 for simulating a tradeshow experience over an indefinite time period (e.g., to provide users the benefits of a tradeshow experience without the constraints of a relatively short time period or the requirement to physically meet at a designated geographic location). In the illustrative embodiment, the method 300 begins with block 302, in which the server compute device 110 determines whether to provide a platform to provide a simulated tradeshow experience (e.g., whether to perform the remaining operations of the method 300). In doing so, the server compute device 110 may determine whether a request to provide the platform has been received (e.g., from another compute device (not show)), whether a configuration setting (e.g., in a configuration file in the data storage 212) indicates to provide the platform, and/or based on other factors. Regardless, in response to a determination to provide the platform, the method 300 advances to block 304, in which the server compute device 110 determines whether to add one or more users. In doing so, the server compute device 110 may determine to add one or more users in response to a request to do so (e.g., from an administrator), in response to a potential user responding to an invitation to set up a user account, as described in more detail herein, and/or based on other factors.

In some embodiments, an administrator may establish placeholders for one or more user accounts by defining (e.g., through a user interface) an initial amount of account data (e.g., an identifier of a user, such as a name, and contact information, such as an email address, usable to send an initial notification to the potential user) for each potential user. Regardless, in response to a determination to add one or more users, the method 300 advances to block 306, in which the server compute device 110 may send one or more notifications to potential user(s) to create account(s) on the platform. In doing so, and as indicated in block 308, the server compute device 110 may send one or more notification emails to email accounts of potential users to create accounts on the platform. The emails may include a link (e.g., a uniform resource locator) that, when selected by a potential user (e.g., using a compute device 120, 122, 130, 132, 140, 142), causes the user's compute device 120, 122, 130, 132, 140, 142 to provide a user interface (e.g., according to code (e.g., hypertext markup language (HTTP), JavaScript, or other code)) provided by the server compute device 110, usable to establish a corresponding user account. Additionally or alternatively, and as indicated in block 310, the server compute device 110 may send notification(s) to potential user(s) to create account(s) on the platform through other communication channel(s) (e.g., short message service (SMS), the Signal protocol, the Apple Push Notification service, etc.).

As indicated in block 312, the server compute device 110, in the illustrative embodiment, obtains a set of roles for users that are to be associated with the platform (e.g., the system 100). As stated above, the platform (e.g., the system 100), in the illustrative embodiment provides for the management of connections, content, and commerce among the users. As indicated in block 314, the server compute device 110 may obtain (e.g., receive data that defines) a set of roles that include a hosting organization (e.g., a hosting organization is to be a type of user of the system 100). In doing so, and as indicated in block 316, the server compute device 110 may obtain a set of roles that include a hosting organization that is an industry trade group (e.g., a trade association or professional association, such as the American Heart Association, the American Architectural Foundation, the Institute of Electrical and Electronics Engineers, the American Chemical Society, etc.). The server compute device 110, as indicated in block 318, may obtain a set of roles that includes a vendor (e.g., one type of user is a vendor who may sell products or services relevant to a particular industry associated with an industry trade group). Additionally, in the illustrative embodiment, the server compute device 110 may obtain a set of roles that includes a professional (e.g., another type of user of the platform is a professional (e.g., a person who works in an industry associated with an industry trade group)), as indicated in block 320. In some embodiments, the server compute device 110 obtains a set of roles defined by a user of the system 100 (e.g., through a user interface that enables the user to define roles or segments of users), as indicated in block 322. For example, and as indicated in block 324, the server compute device 110 may obtain a set of roles defined by an administrator of the system 100. Additionally or alternatively, the server compute device 110 may obtain a set of roles defined by a hosting organization (e.g., through a user interface provided to a hosting organization using a hosting organization compute device 120, 122 in communication with the server compute device 110), as indicated in block 326.

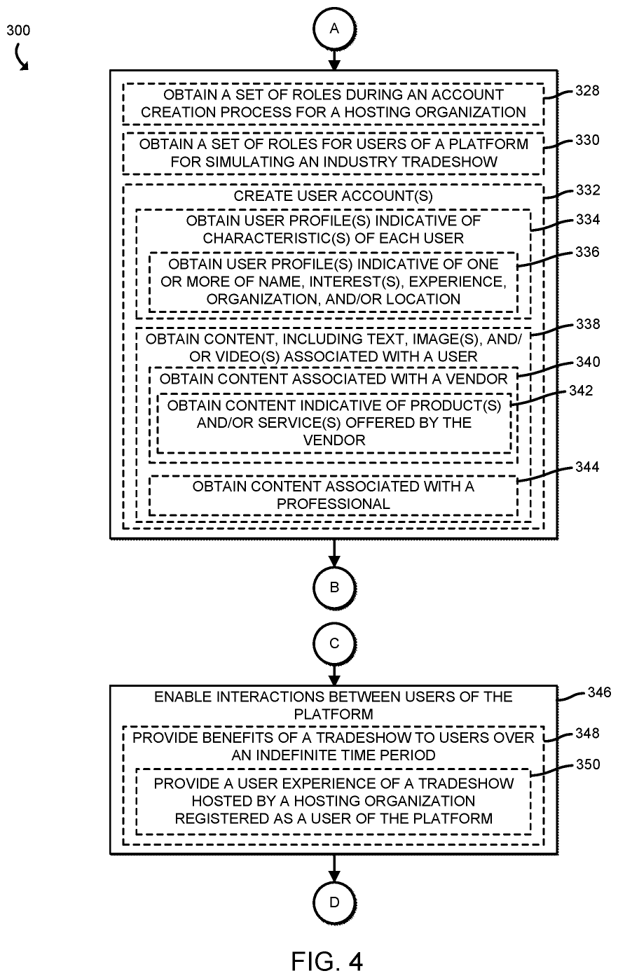

Referring now to FIG. 4, the server compute device 110 may obtain a set of roles (e.g., data defining a set of roles) during an account creation process for a hosting organization (e.g., a hosting organization may create roles for other types of users during the establishment of that hosting organization's account on the platform), as indicated in block 328. In the illustrative embodiment, the server compute device 110 obtains a set of roles for users of a platform for simulating an industry tradeshow (e.g., the system 100, in the illustrative embodiment, is configured to simulate and industry tradeshow among users having the defined roles), as indicated in block 330. While vendors, professionals, and hosting organizations are examples of user roles that the system 100 may support, in some embodiments, other roles or sub-roles (e.g., a particular type of professional) may be defined (e.g., by a hosting organization or administrator, through a corresponding user interface) and supported (e.g., the platform may enable connections, communication, and commerce among other types of users).

Still referring to FIG. 4, the server compute device 110 creates user accounts (e.g., by writing data defining the user accounts in the memory 204 and/or the data storage 212) for the users of the platform (e.g., the system 100), as indicated in block 332. In doing so, and as indicated in block 334, the server compute device 110 may obtain user profile(s) (e.g., by receiving user profile data through corresponding user interfaces) indicative characteristics of each user. For example, and as indicated in block 336, the server compute device 110 may obtain user profile(s) indicative of one or more of a name, interest(s) (e.g., professional interests, such as new opportunities, mentorship, small businesses, etc.), experience (e.g., professional experience, such as an amount of time spent working in a particular professional field, notable projects that the user was involved in, etc.), organization that the user is involved with (e.g., the name of the user's company), and/or location (e.g., geographic region where the user is located). In some embodiments, the server compute device 110 may obtain additional or alternative information for a user profile (e.g., languages spoken, job title, a link to a web site containing biographical information about the user, etc.).

The server compute device 110 may also obtain content in association with a user account, such as text, one or more images, and/or one or more videos associated with a user, as indicated in block 338. In doing so, the server compute device 110 may obtain content associated with a vendor, as indicated in block 340. For example, the server compute device 110 may obtain content indicative of products and or services offered by the vendor, as indicated in block 342. Similarly, the server compute device 110 may obtain content associated with a professional (e.g., a profile picture, a video or textual description of who the professional is, why the professional joined the platform, etc.), as indicated in block 344.

Subsequently, the method 300 loops back to block 304 of FIG. 3 to determine whether to add one or more additional users to the platform. If not, the method 300 proceeds to block 346 of FIG. 4, in which the server compute device 110 enables interactions between users of the platform (e.g. the system 100). In doing so, and as indicated in block 348, the server compute device 110, in the illustrative embodiment, provides the benefits of a tradeshow (e.g., the ability to connect, communicate, and potentially conduct commerce with other users) over an indefinite time period (e.g., for a period of time longer than the length of a tradeshow, with no set end date, etc.). As indicated in block 350, the server compute device 110 may provide a user experience of a tradeshow that is hosted by a hosting organization that is registered as a user of the platform (e.g., through the user account creation process described above).

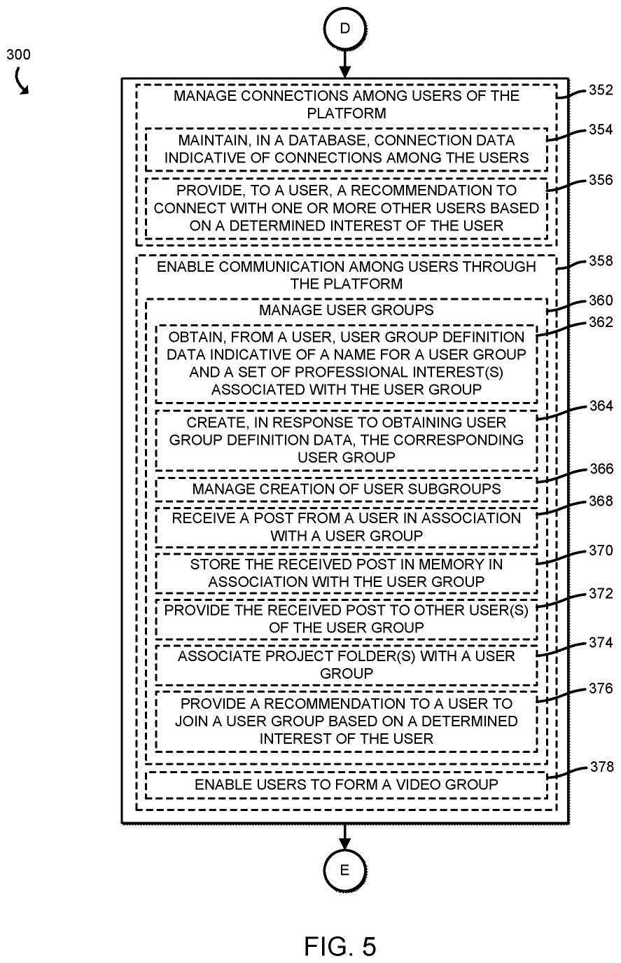

Referring now to FIG. 5, in enabling interactions between users of the platform (e.g., the system 100) the server compute device 110 may manage connections among the users, as indicated in block 352. In doing so, and as indicated in block 354, the server compute device 110 may maintain, in a database (e.g., in the data storage 212) connection data which may be embodied as any data indicative of connections among the users. As indicated in block 356, the server compute device 110 may provide, to a user (e.g., through a user interface) a recommendation to connect with one or more other users based on a determined interest of the user (e.g., based a determination that the user and the recommended user share one or more professional interests). The server compute device 110, in the illustrative embodiment, also enables communication among users through (e.g., using) the platform (e.g., the system 100), as indicated in block 358. In doing so, and as indicated in block 360, the server compute device 110 may manage one or more user groups. For example, and as indicated in block 362, the server compute device 110 may obtain, from a user (e.g., through a user interface) user group definition data which may be embodied as any data indicative of a name for a user group and a set of one or more professional interests associated with the user group. Further, and as indicated in block 364, the server compute device 110 creates, in response to obtaining the user group definition data, the corresponding user group (e.g., as a record in a dataset of user groups in the data storage 212).

Still referring to FIG. 5, in managing user groups, the server compute device 110 may also manage the creation of user subgroups (e.g., user groups within user groups), as indicated in block 366. In doing so, the server compute device 110 may obtain (e.g., through a user interface) subgroup data which may be embodied as any data indicative of a name of the user subgroup and one or more specific professional interests within the larger set of professional interests associated with the user group, and create the corresponding user subgroup (e.g., including writing a record indicative of the user subgroup to the data storage 212). As indicated in block 368, the server compute device 110 may receive (e.g., through a user interface) a post from a user in association with a user group (or subgroup). Further, and as indicated in block 370, the server compute device 110 may store the received post in memory (e.g., the memory 204, the data storage 212, etc.) in association with the user group (or user subgroup). For example, the server compute device 110 may store, in memory, the post itself and an indicator of the corresponding user group or user subgroup to which the post pertains.

As indicated in block 372, the server compute device 110, in the illustrative embodiment, provides the received post to other users of the user group or subgroup (e.g., by presenting the post in a user interface associated with the group or subgroup). As indicated in block 374, the server compute device 110 may associate one or more project folders (e.g., each a container of a set of one or more content items) with a user group or subgroup. In some embodiments, the server compute device 110 may provide a recommendation to a user to join a user group or user subgroup based on a determined interest of the user (e.g., based upon a determination that an interest of the user corresponds with an interest defined in association with a user group or user subgroup), as indicated in block 376. As indicated in block 378, the server compute device 110 may enable users to form a video group (e.g., in which users may participate in video conferences as a group).

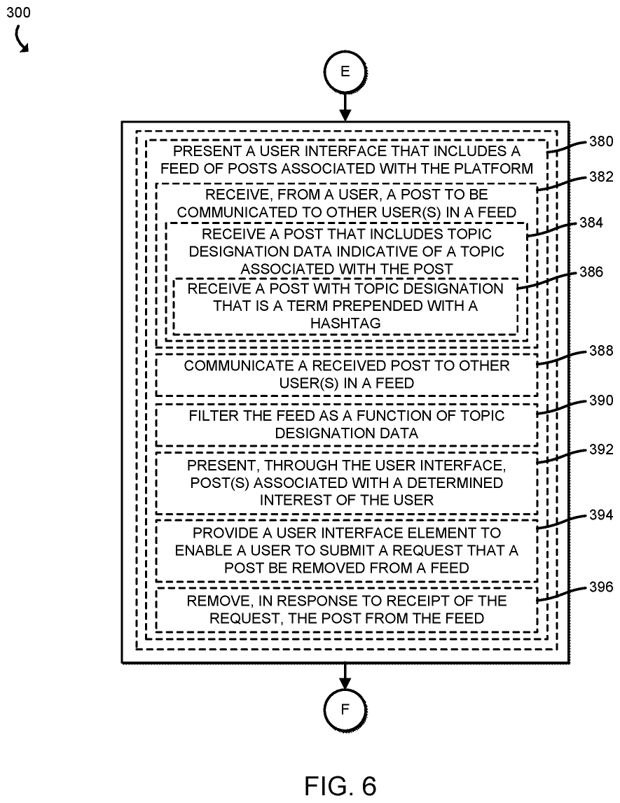

Referring now to FIG. 6, and as indicated in block 380, the server compute device 110 may present (e.g., send, to a recipient compute device, instruction(s) (e.g., code, a request, etc.) to present) a user interface that includes a feed of posts (e.g., text, images, videos, or other content) associated with the platform (e.g., received from users of the compute devices 120, 122, 130, 132, 140, 142). For example. the server compute device 110, in block 382, may receive, from a user, a post to be communicated to one or more other user(s) in a feed (e.g., a feed presented in a user interface displayed to each user). In receiving a post, the server compute device 110 may receive a post that includes topic designation data, which may be embodied as any data indicative of a topic associated with the post, as indicated in block 384. For example, and as indicated in block 386, the server compute device 110 may receive a post with topic designation data that is embodied as a term (e.g., one or more words, which may be concatenated together) prepended with a hashtag. The user interface provided to the user submitting the post may also include a user interface element that enables the user to specify which users can see the post (e.g., on their feeds). For example, the user interface may enable the user to select “everyone”, specify certain roles of users (e.g., “Staff, Students, “Vendors”, etc.), or provide other restrictions on who may see the post. The user interface may also enable the user to address another user of the platform (e.g., with a specified symbol such as “@” followed by an identifier of the user, such as a user name), which may cause the post to be directed to a feed of the user who was identified (and potentially to other users).

Afterwards, and as indicated in block 388, the server compute device 110 may communicate a received post (e.g., the post received in block 382) to one or more other users in a feed (e.g., user interfaces presented to other professionals, vendors, etc.). In some embodiments, the server compute device 110 may filter the feed presented to a user as a function of (e.g., based on) topic designation data, as indicated in block 390. For example, the server compute device 110 may provide a user interface element (e.g., a search bar) associated with a feed that receives text and/or other data usable to narrow the set of data shown in the user's feed, and, in response to receiving the data provided by the user (e.g., topic designation data, such as “#creative”, “#cinematography”, etc.). As indicated in block 392, the server compute device 110 may present (e.g., send code defining a user interface that, when rendered by the receiving compute device 120, 122, 130, 132, 140, 142, displays) posts associated with a determined interest of the user (to whom the posts are being presented). In some embodiments, the server compute device 110 may provide one or more user interface elements (e.g., a button, an icon, a text box, and/or a selection box, etc.) to enable a user to submit a request that a post be removed from a feed (e.g., due to a specified reason, such as offensive content, etc.), as indicated in block 394. The server compute device 110 may remove, in response to receipt of the request, the corresponding post from the feed (e.g., of the user and, in some embodiments, from the feeds of all other users that would otherwise see the post), as indicated in block 396.

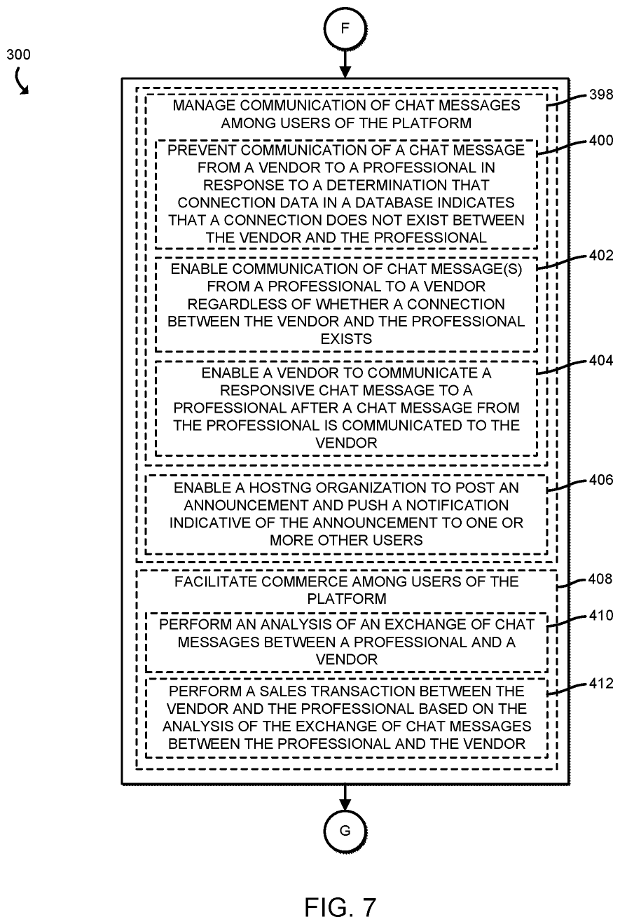

Referring now to FIG. 7, the server compute device 110 may manage communication of chat messages among users of the platform (e.g., the system 100). In doing so, and as indicated in block 400, the server compute device 110 may prevent communication of a chat message from a vendor to a professional in response to a determination (e.g., by the server compute device 110) that connection data in a database (e.g., the memory 204 and/or the data storage 212) indicates that a connection does not presently exist between the vendor and the professional (e.g., that the professional and the vendor have not agreed to form a connection in a professional network represented by the database of connections stored by the server compute device 110). Conversely, and as indicated in block 402, the server compute device 110, in the illustrative embodiment, enables communication of chat messages from a professional to a vendor regardless of whether a connection between the vendor and the professional exists (e.g., in the database of connections). As indicated in block 404, the server compute device 110, in the illustrative embodiment, enables a vendor to communicate a responsive chat message to a professional after a chat message from the professional is communicated to the vendor. Accordingly, the server compute device 110 prevents potentially unwanted solicitations from being sent to professionals from vendors but allows chat messages to be communicated from the vendor to the professional if the professional has already indicated an interest in communicating with the vendor (e.g., by forming a connection with the vendor or by sending one or more initial chat messages to the vendor).

As indicated in block 406, the server compute device 110 may enable a hosting organization (e.g., user(s) of hosting organization compute devices 120, 122) to post an announcement and push a notification indicative of the announcement to one or more other users (e.g., causing the notification to appear in a user interface presented to the users). The server compute device 110, in the illustrative embodiment, additionally may facilitate commerce among users of the platform (e.g., the system 100), as indicated in block 408. In doing so, the server compute device 110 may perform an analysis (e.g., a natural language processing (NLP) analysis) of an exchange of chat messages between two users, such as a vendor and a professional, as indicated in block 410. Further, the server compute device 110 may perform a sales transaction between the users (e.g., vendor and professional) based on the analysis of the exchange of chat messages, as indicated in block 412. For example, the server compute device 110 may identify an intent to perform a commercial transaction by detecting words such as “sell,” “purchase,” or synonyms, and identify a good or service to be sold from terms in the chat messages. In some embodiments, the server compute device 110 may identify a price specified in the chat messages and may further identify from the chat messages or by prompting the purchaser, payment information usable to send payment from one user to the other user (e.g., from the professional to the vendor), by submitting the payment through a payment network (e.g., a credit card payment network, a cryptocurrency payment network, etc.).

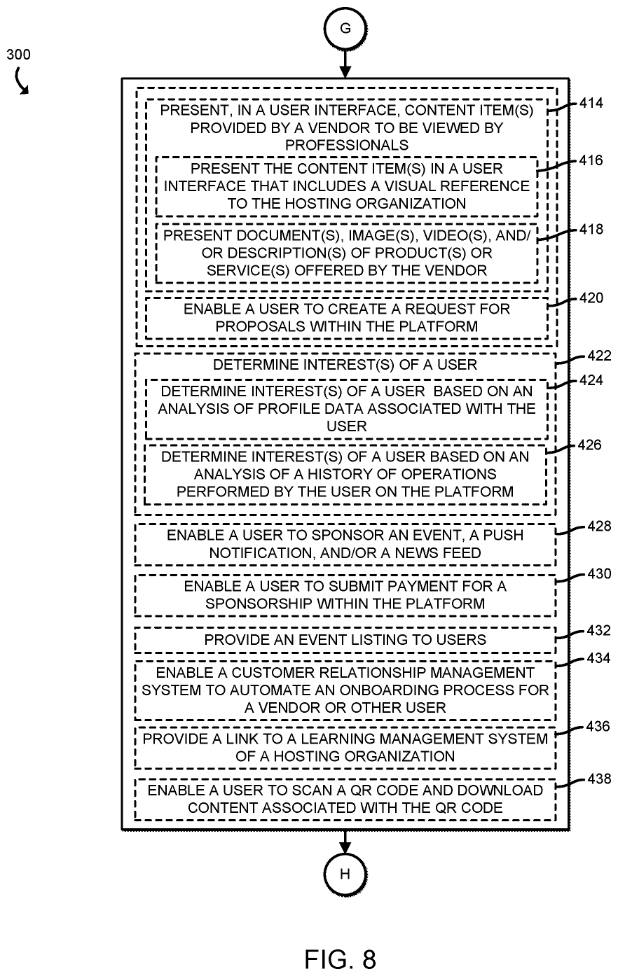

Referring now to FIG. 8, the server compute device 110, in facilitating commerce among users, may present, in a user interface, one or more content items provided by a vendor to be viewed by professionals (e.g., in a digital storefront or booth), as indicated in block 414. The server compute device 110 may present the content items in a user interface that includes a visual reference to the hosting organization, as indicated in block 416. That is, while the digital storefront may display the logo or name of the vendor in connection with content items offered by the vendor, the user interface illustratively also includes a logo or name of the hosting organization (industry trade association) responsible for organizing and hosting the simulated tradeshow, thereby creating the experience of a vendor's booth located at a tradeshow in which one or more visual references to the hosting organization (industry trade association) are also visible. In presenting content items provided by a vendor, the server compute device 110 may present one or more documents, images, videos, and/or descriptions of products or services offered by the vendor, as indicated in block 418. In some embodiments, in facilitating commerce among users, the server compute device 110 may enable a user to create a request for proposals within the platform (e.g., by providing a user interface for describing the project to be completed, managing submission of the request to users of the platform and receiving, and organizing responsive proposals from the users).

The server compute device 110, in some embodiments, may determine one or more interests of a user, as indicated in block 422. In doing so, and as indicated in block 424, the server compute device 110 may determine one or more interests of a user based on an analysis of profile data associated with the user (e.g., by analyzing interests selected or otherwise input by the user during the creation or editing of the user's profile). Additionally or alternatively, the server compute device 110 may determine one or more interests of a user based on an analysis of a history of operations performed by the user on the platform (e.g., based on communications or requests to connect with other users having known shared interests, joining one or more groups or subgroups associated with particular topics, topic designation data included in posts from the user, etc.), as indicated in block 426. In some embodiments, the server compute device 110 may enable a user to sponsor (e.g., have a visual reference to the user appear in connection with) an event, a push notification, and/or a news feed on the platform (e.g., the system 100), as indicated in block 428. Relatedly, the server compute device 110 may enable a user to submit payment for a sponsorship within the platform (e.g., the system 100), as indicated in block 430. That is, the server compute device 110 may provide a user interface to a user to submit payment information (e.g., bank account information, credit card information, etc.) in connection with a designated type of sponsorship (e.g., an event, a push notification, a news feed, etc.).

The server compute device 110, in some embodiments, may provide an event listing to users (e.g., a list of one or more upcoming video presentations, video conferences, etc.), as indicated in block 432. In some embodiments, the server compute device 110 may enable a customer relationship management (CRM) system to automate an onboarding process for a vendor or other user. In doing so, in some embodiments, the server compute device 110 may provide a link (e.g., a uniform resource locator (URL)) to a website of the CRM system in a user interface presented to a user of the system 100, as indicated in block 434. In other embodiments, the CRM system is incorporated within the platform (e.g., executed by the server compute device 110), rather than being executed by an external system that is linked to by the platform. The server compute device 110, in some embodiments, may provide a link to a learning management system of a hosting organization, as indicated in block 436. In some embodiments, the system 100 may enable a user to scan a quick response (QR) code (e.g., using a camera in their compute device 130, 132) and download content associated with the QR code (e.g., as a virtual “goodie bag” of content items from a vendor), as indicated in block 438.

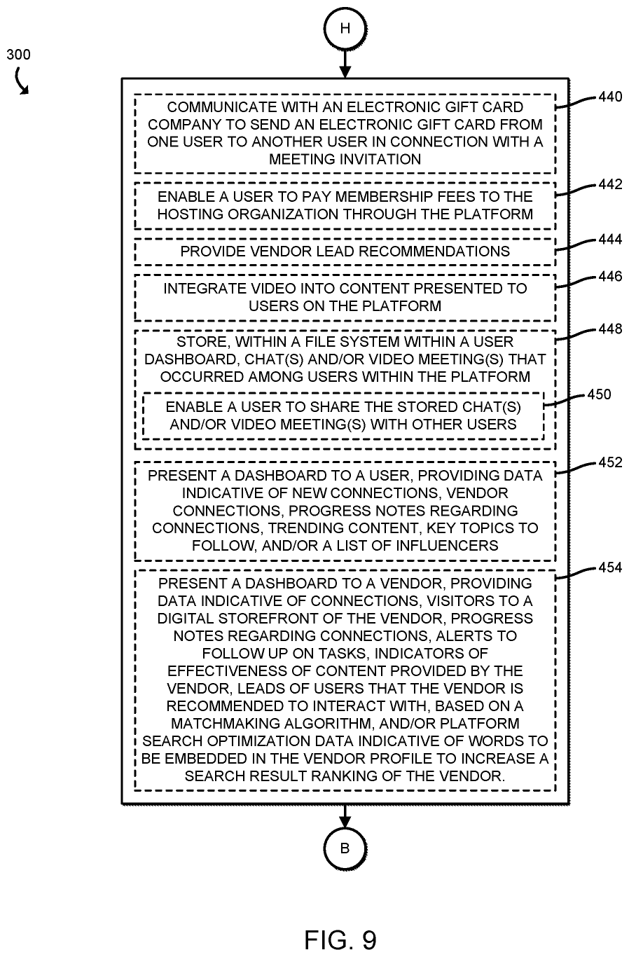

Referring now to FIG. 9, the server compute device 110 may communicate with an electronic gift card company to send an electronic gift card from one user to another user in connection with a meeting invitation, as indicated in block 440. For example, the server compute device 110 may enable a user to send a gift certificate for coffee to another user, in connection with a request to hold a virtual meeting (e.g., a video conference). As indicated in block 442, the sever compute device 110 may enable (e.g., through a user interface that accepts payment information) a user (e.g., a professional) to pay membership fees to the hosting organization (e.g., a hosting organization associated with a simulated tradeshow that the professional is participating in). For example an engineer (e.g., professional) may pay membership fees to a corresponding hosting organization, such as the Institute of Electrical and Electronics Engineers (IEEE) through a user interface provided by the system 100 (e.g., a user interface rendered by the professional compute device 130 based on code (HTML, JavaScript, etc.) sent from the server compute device 110). The server compute device 110, in some embodiments, may provide vendor lead recommendations, as indicated in block 444. That is, the server compute device 110 may determine interests of one or more users (e.g., in block 422), determine which users have interests that pertain to products and/or services offered by a vendor, and present a list of those users to the vendor (e.g., on the vendor compute device 140, 142) as users that the vendor should interact with.

The server compute device 110, in some embodiments, may integrate video into content presented to users on the platform, as indicated in block 446. In the illustrative embodiment, the server compute device 110 may store, within a file system represented in a user dashboard (e.g., an interface that organizes and presents a global view of information from multiple sources), records of one or more chats and/or video meetings that occurred among users of the platform (e.g., the user whose dashboard is displayed and one or more other users), as indicated in block 448. The server compute device 110 may additionally enable the user to share the stored one or more chats and/or video meetings with other users (e.g., by selecting a corresponding user interface element and identifying one or more users to share with), as indicated in block 450. In some embodiments, the server compute device 110 may present a dashboard to a user that provides data indicative of new connections, vendor connections, progress notes regarding connections (e.g., a note to follow up with a user, etc.), trending content, key topics to follow, and/or a list of influencers, as indicated in block 452.

Additionally or alternatively, the server compute device 110 may present a dashboard to a vendor that provides data indicative of connections, visitors to a digital storefront of the vendor (e.g., having content items uploaded by the vendor), progress notes regarding connections, alerts to follow up on defined tasks, indicators of effectiveness of content provided by the vendor (e.g., whether a particular video regarding a product has led professionals to initiate communication with the vendor, etc.), leads of users that the vendor is recommended to interact with, based on a matchmaking algorithm (similar to block 444 discussed above), and/or platform search optimization data indicative of words that the server compute device 110 recommends to be embedded in the vendor's profile to increase a search result ranking of the vendor within the platform (e.g., in response to searches submitted by users of the system 100). Subsequently, the method 300 loops back to block 304 of FIG. 3 to determine whether to add additional users.

While the operations of the method 300 are illustrated and described with reference to FIGS. 3-9 in a particular order, it should be understood that many of the operations could be performed in a different order or concurrently. For example, the server compute device 110 may add users while concurrently facilitating interactions among existing users of the system 100.

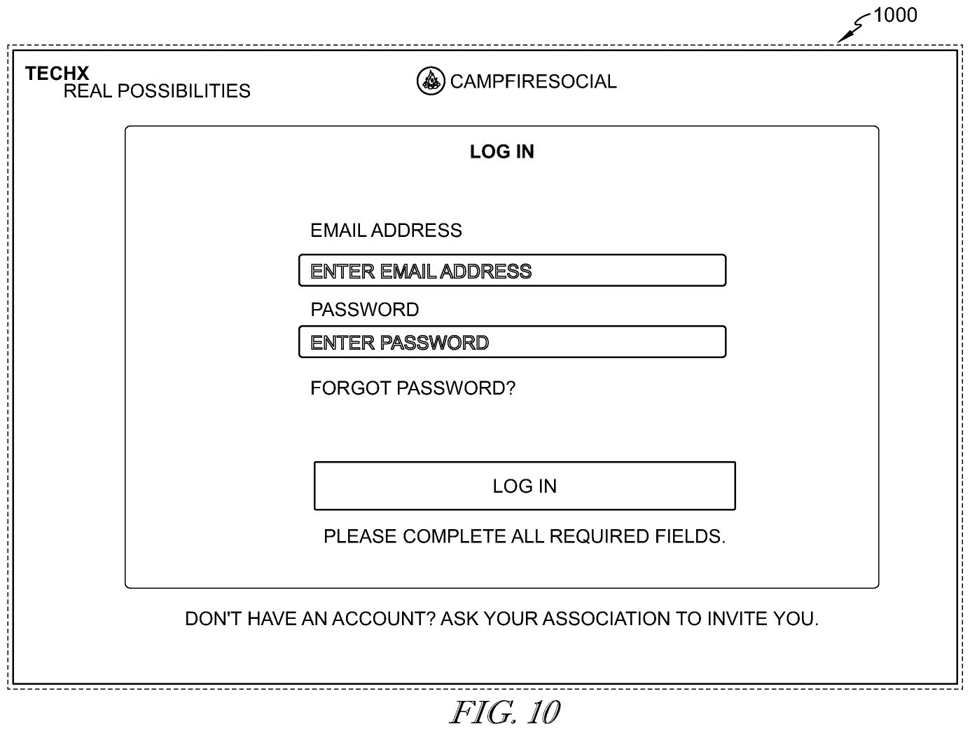

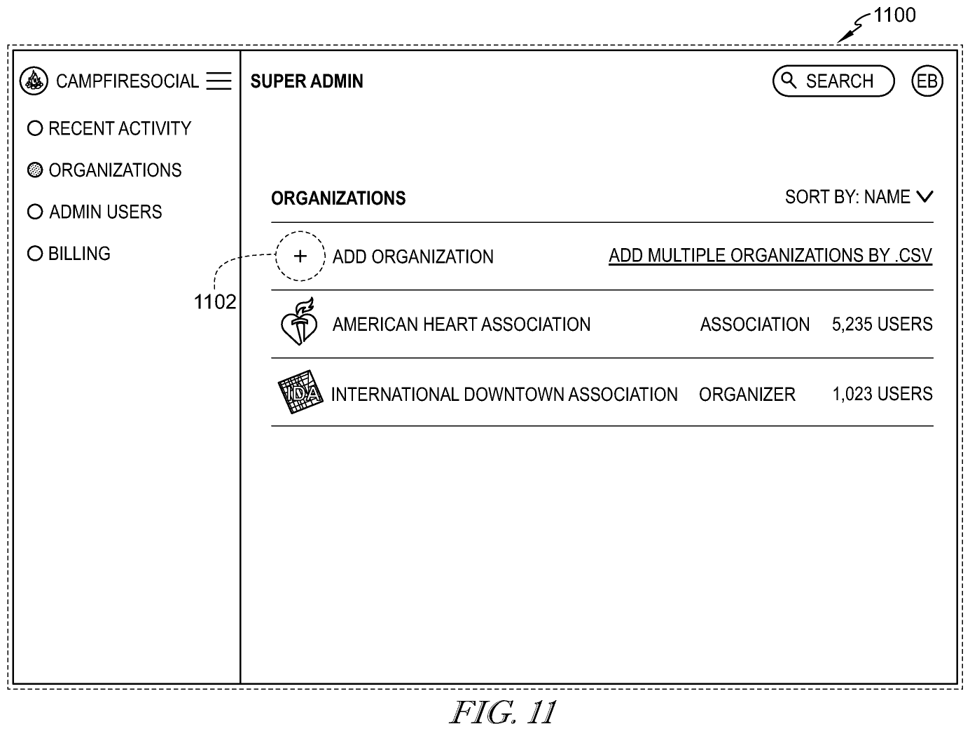

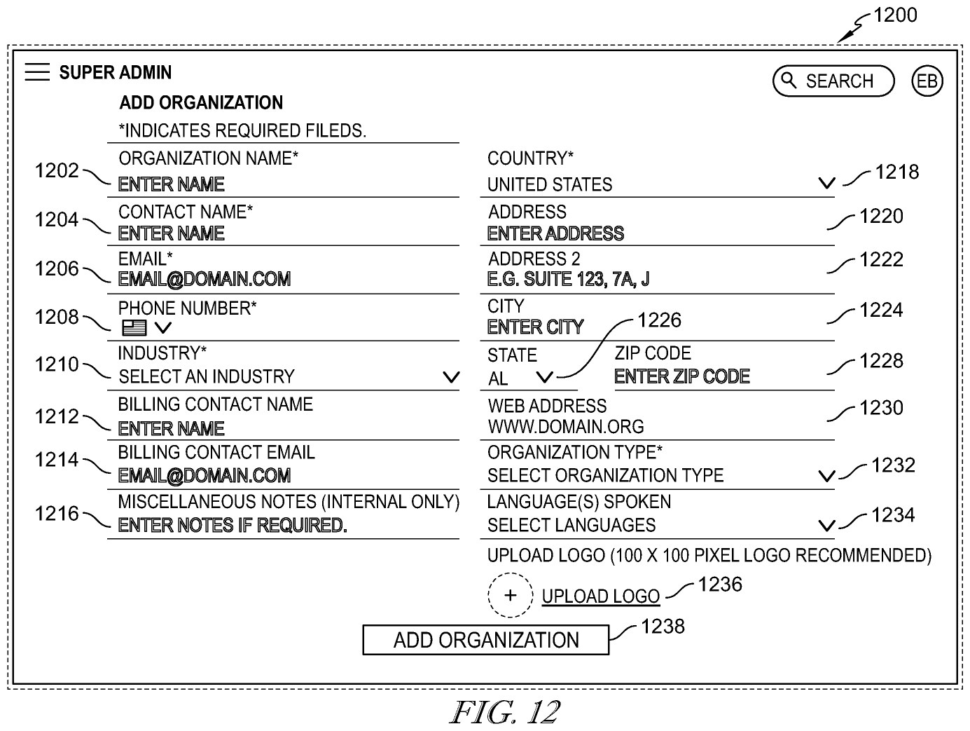

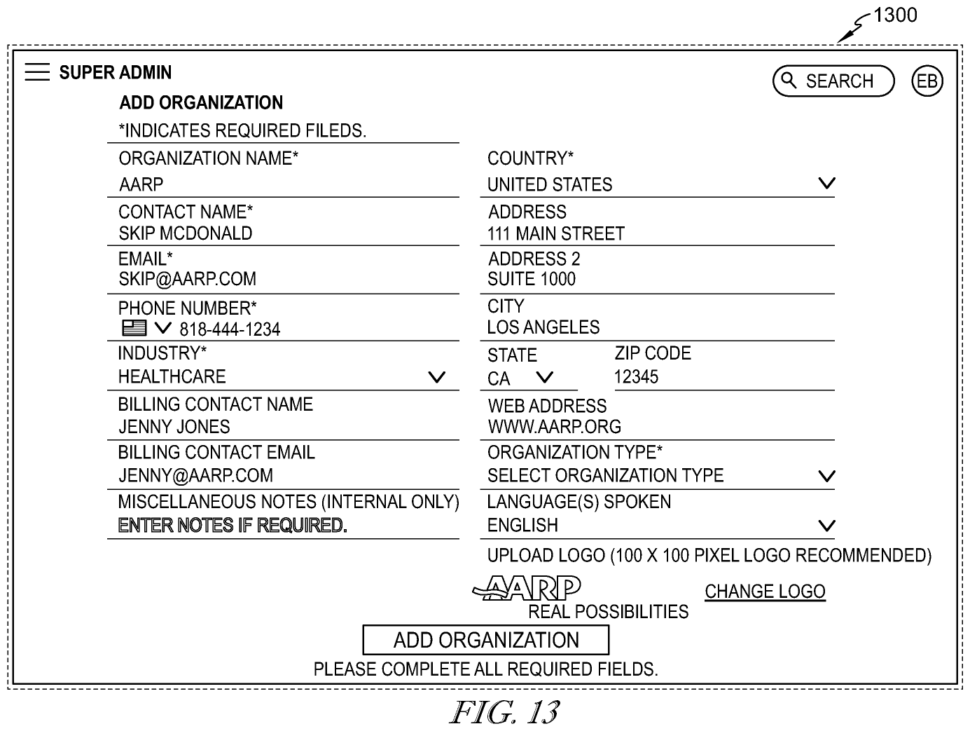

Referring now to FIG. 10, the system 100 may provide a log in interface 1000 to prompt a user to provide log in credentials (e.g., an email address and a password) to access the platform. FIG. 11 illustrates a user interface 1100 that may be provided to an administrator. In the illustrative embodiment, the user interface 1100 enables a user (e.g., an administrator) to create accounts for organizations (hosting organizations). In the illustrative embodiment, in response to a user (e.g., an administrator) selecting a user interface element 1102, the system 100 provides the user interface 1200 of FIG. 12 for adding an account for a new hosting organization. The user interface 1200 includes multiple user interface elements 1202, 1204, 1206, 1208, 1210, 1212, 1214, 1216, 1218, 1220, 1222, 1224, 1226, 1228, 1230, 1232, 1234, 1236, 1238 to enable the user (e.g., administrator) to submit information about the hosting organization, including the name of the organization, contact information, billing information, notes, location information, web address information, organization type, languages spoken by personnel at the organization, and a logo for the organization. FIG. 13 illustrates a user interface 1300, similar to the user interface 1200, in which information about a hosting organization has been supplied by the user (e.g., administrator).

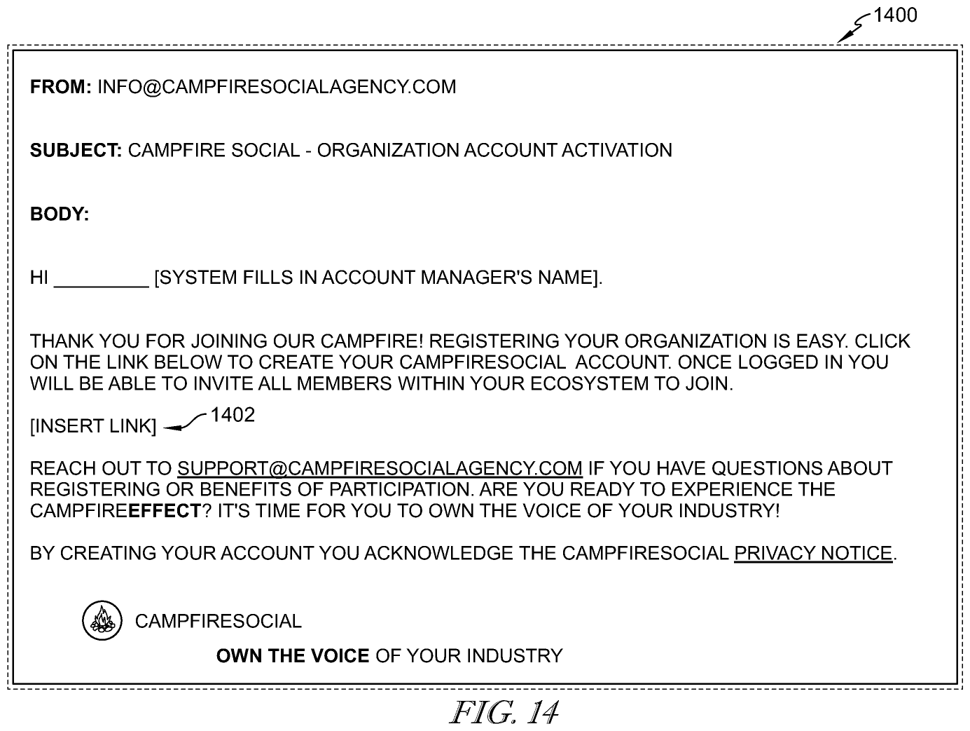

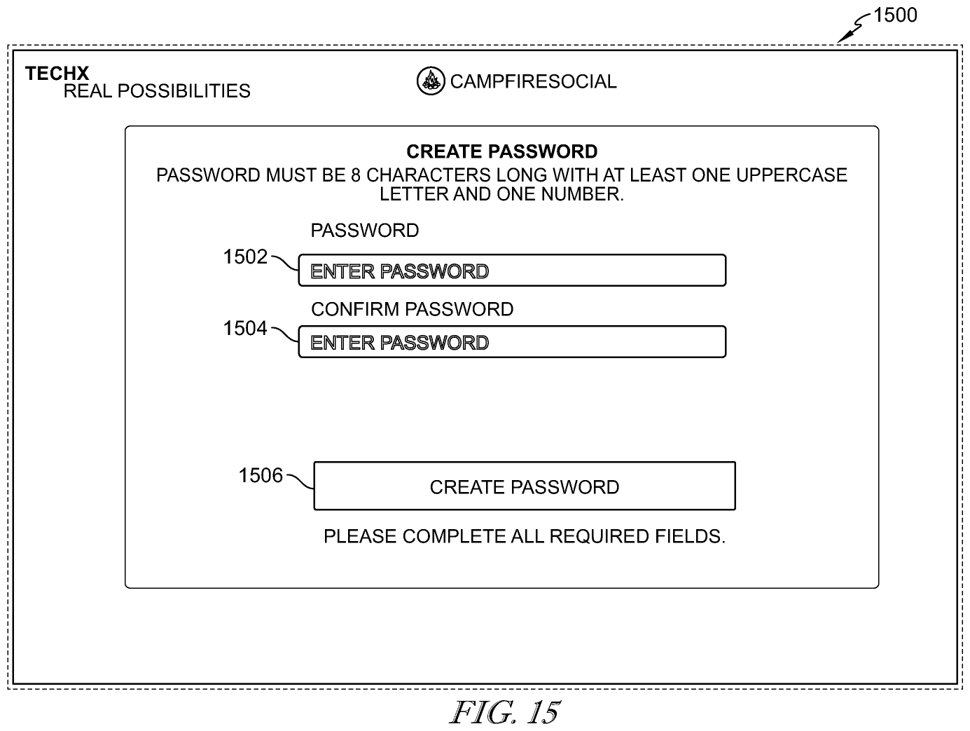

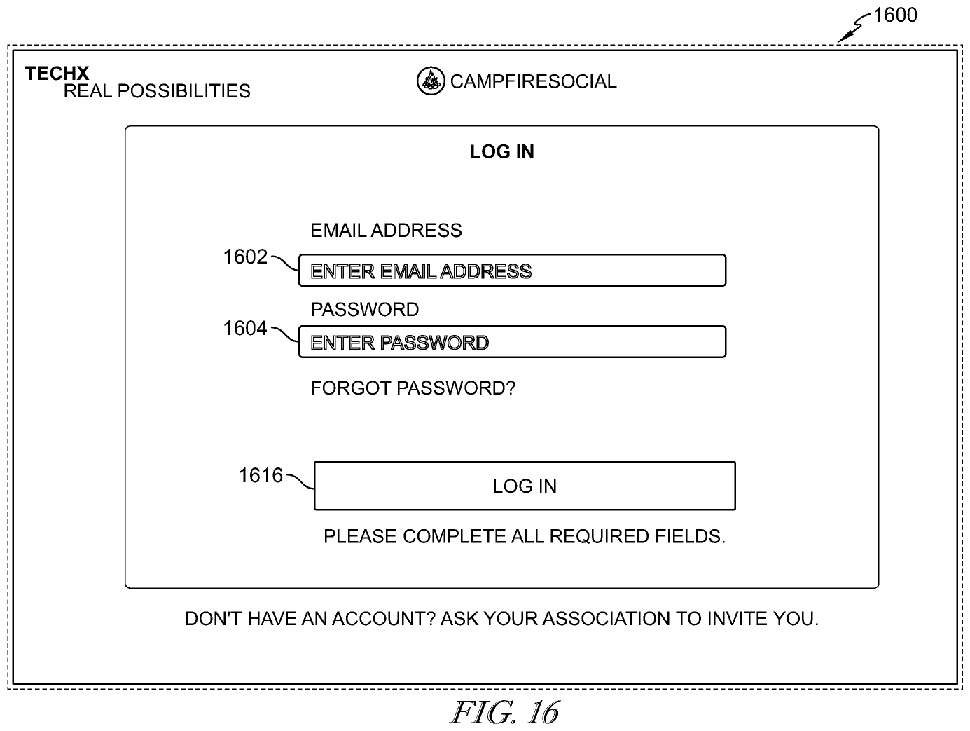

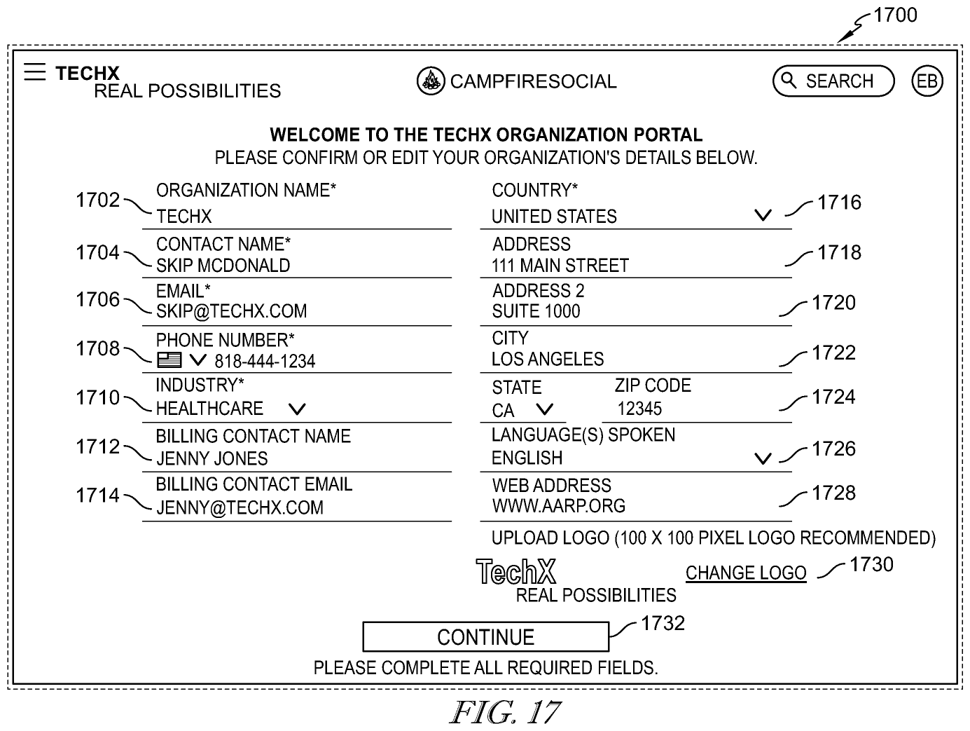

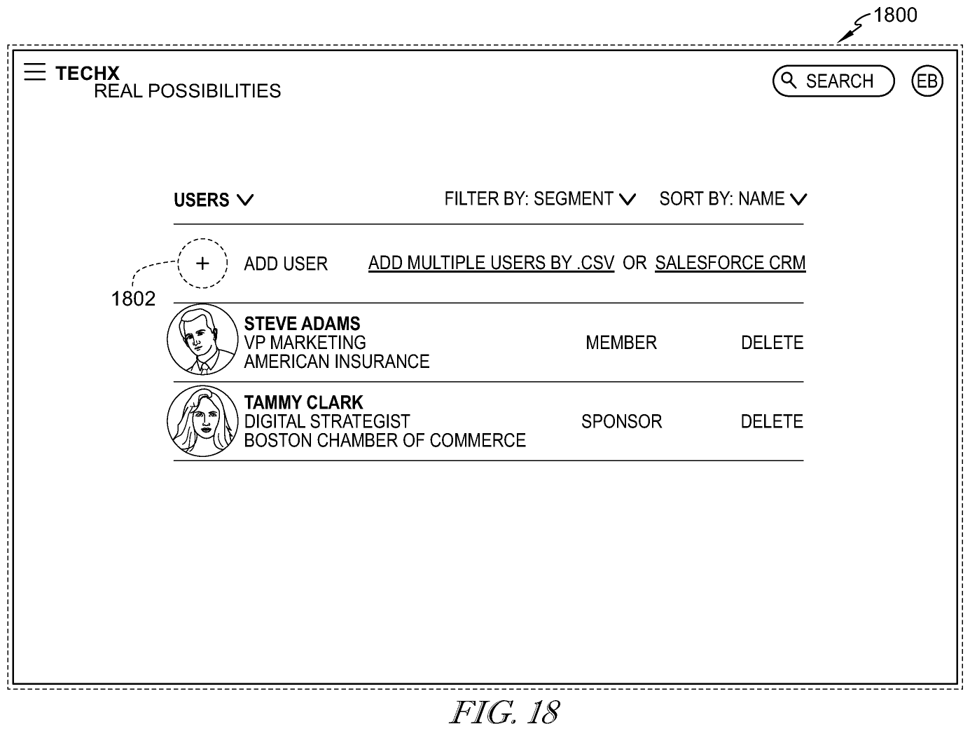

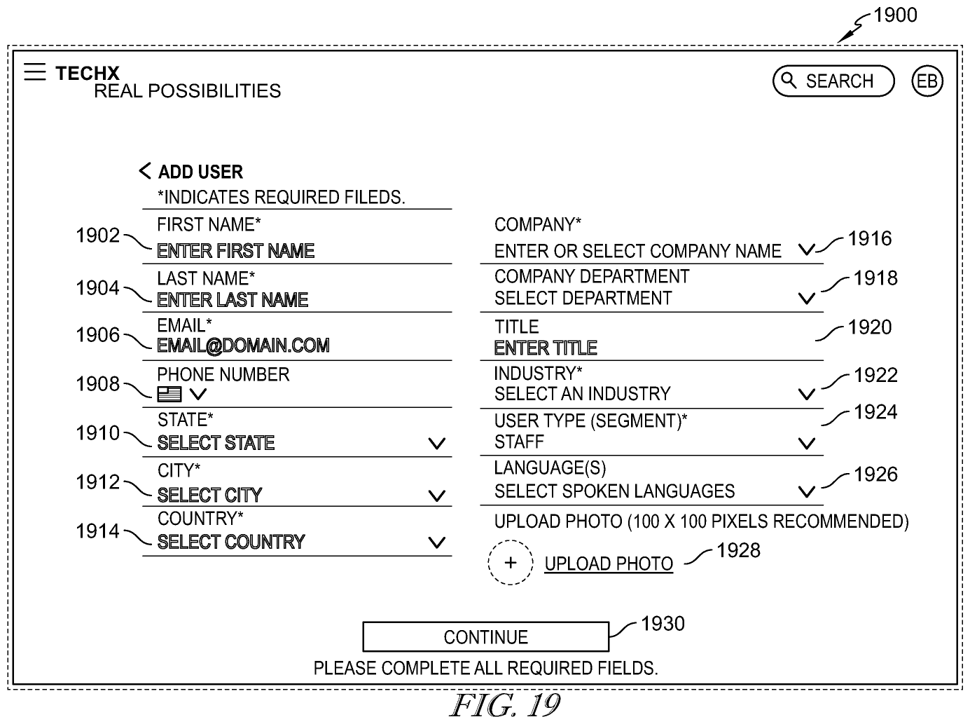

Referring now to FIG. 14, the system 100 may send a notification 1400 (e.g., an email) to a hosting organization inviting a person at the hosting organization to access the system 100 to register the account of the hosting organization. In the illustrative embodiment, the notification 1400 includes a link 1402, that, when selected, causes the user's compute device (e.g., the hosting organization compute device 120) to communicate with the server compute device 110 to register the account of the hosting organization. Referring now to FIG. 15, when the user (e.g., at the hosting organization) selects the link 1402, the system 100 may provide the user interface 1500, which enables the user to enter an account password, using user interface elements 1502, 1504 and submit the account password, using the user interface element 1506, to the server compute device 110. Referring to FIG. 16, the system 100 may provide a user interface 1600 to enable a user (e.g., a hosting organization using a hosting organization compute device 120) to log in to the system 100 (e.g., to the server compute device 110). In the illustrative embodiment, the user enters log in credentials (e.g., an email address and password) using user interface elements 1602, 1604 and submits the log in credentials to the system 100 (e.g., the server compute device 110) by selecting the user interface element 1616. Upon a successful authentication (e.g., log in) to the system 100, the system 100 may provide the user interface 1700 to a user (e.g., a hosting organization) to confirm or edit details of the hosting organization that may have been originally provided by an administrator (e.g., through a user interface similar to the user interface 1200 of FIG. 12). That is, using the user interface elements 1702, 1704, 1706, 1708, 1710, 1712, 1714, 1716, 1718, 1720, 1722, 1724, 1726, 1728, 1730, 1732, the user (e.g., hosting organization) may review, potentially change, and submit (e.g., to the server compute device 110) information about the hosting organization that was originally provided by the administrator during an earlier account creation process for the hosting organization.

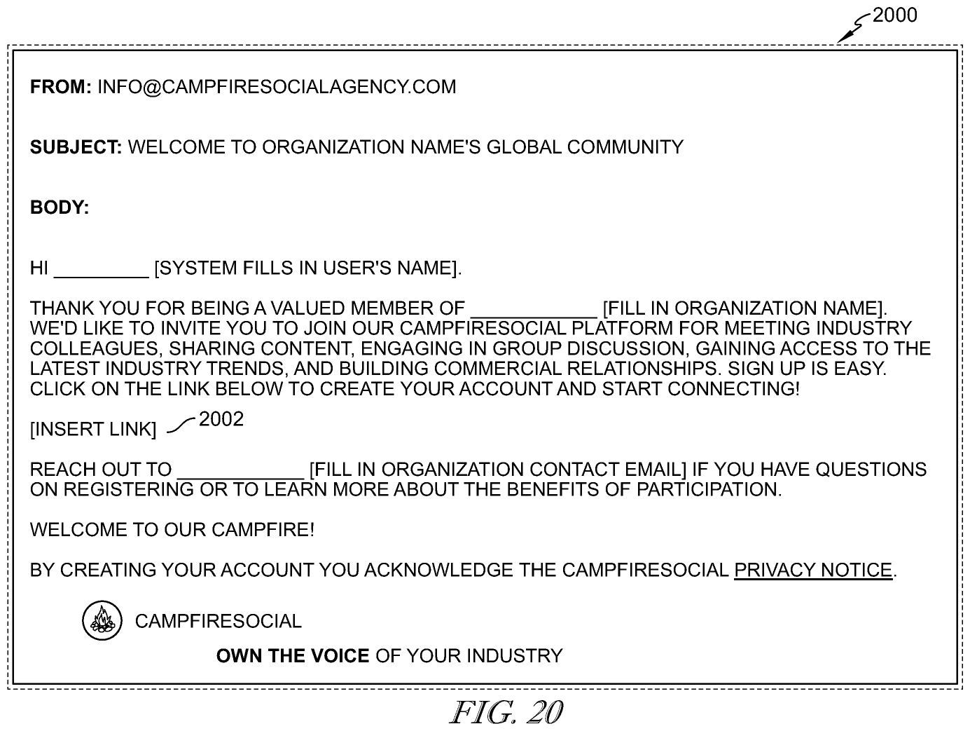

After the information about the hosting organization has been reviewed, potentially edited, and submitted to the server compute device 110 by the hosting organization (e.g., using the hosting organization compute device 120), the server compute device 110 may provide the user interface 1800, which enables the user (e.g., hosting organization) to review and add users (e.g., to be involved in a simulated tradeshow experience associated with the hosting organization). In response to selection of the user interface element 1802, the system 100, in the illustrative embodiment, may provide the user interface 1900 of FIG. 19. Referring now to FIG. 19, the user interface 1900 enables the hosting organization (e.g., using the hosting organization compute device 120) to provide information about a new user through user interface elements 1902, 1904, 1906, 1908, 1910, 1912, 1914, 1916, 1918, 1920, 1922, 1924, 1926, 1928, 1930. That is, the hosting organization may provide a user's first name, last name, email address, phone number, state, city, country, company, department, title, industry, role (segment), language(s) spoken, and a photo using the user interface 1900. In response to receiving information regarding a new user, the system 100 (e.g., the server compute device 110) may send a notification to the new user (e.g., as an email). Referring now to FIG. 20, an example notification 2000 to a new user, sent by the system 100 (e.g., the server compute device 110) invites the user to select a link 2002 to access the system 100 (e.g., the server compute device 110) and register their account (which was created by the hosting organization using the user interface 1900).

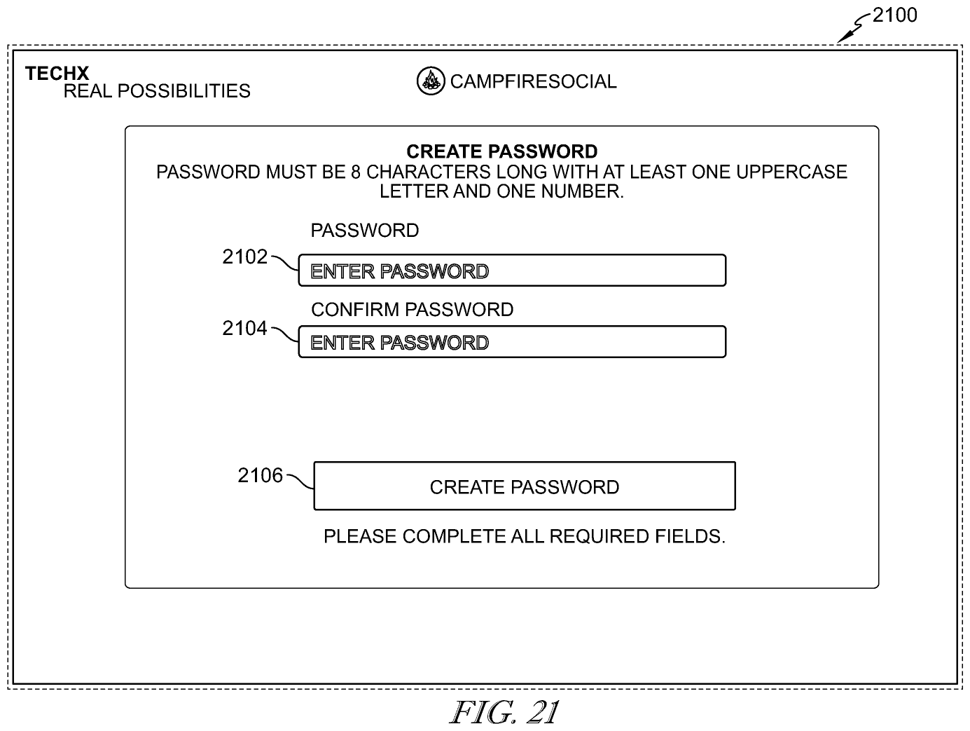

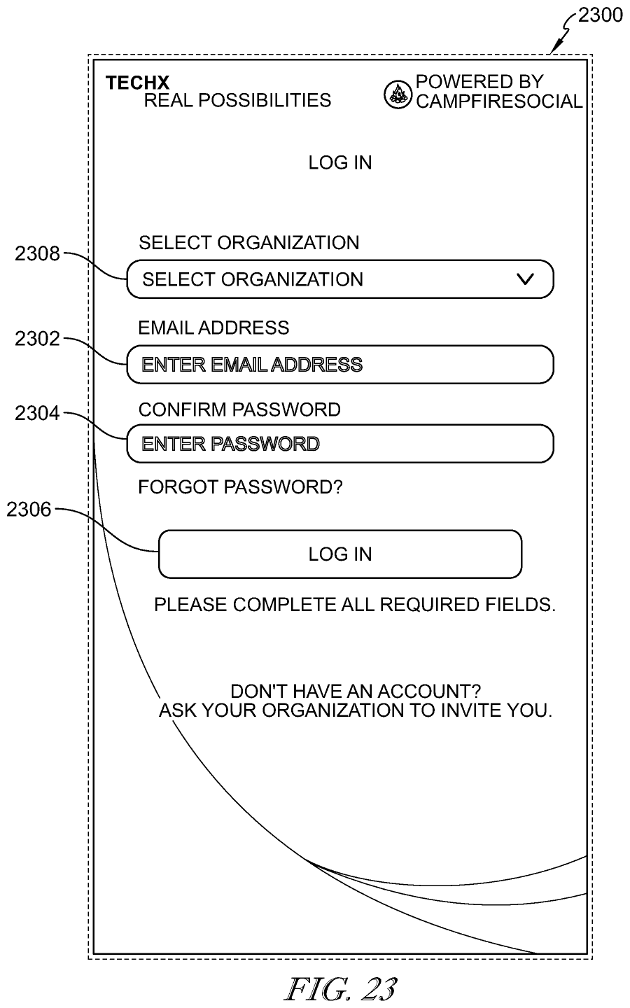

Referring now to FIG. 21, the system 100 may provide a user interface 2100 in response to the user selecting the link 2002 (of FIG. 20) to register their account with the system 100 (e.g., the server compute device 110). The user interface 2100 includes user interface elements 2102, 2104 enabling the user to enter and confirm a password for their account and submit the password to the server compute device 110, by selecting the user interface element 2106. After the user submits the password for the account, the system 100 may provide a user interface 2200 (e.g., rendered on the compute device 130) to enable the user to log in to the system 100 (e.g., to the server compute device 110). The user interface 2200 includes user interface elements 2202, 2204 to enable the user to enter authentication credentials (e.g., an email address and password) and to submit the authentication credentials (e.g., to the server compute device 110), by selecting the user interface element 2206. FIG. 23 illustrates a user interface 2300, similar to the user interface 2200, but formatted for a smaller screen, such as for a compute device 130, 132 embodied as a mobile compute device (e.g., a smart phone). The user interface 2300, in the illustrative embodiment, includes user interface elements 2302, 2304, 2306 similar to the user interface elements 2202, 2204, 2206. Additionally, the user interface 2300 includes an additional user interface element 2308, which enables the user to select a hosting organization that the account credentials (entered in user interface elements 2302, 2304) pertain to. That is, a user may have different accounts associated with different simulated tradeshows (e.g., created by different hosting organizations). In some embodiments, the user interface 2200 may include a user interface element similar to the user interface element 2308 (e.g., to enable the user to select a hosting organization).

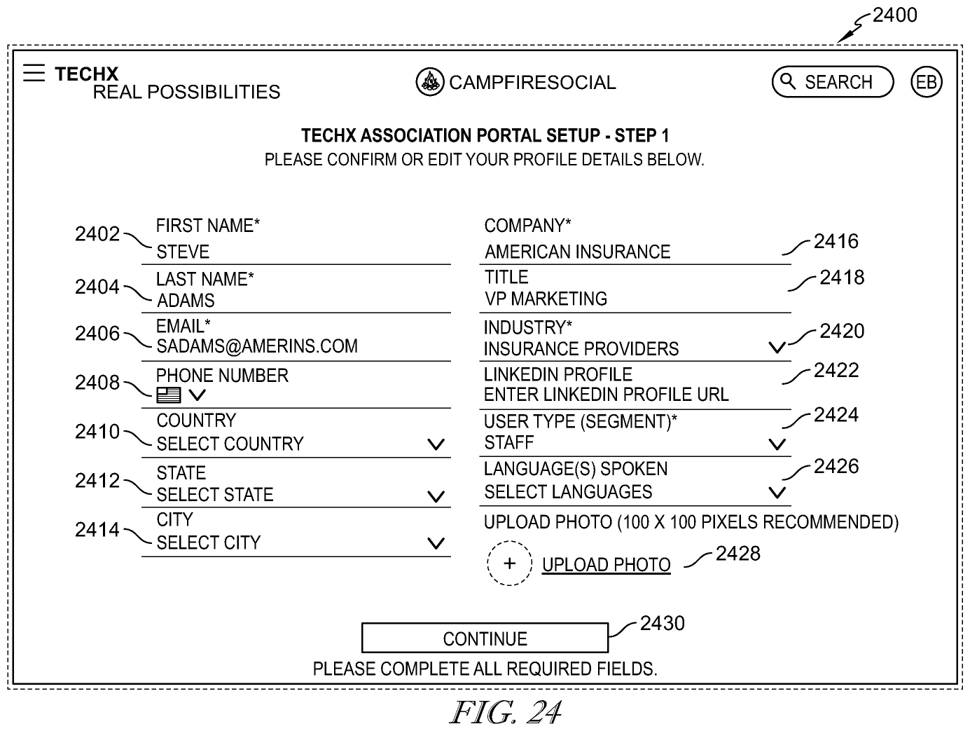

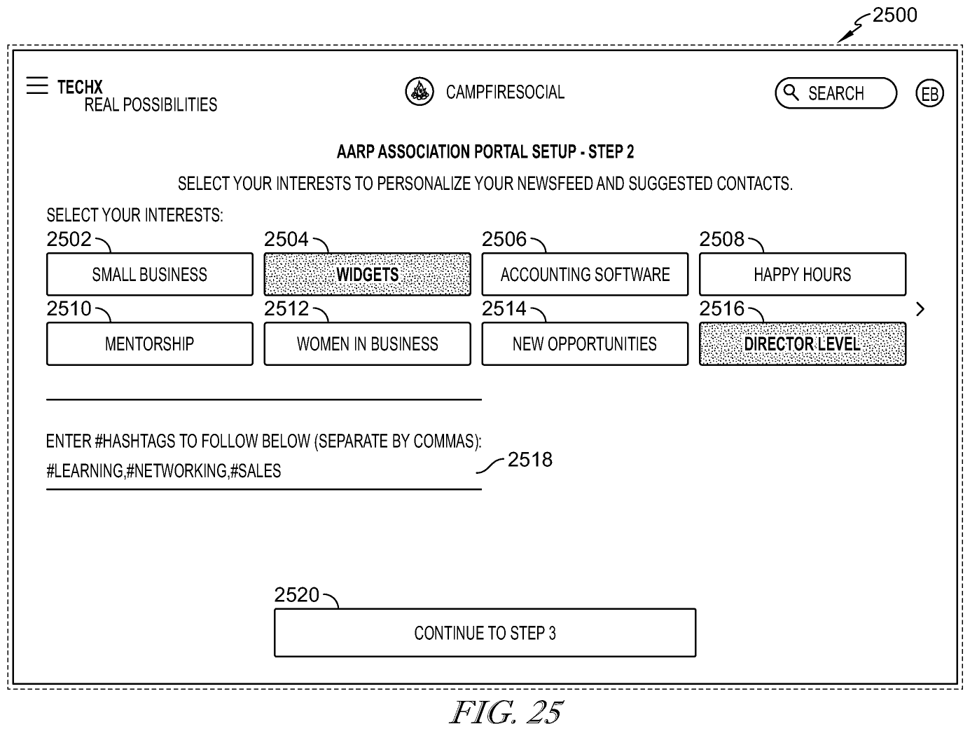

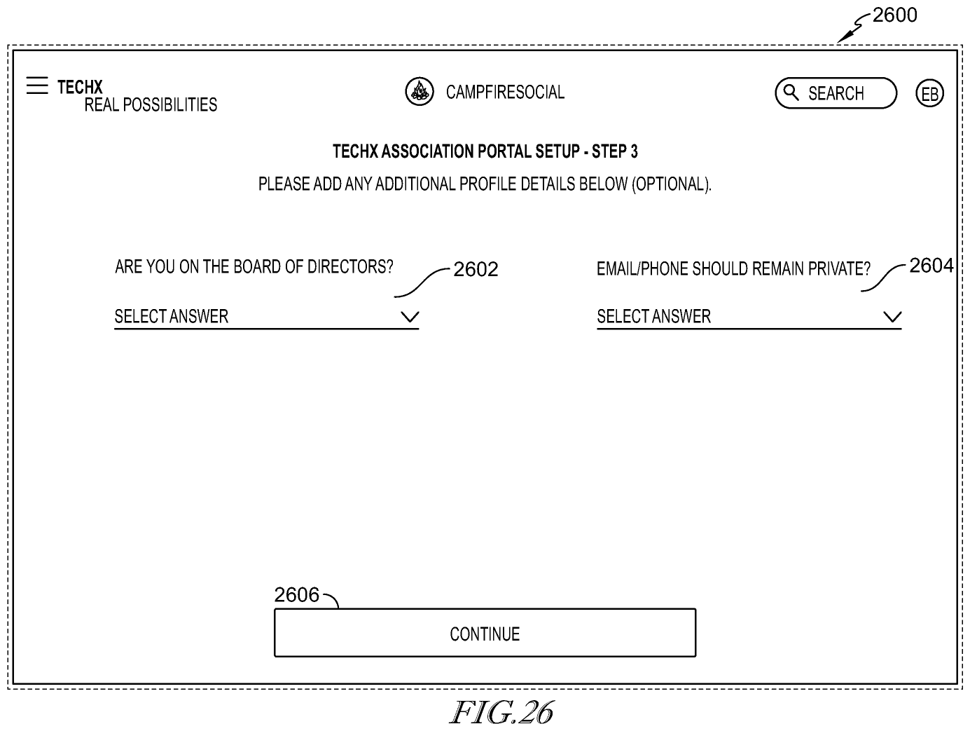

Referring now to FIG. 24, the system 100 may provide a user interface 2400 in response to a user successfully authenticating to the server compute device 110 (e.g., via one of the user interfaces 2200, 2300). The user interface 2400 illustratively incudes user interface elements to review, potentially edit, and submit information about the user that may have been originally provided, at least in part, by the hosting organization (e.g., through the user interface 1900 of FIG. 19). That is, with the user interface elements 2402, 2404, 2406, 2408, 2410, 2412, 2414, 2416, 2418, 2420, 2422, 2424, 2426, 2428, 2430, the user may provide the user's first name, last name email address, phone number, country, state, city, company, title, industry, profile on an external professional networking site, user role (segment), language(s) spoken, and photo. Subsequently, the system 100, in the illustrative embodiment, provides the user interface 2500, having user interface elements 2502, 2504, 2506, 2508, 2510, 2512, 2514, 2516, 2518, 2520 with which the user may select professional interests and topics (e.g., indicated with topic designation data, such as hashtags concatenated with one or more words). In response to obtaining the information provided through the user interface 2500, the system 100, in the illustrative embodiment, provides the user interface 2600 of FIG. 26. The user interface 2600, in the illustrative embodiment, prompts the user to provide additional information about the user, including whether the user is on the board of directors of their company (e.g., using user interface element 2602) and whether the user's email and phone number should remain private (e.g., using user interface element 2604). The user may submit (e.g., to the server compute device 110) their answers to the prompts by selecting the user interface element 2606.

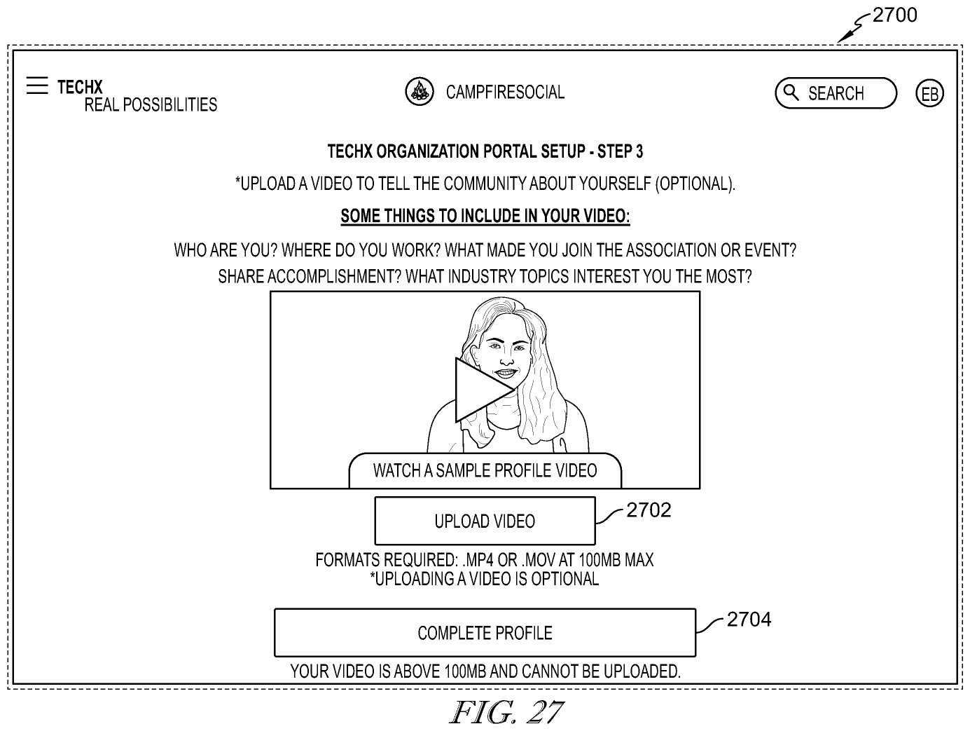

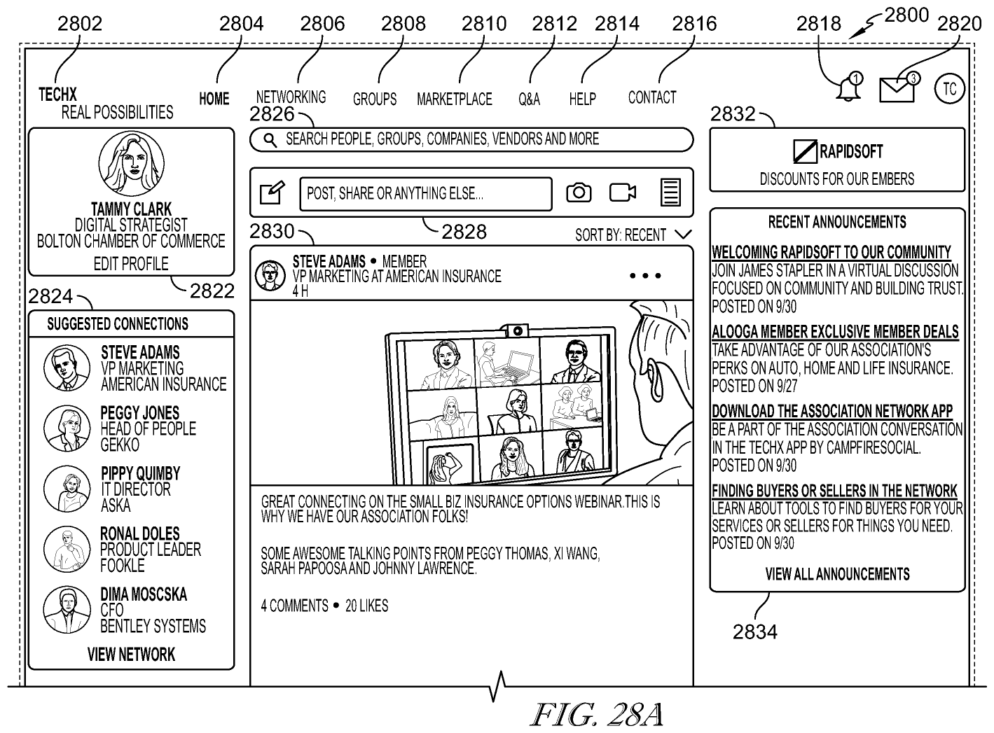

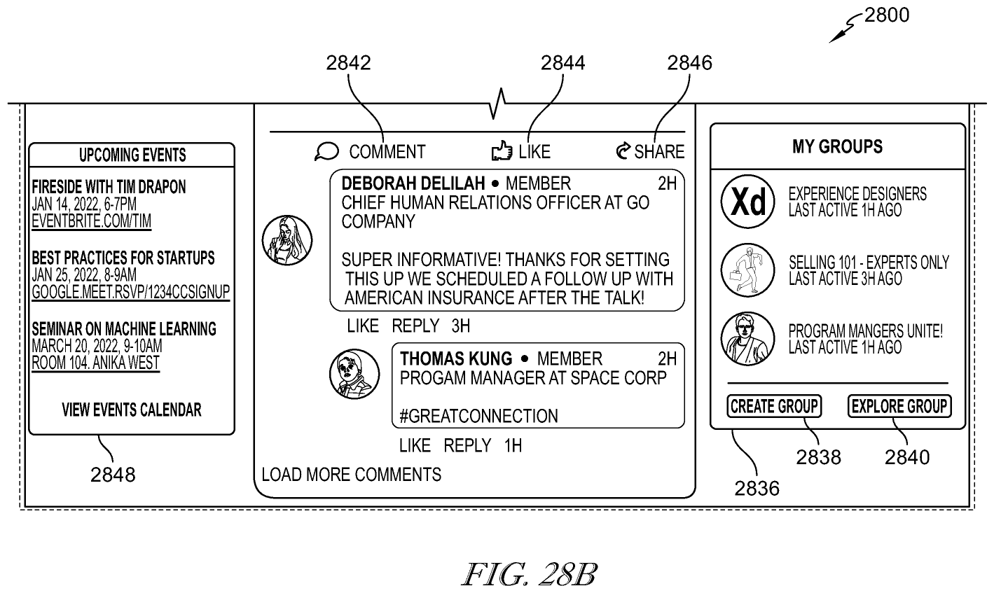

Subsequently, the system 100, in the illustrative embodiment, provides the user interface 2700 of FIG. 27, which includes user interface elements 2702, 2704 to enable the user to upload (e.g., to the server compute device 110) a video in which the user tells the community (e.g., other users) about himself or herself (e.g., who the user is, where the user works, what caused the user to join the hosting organization (e.g., industry trade association) or simulated tradeshow experience, the user's professional accomplishments, the user's professional interests, and/or other information about the user). The server compute device 110, in the illustrative embodiment, stores the information provided through the user interfaces 2400, 2500, 2600, 2700 as user profile data (e.g., in the data storage 212). Referring now to FIGS. 28A and 28B, the system 100, in the illustrative embodiment, provides a user interface 2800 (e.g., a home screen) to a user once the user has logged into their account and after their profile data has been established. The user interface 2800 includes a user interface element 2802 that provides a visual reference to the hosting organization associated with the simulated tradeshow experience that the user is participating in. A set of user interface elements 2804, 2806, 2808, 2810, 2812, 2814, 2816 provide a high level menu for user interfaces that the user may select from.

As indicated in FIG. 28A, the user interface element corresponds to a home screen user interface (e.g., the user interface 2800), the user interface element 2806, when selected, causes the system 100 to provide a networking user interface (e.g., indicating users that the present user is connected with or may connect with). The user interface element 2808, when selected, causes the system 100 to provide a groups user interface (e.g., indicating groups that the user is presently a member of and/or groups that the user may join). Further, the user interface element 2810, when selected, causes the system 100 to provide a marketplace user interface (e.g., indicative of vendors offering products and/or services). The user interface element 2812, when selected, causes the system 100 to provide a Q&A user interface (e.g., indicative of questions and answers for review by users). Additionally, the user interface element 2814, when selected, causes the system 100 to provide a help user interface (e.g., to provide technical assistance to the user). Further, the user interface element 2816, when selected, causes the system 100 to provide a contact user interface to enable the user to contact an organization (e.g., the hosting organization, an organization responsible for operating the server compute device 110, etc.). The user interface element 2818 indicates notification(s) for the user and when selected, may cause the system 100 to provide additional details on the notification(s). Similarly, the user interface element 2820 indicates messages to the user and, when selected, may cause the system 100 to provide additional details on the messages (e.g., the content of the messages). The user interface 2800 also includes a user interface element 2822, which provides an abbreviated set of profile data associated with the present user and enables the user to edit the profile data.

Additionally, in the illustrative embodiment, the user interface 2800 includes a user interface element 2824 with a set of suggested connections (e.g., people that the present user should connect with) and enables the user to view their network in more detail. Further, the user interface 2800 includes a user interface element 2826 (e.g., a search bar) that enables the user to search the system 100 for people, groups, companies, and/or other items within the platform. The user interface 2800 additionally includes a user interface element 2828 that enables the user to provide content to the system 100 (e.g., a post), including one or more images, videos, documents, and/or text. The user interface 2800 also includes a feed 2830, which includes a set of posts provided by users of the system 100. The feed 2830 may be sorted according to criteria selected by the user (e.g., from most recent to least recent, etc.). As shown in FIG. 28B, within the feed 2830, the user may select a user interface element 2842 to comment on a post. Additionally or alternatively, the user may select a user interface element 2844 to indicate their approval of (e.g., like) a post. Further, the user interface 2800 includes a user interface element 2846 to enable the user to share a post in the feed 2830 with one or more other users.

Referring back to FIG. 28A, the user interface 2800 includes a user interface element 2832 that has sponsored content from a vendor. If the user interface 2832 is selected by the user, the system 100, in the illustrative embodiment, provides additional information to the user regarding the sponsored content. Further, the user interface 2800 includes a user interface element 2834 having recent announcements for users and, when selected, may provide additional information pertaining to a particular announcement and/or may display additional announcements. The user interface 2800 additionally includes a user interface element 2848 summarizing upcoming events and enabling the user to view an events calendar. Further, the user interface 2800 includes a user interface element 2836 that shows user groups that the user is a member of. Additionally, the user interface 2800 includes a user interface element 2838 enabling the user to view a user interface for creating a new user group and a user interface element 2840 that, if selected, enables the user to explore (e.g., view more information regarding) user groups available in the platform.

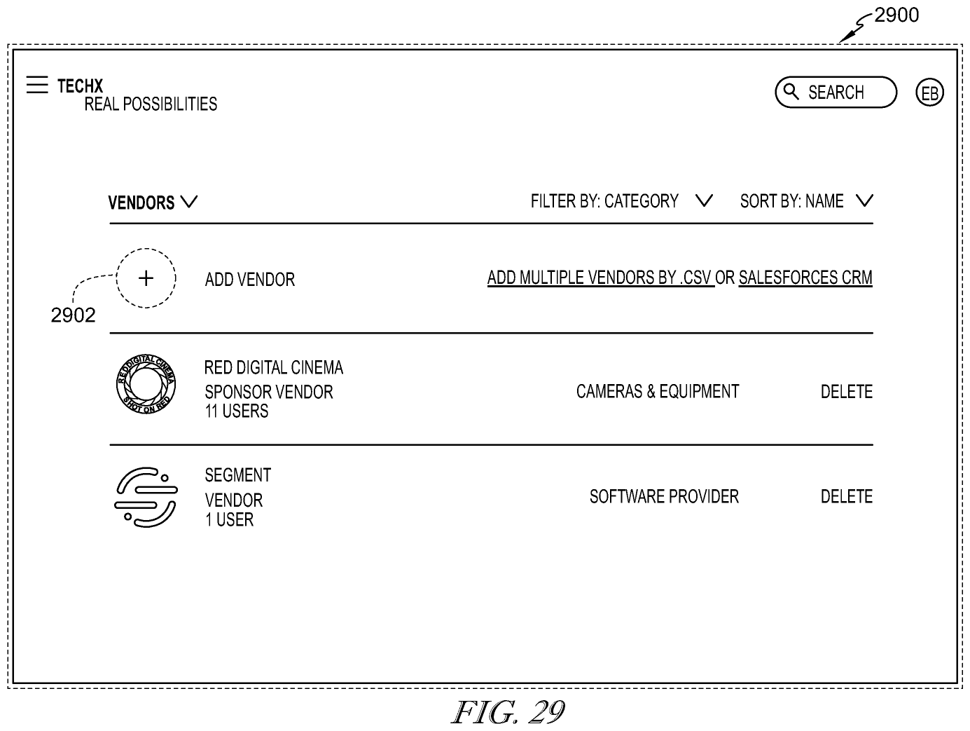

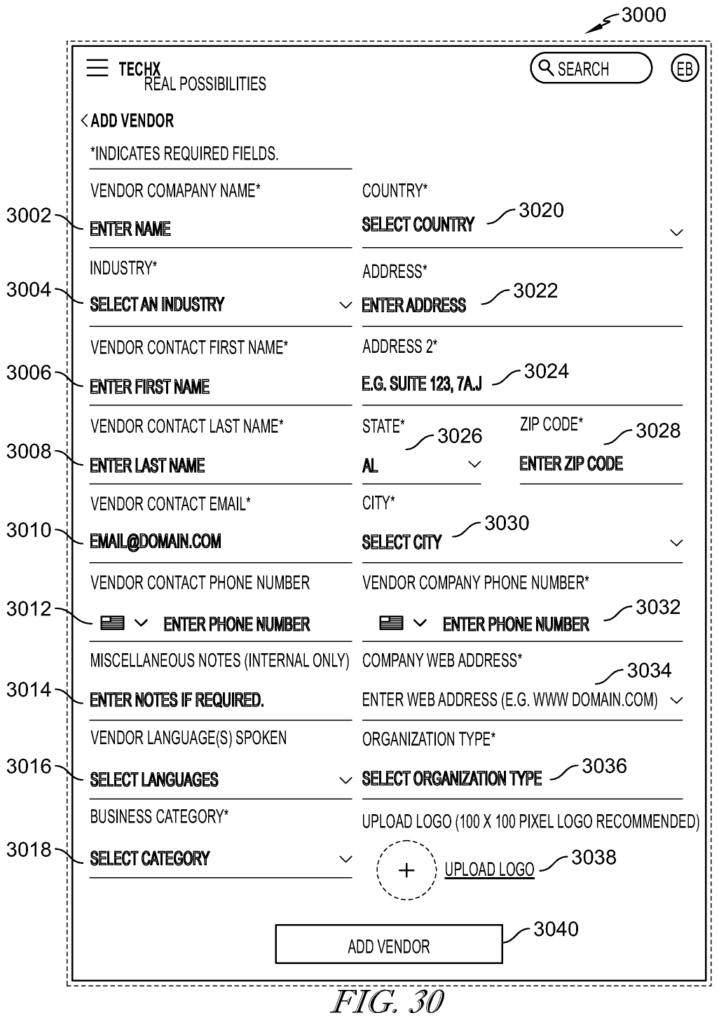

Referring now to FIG. 29, the system 100 may provide a user interface 2900 to enable a user (e.g., a hosting organization) to view accounts for vendors that have been associated with a simulated tradeshow experience hosted by the hosting organization and to create an account for a new vendor (e.g., by selecting the user interface element 2902). In the illustrative embodiment, the system 100 provides the user interface 3000 of FIG. 30 in response to the user selecting the user interface element 2902 from FIG. 29. The user interface 3000 includes a set of user interface elements 3002, 3004, 3006, 3008, 3010, 3012, 3014, 3016, 3018, 3020, 3022, 3024, 3026, 3028, 3030, 3032, 3034, 3036, 3038, 3040 to provide information about the vendor, including the vendor name, the vendor's industry, a first name and last name of a contact person for the vendor, an email address for the vendor, a phone number for the vendor, notes regarding the vendor, language(s) spoken by the vendor, a business category of the vendor, the country of the vendor, an address of the vendor, a company phone number for the vendor, a web address of the vendor, an organization type of the vendor, and a logo of the vendor. The user may upload the information (e.g., to the server compute device 110) by selecting the user interface element 3040.

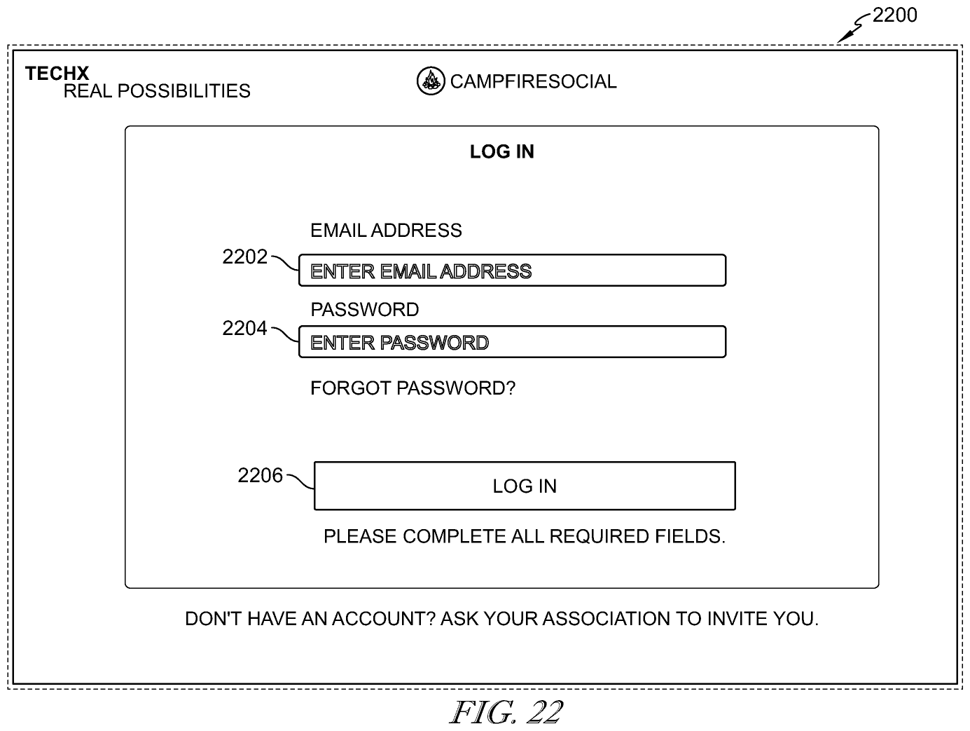

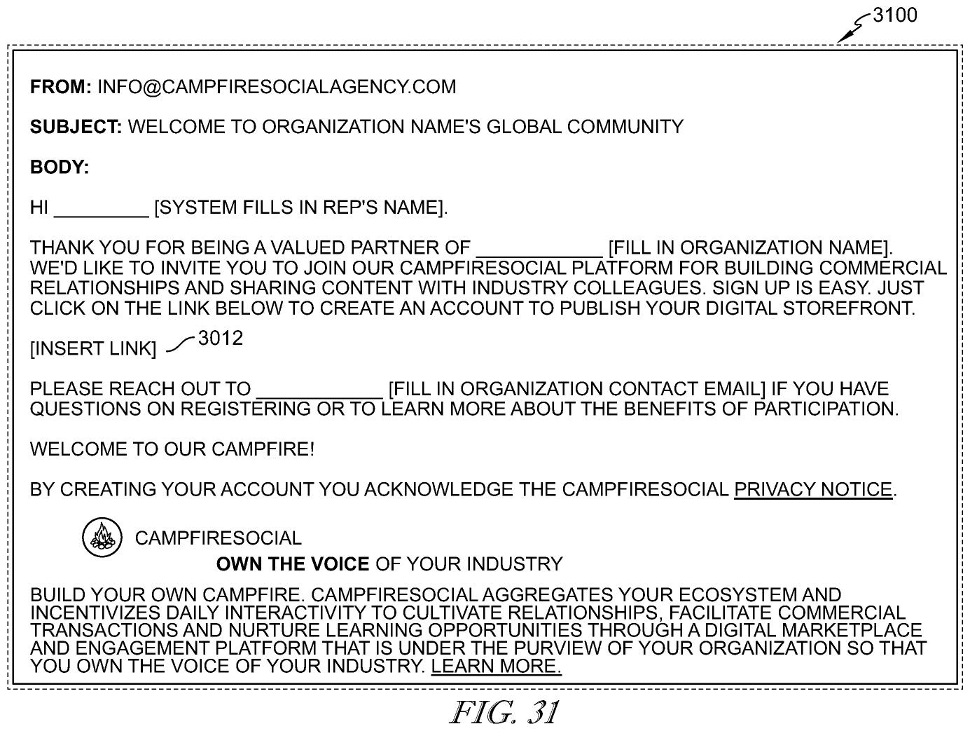

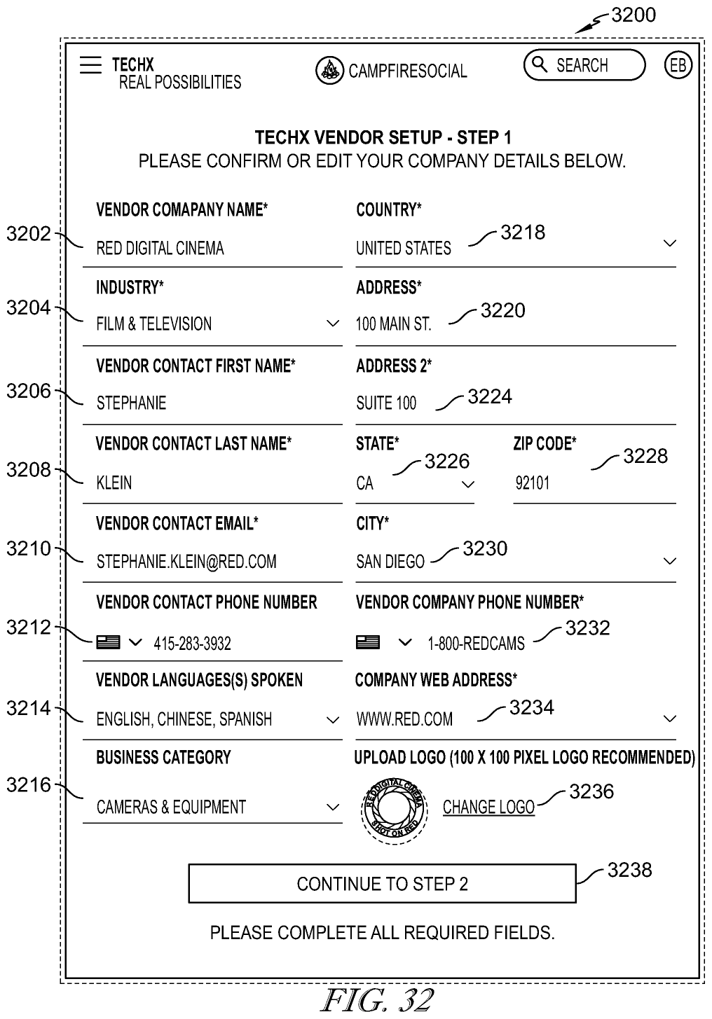

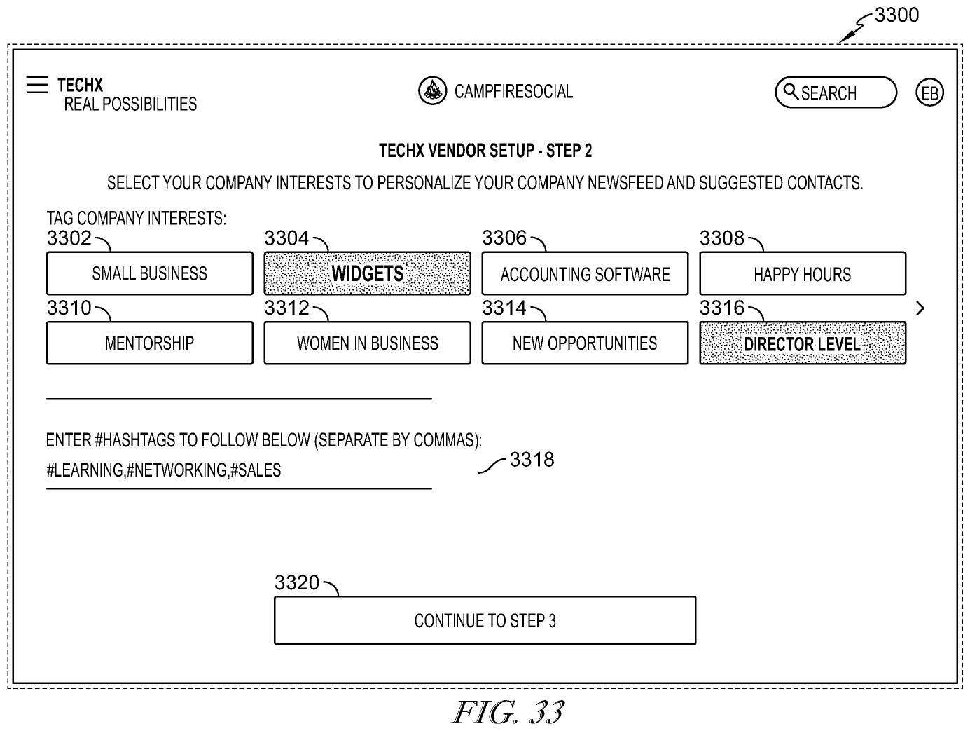

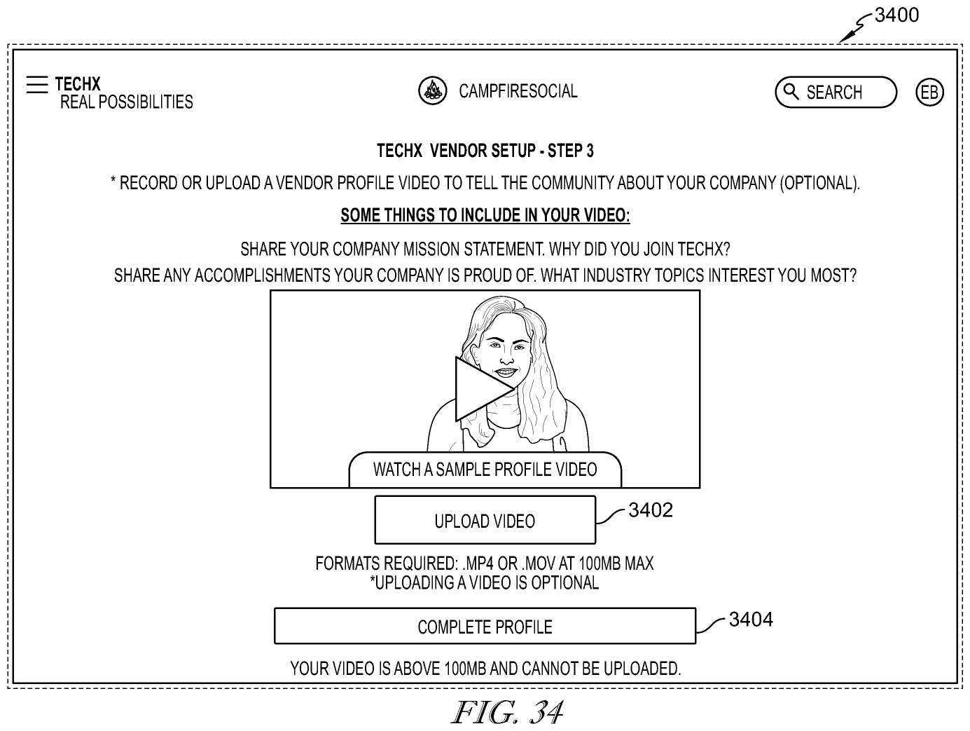

Referring now to FIG. 31, the system 100 (e.g., the server compute device 110) provides, in response to obtaining the vendor information from the user interface 2900, a notification 3100 to the vendor (e.g., displayed by a vendor compute device 140, 142). In the illustrative embodiment, the notification is an email that includes a link 3102 that, when selected by the user (e.g., vendor), enables the vendor to register their account with the system 100 (e.g., with the server compute device 110). In the illustrative embodiment, the system 100 provides the user interface 3200 of FIG. 32 to the vendor in response to selection of the link 3102 and after a password creation and initial log in process similar to those described with reference to FIGS. 21 and 22. Using the user interface elements 3202, 3204, 3206, 3208, 3210, 3212, 3214, 3216, 3218, 3220, 3222, 3224, 3226, 3228, 3230, 3232, 3234, 3236, 3238, the user (e.g., vendor) may review, edit, and submit information about the vendor that may have been initially provided by the hosting organization (e.g., through the user interface 3000 of FIG. 30). Subsequently, in the illustrative embodiment, the system 100 provides the user interface 3300 of FIG. 33, in which the user (e.g., vendor) may utilize user interface elements 3302, 3304, 3306, 3308, 3310, 3312, 3314, 3316, 3318, 3320 to provide information regarding interests of the vendor and topic designation data (e.g., hash tags concatenated with one or more words). Subsequently, in the illustrative embodiment, the system 100 provides the user interface 3400 of FIG. 34. The user (e.g., vendor) may utilize the user interface elements 3402, 3404 to submit a video about the vendor, such as the vendor's mission statement, why the vendor joined the hosting organization (e.g., the industry trade group), accomplishments of the vendor, industry topics of interest to the vendor, and/or other information. Subsequently, the system 100 may provide a user interface similar to the user interface 2800 described above with reference to FIG. 28.

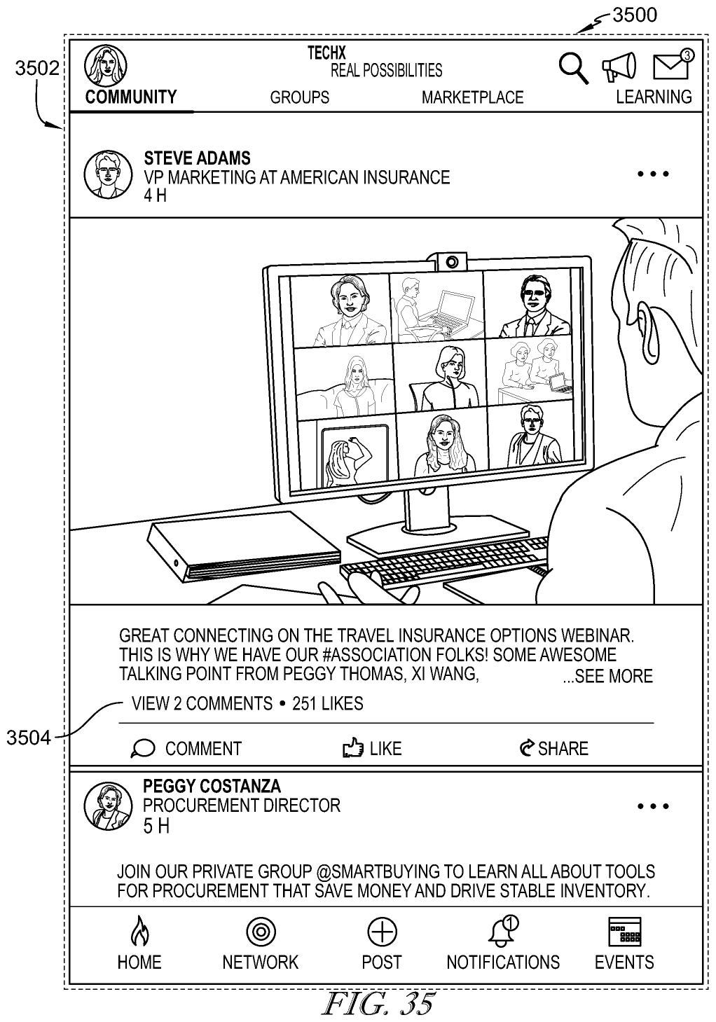

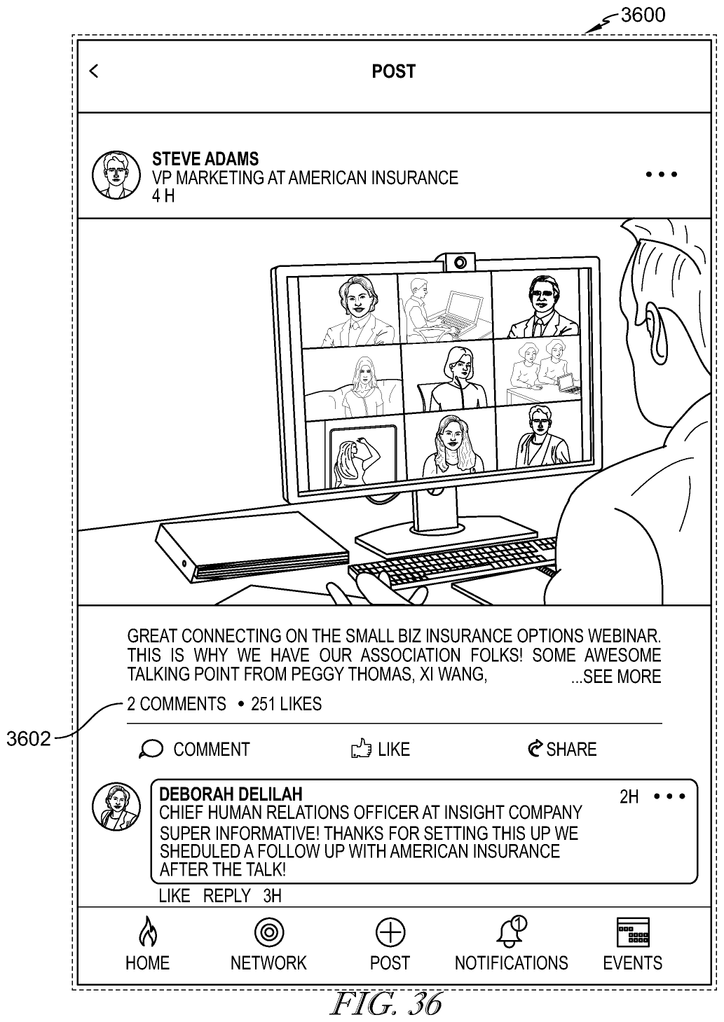

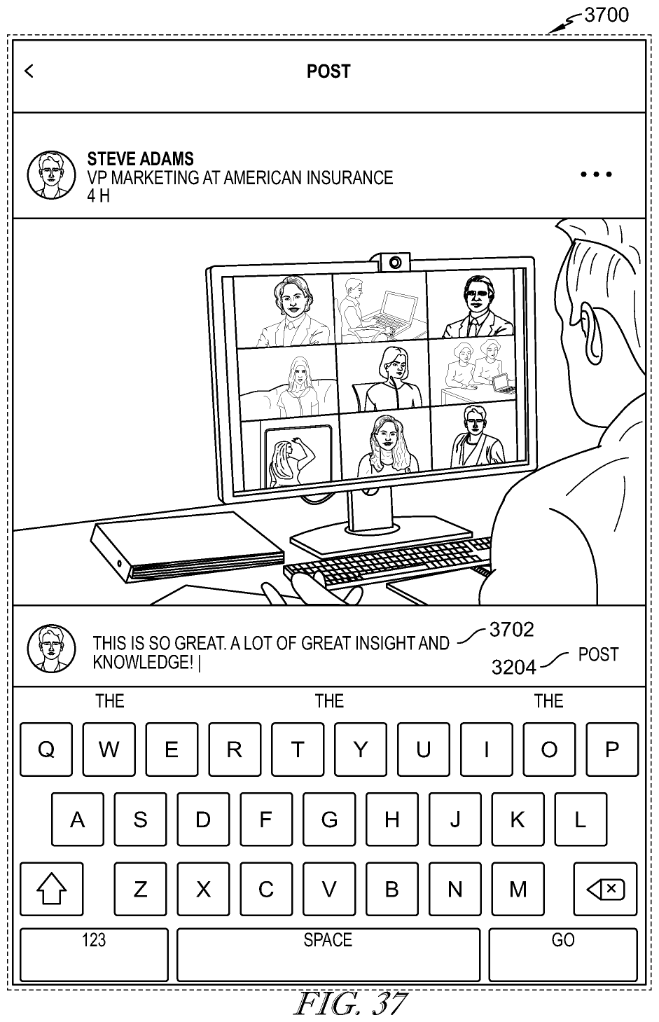

Referring to FIG. 35, the system 100 may provide a user interface 3500 for a logged in user that is formatted for a relatively small screen (e.g., a smart phone). The user interface 3500, in the illustrative embodiment, includes a feed 3502 of posts shared by users of the system 100. In response to selection of a user interface element 3504, the system 100 provides the user interface 3600 of FIG. 36, in which a user may view one or more comments associated with a post. Further, in response to a user's selection of a user interface element 3602, the system 100, in the illustrative embodiment, provides a user interface 3700, shown in FIG. 37, to enable a user to enter (e.g., via the user interface element 3702) and submit (e.g., via selection of the user interface element 3704) a comment relating to a post.

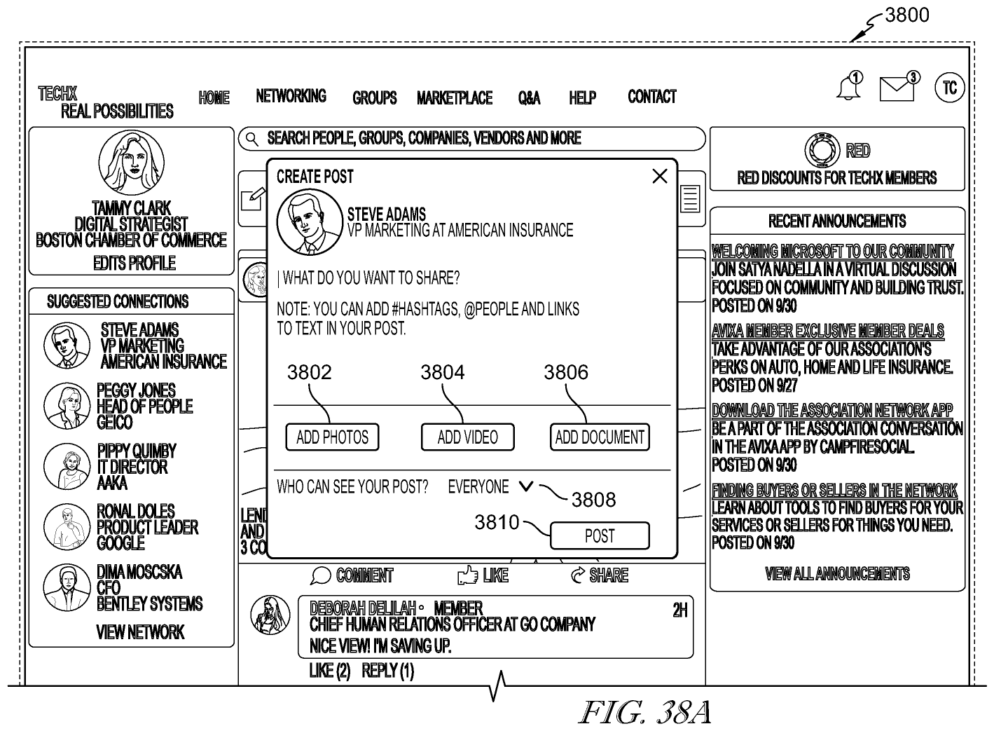

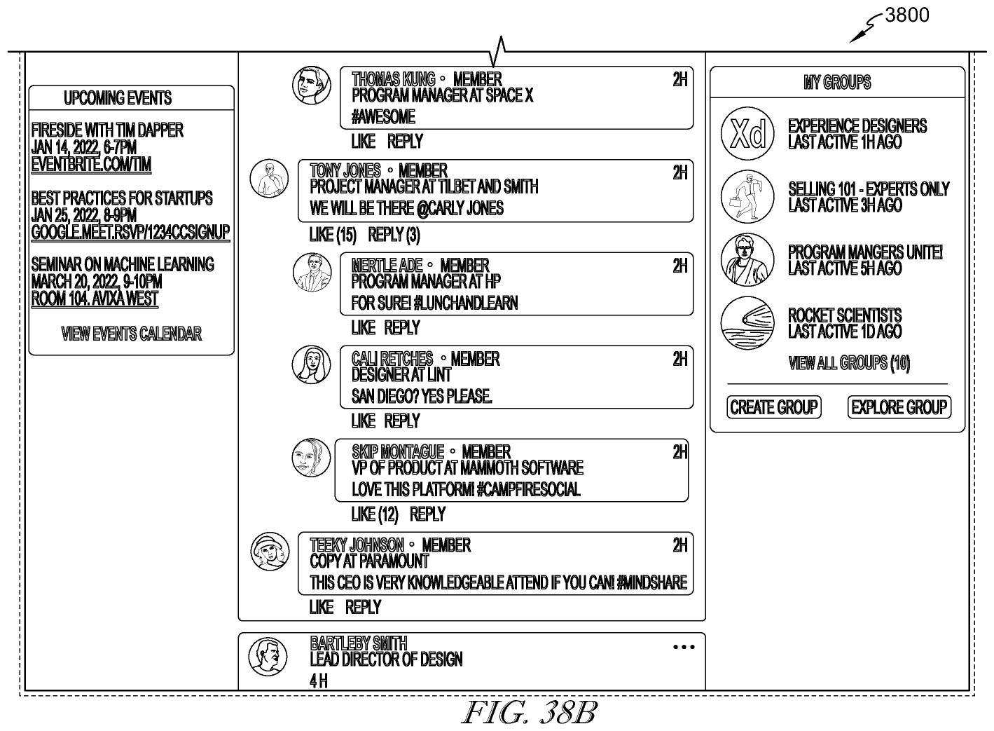

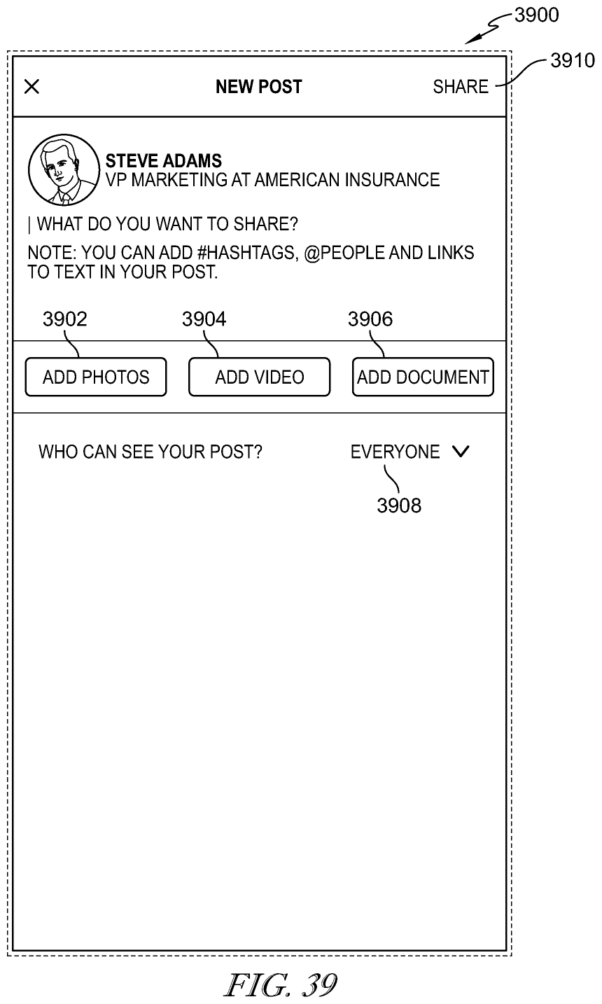

Referring now to FIGS. 38A and 38B, the system 100 may provide a user interface 3800 formatted for a larger screen (e.g., of a tablet, a notebook computer, a desktop computer, etc.) to enable a user to create and submit a post to be viewed by other users of the system 100. The user interface element 3802 enables the user to add one or more photos to the post. Additionally, the user interface element 3804 enables the user to add one or more videos to the post. Further, the user interface element 3806 enables the user to add one or more documents to the post. A user interface element 3808 enables the user to select who (e.g., which users of the system 100) can see the post and the user interface element 3810, when selected, submits the post to the server compute device 110 (e.g., to be provided to other users). Referring now to FIG. 39, the system 100 may provide a user interface 3900, formatted for a smaller screen (e.g., of a mobile compute device such as a smart phone) for creating a post to be shared with other users. Similar to the user interface 3800 of FIGS. 38A and 38B, the user interface 3900 includes user interface elements 3902, 3904, 3906 for adding photo(s), video(s), and/or document(s). Additionally, the user interface 3900 includes a user interface item 3908 to enable the user to select who can view the post, once submitted. Additionally, the user interface 3900 includes a user interface element 3910 that, when selected, submits the post to the server compute device 110 to be shared with other users of the system 100.

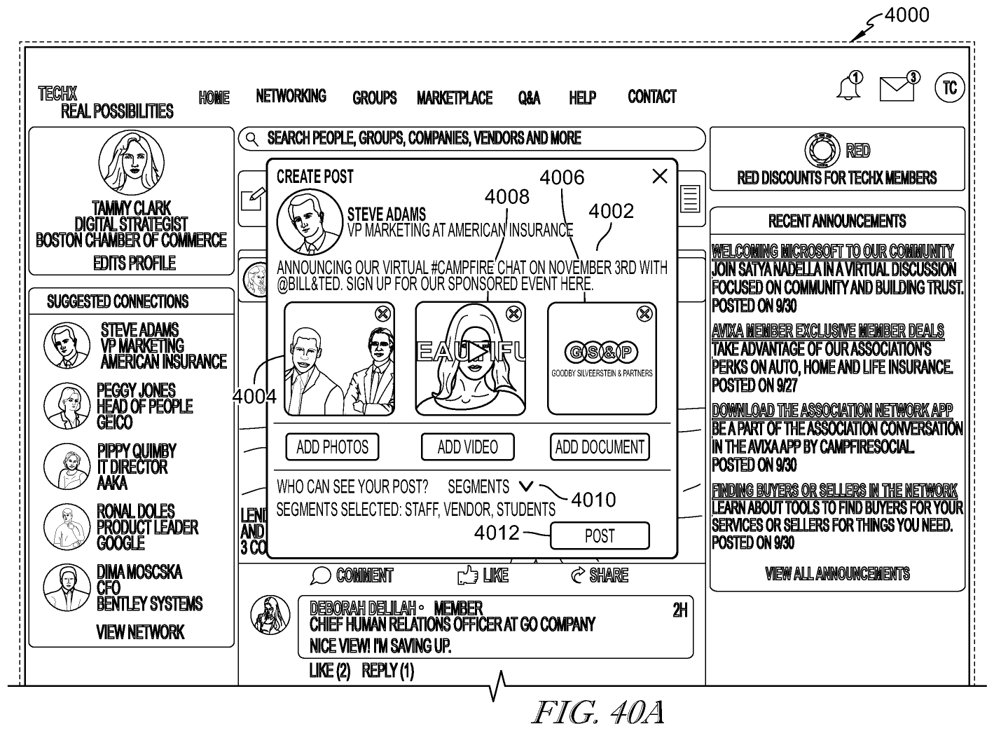

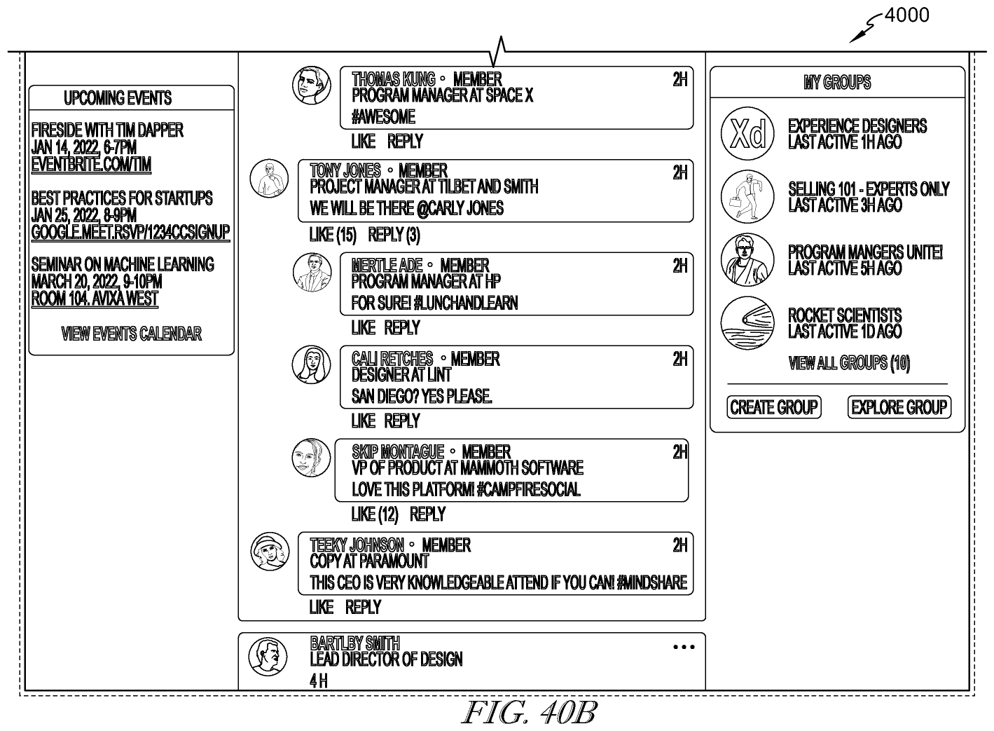

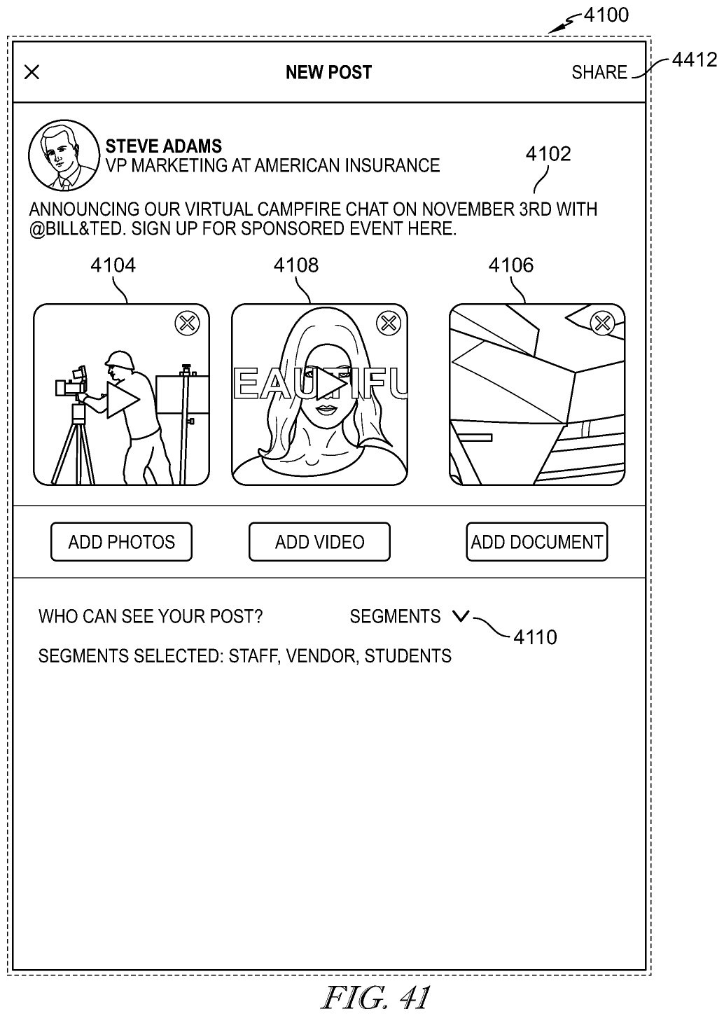

Referring now to FIGS. 40A and 40B, the system 100 may provide a user interface 4000 formatted for relatively large screens (e.g., on a tablet, a notebook computer, a desktop computer, etc.) for creating and submitting a post. The user interface 4000 is similar to the user interface 3800 of FIGS. 38A and 38B, but includes information submitted by the user. As shown, the post includes text 4002, including the topic designation data “#campfire” and a tag addressing a particular user “@bill&ted”. The post also includes a set of photos, as represented by user interface elements 4004, 4006. Additionally, the post includes a video, as represented by user interface element 4008. The user has selected, with the user interface element 4010, certain roles (segments) of users that will be allowed to view the post. In response to the user selecting the user interface element 4012, the post will be submitted to the server compute device 110 to be shared with other users (e.g., users falling within the selected roles or segments). Referring now to FIG. 41, a corresponding user interface 4100 formatted for a smaller screen (e.g., for a smart phone), includes user interface elements 4104, 4106, 4108, 4110, 4112 having functionality similar to the functionality of corresponding user interface elements 4004, 4006, 4008, 4010, 4012 described above with reference to the user interface 4000.

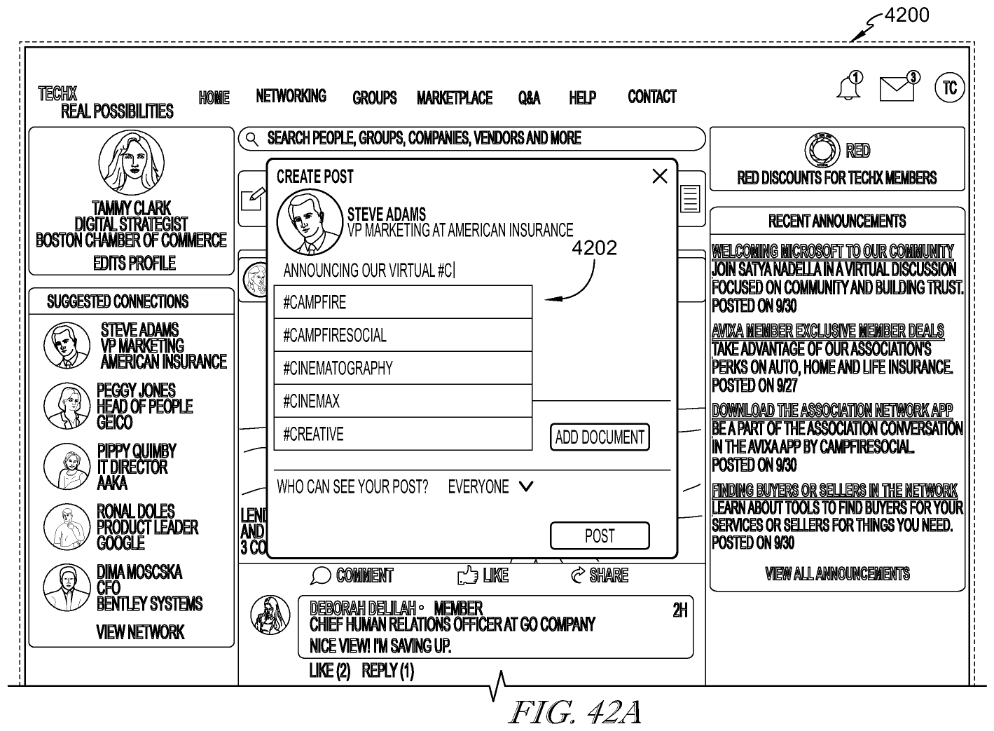

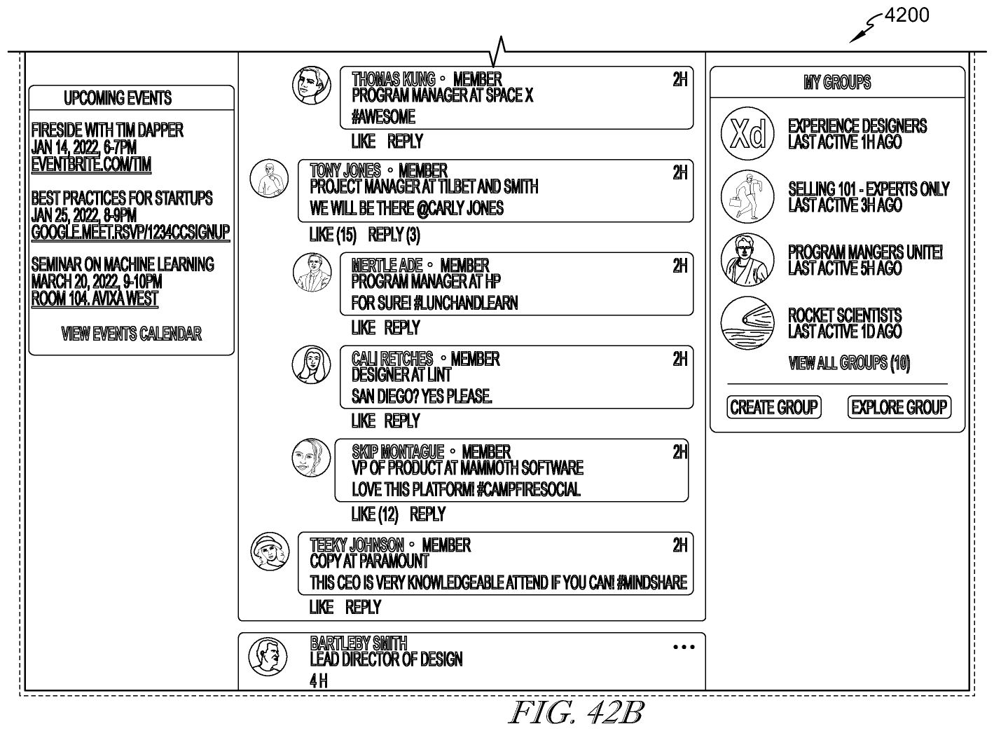

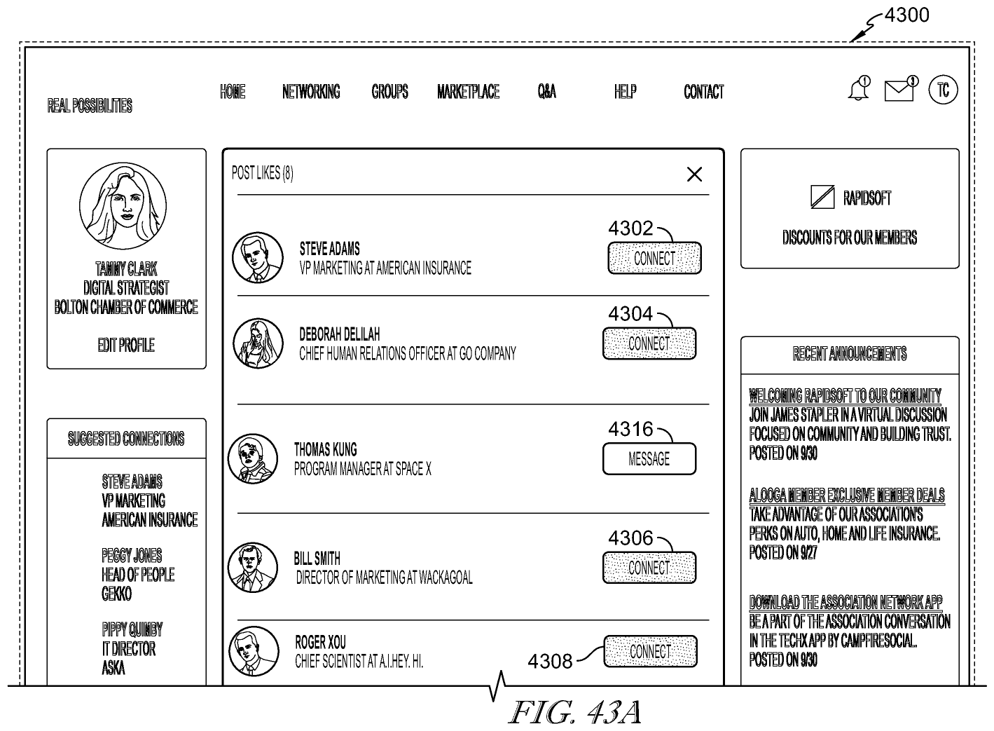

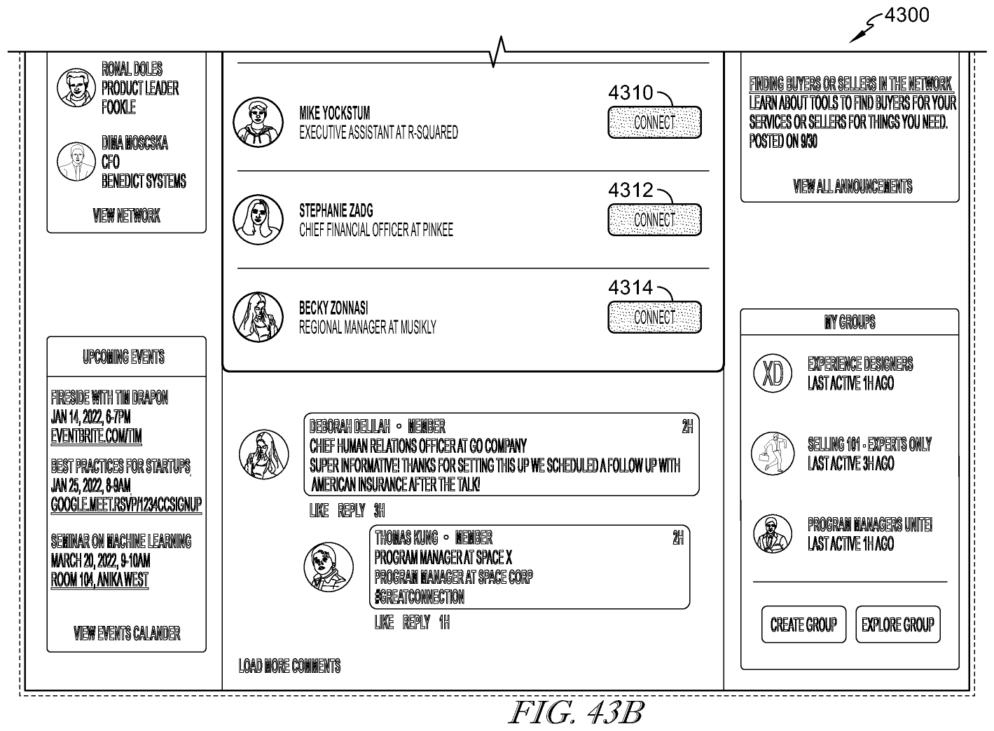

Referring now to FIGS. 42A and 42B, the system 100 may provide a user interface 4200 formatted for a relatively large screen (e.g., a tablet, a notebook computer, a desktop computer, etc.) in which, as the user types a post containing topic designation data (e.g., a hashtag followed by a word), the user interface 4200 provides, in user interface element 4202, suggestions of known topics that the user may select from to complete the topic designation data. Referring to FIGS. 43A and 43B, the system 100 may provide a user interface 4300, formatted for a relatively large screen (e.g., a tablet, a notebook computer, a desktop computer, etc.) that indicates approvals (e.g., likes) of a user's post and user interface elements 4302, 4304, 4306, 4308, 4310, 4312, 4314 enabling the user to connect with other users that approved of (e.g., liked) the user's post. Additionally, the user interface 4300 includes a user interface element 4316 that enables the user to send a message to a user that the present user is already connected with.

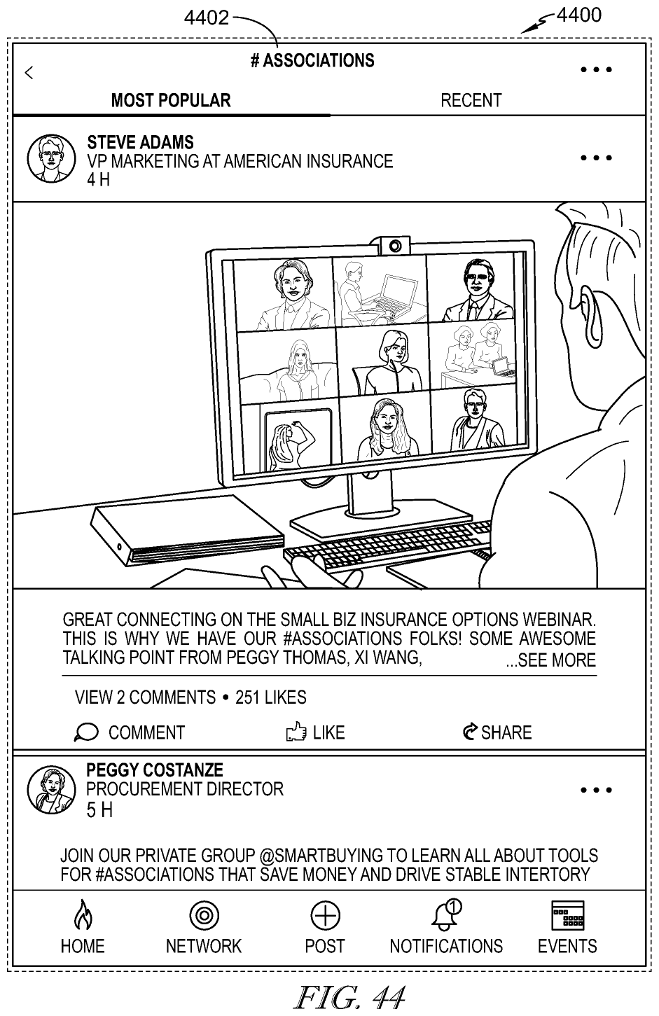

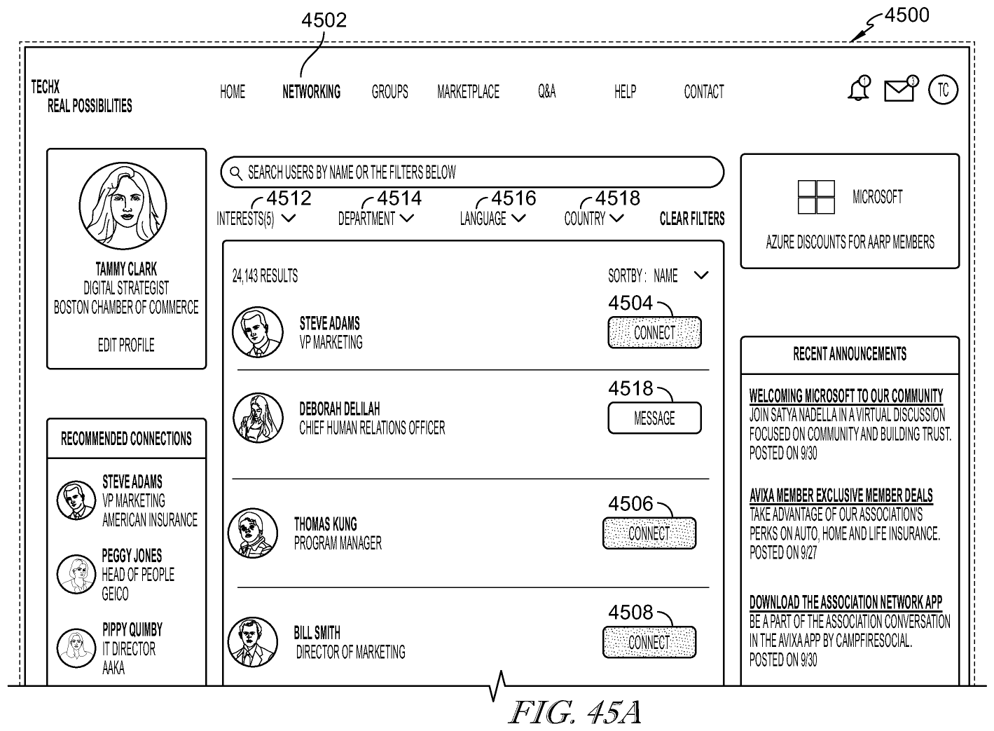

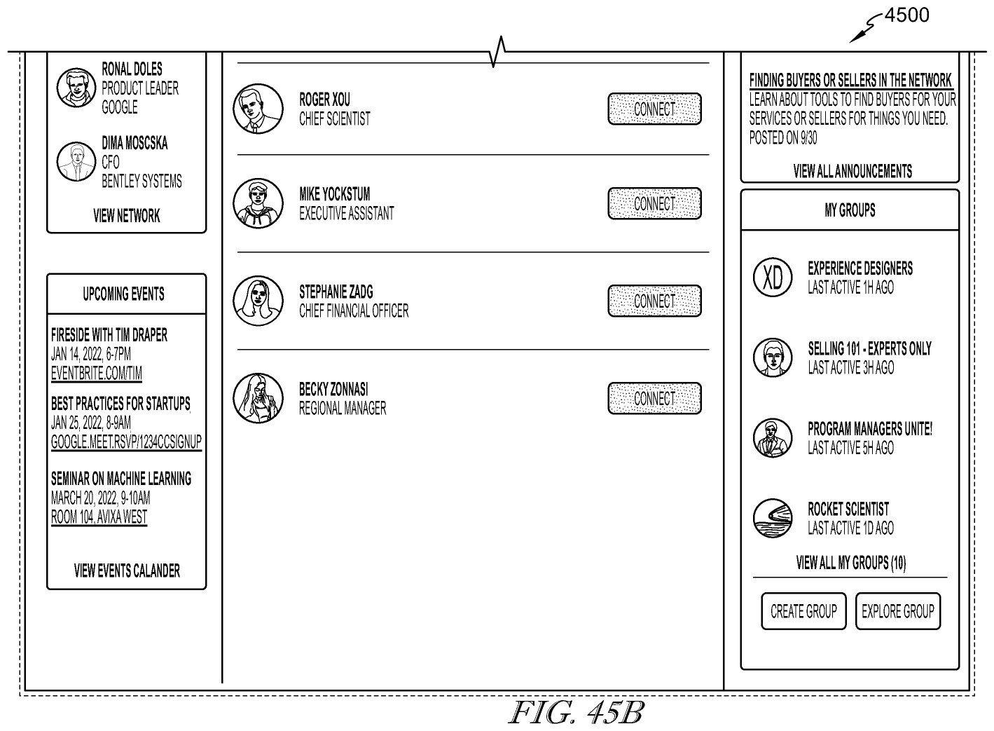

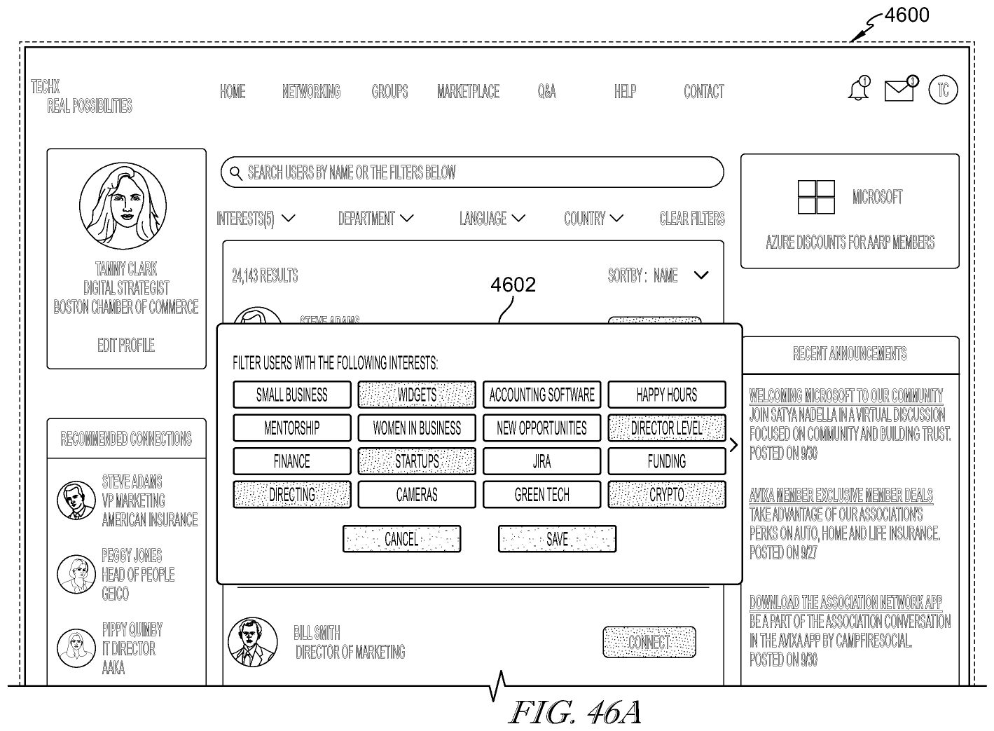

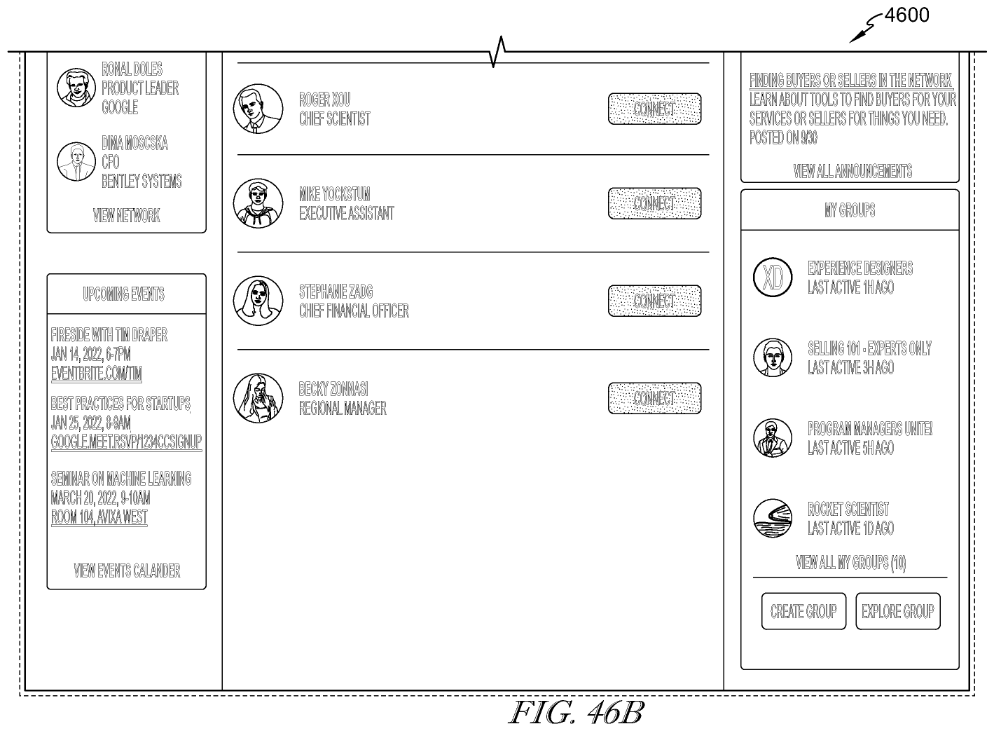

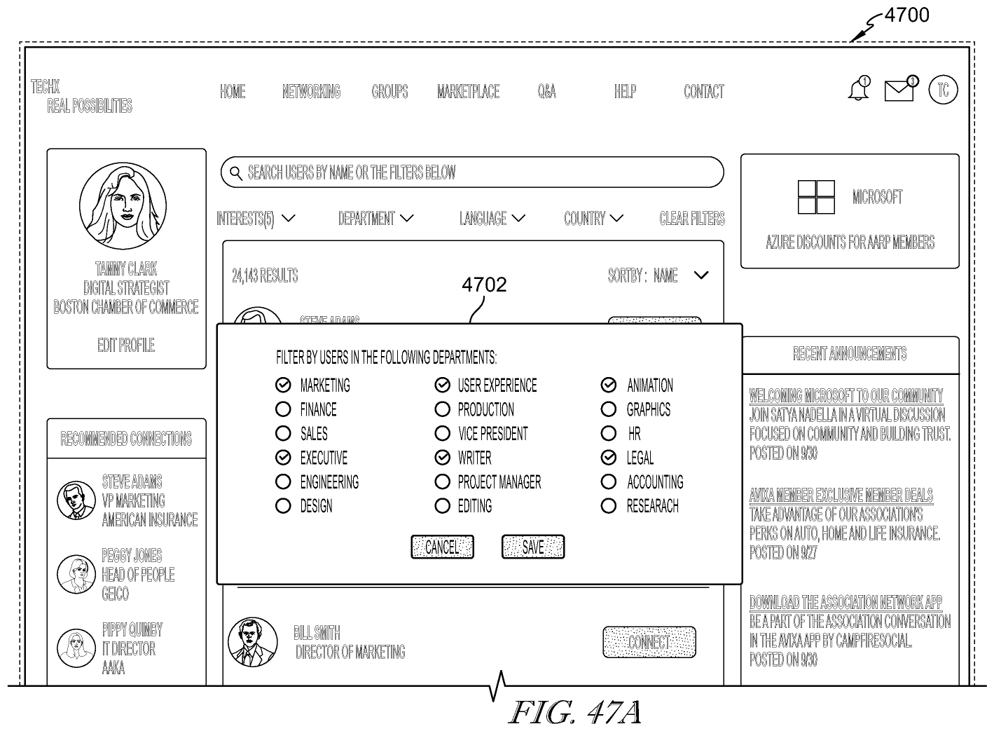

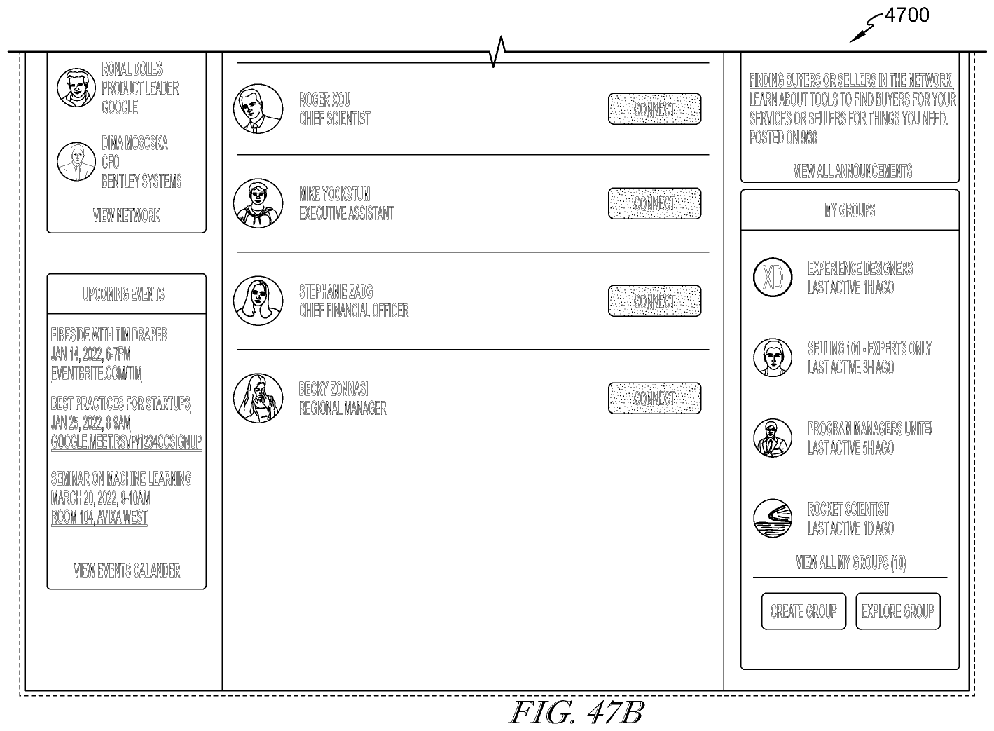

Referring now to FIG. 44, the system may provide a user interface 4400 that shows a feed of posts that are filtered by topic designation data, as indicated in the user interface element 4402. In the example, the feed is filtered to show only posts relating to associations (e.g., that include the text “#associations”). Referring now to FIGS. 45A and 45B, the system 100 may provide a networking user interface 4500 (e.g., in response to selection of a corresponding user interface element 4502). The user interface 4500 includes a list of users of the system 100 (e.g., users participating in a simulated tradeshow associated with a particular hosting organization, in this case “TECHX”) that the present user may interact with. In the list, for each user that the present user is not currently connected with, a corresponding user interface element 4504, 4506, 4508, 4510, 4512, 4514, 4516 is available to enable the present user to send a connection request to that user. For a user that the present user is already connected with, the user interface 4500 includes a user interface element 4518 to enable the present user to send a message to that user. The set of users that appear on the user interface 4500 may be filtered according to various criteria, such as interest(s) (e.g., user interface element 4512), department (e.g., user interface element 4514), language (e.g., user interface element 4516), and/or country (e.g., user interface element 4518). In response to selection of the user interface element 4512, the system 100 may provide a user interface 4600 shown in FIGS. 46A and 46B, to enable the present user to select one or more interests to filter users by (e.g., in the window 4602). Similarly, if the user selects the user interface element 4514 in the user interface 4500, the system 100 may provide the user interface 4700 of FIGS. 47A and 47B, which includes a window 4702 in which the present user may select department(s) to filter the set of users by.

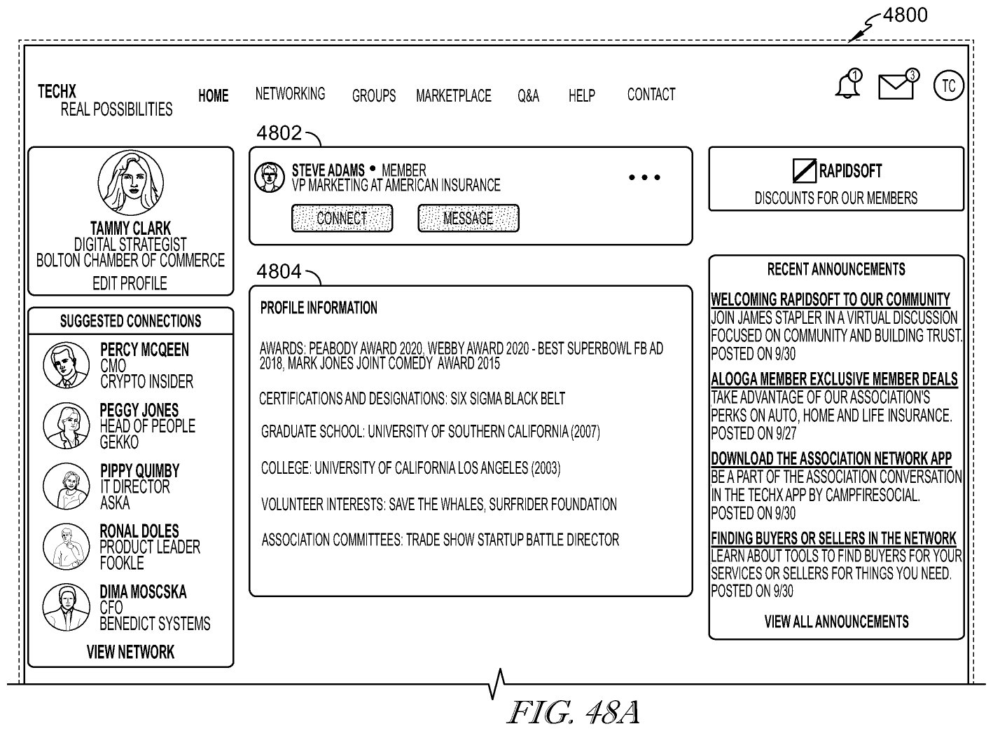

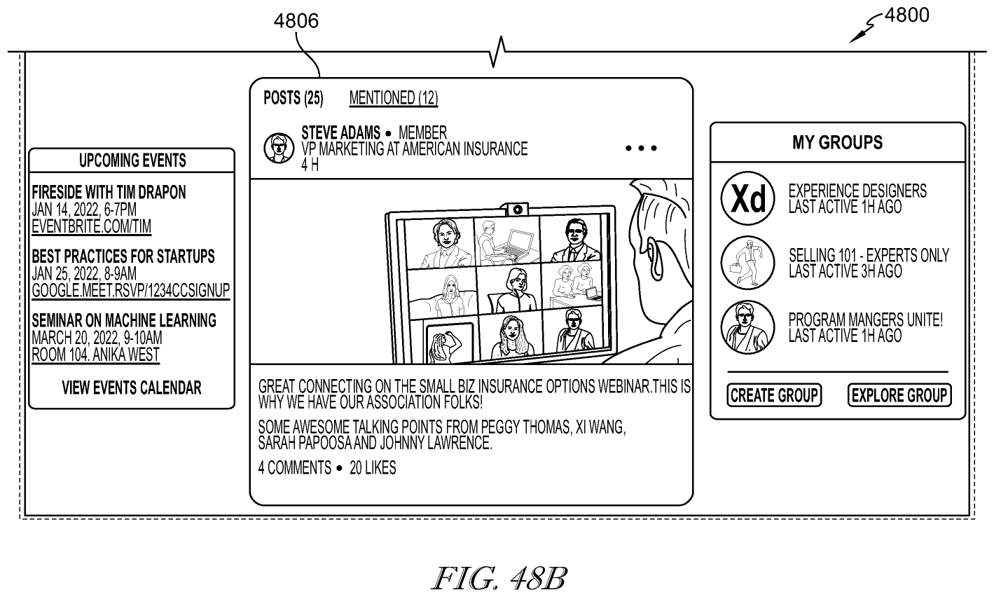

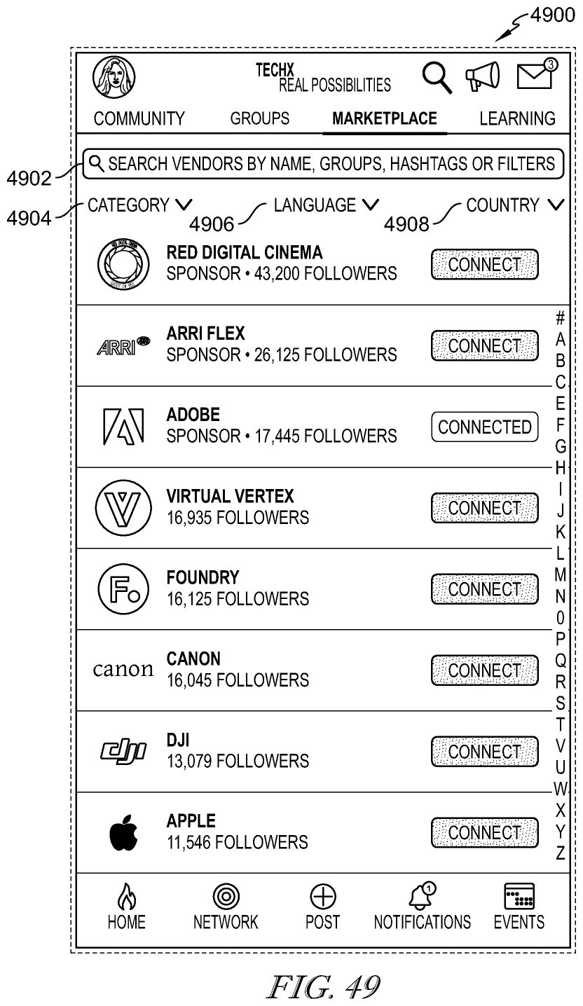

Referring now to FIGS. 48A and 48B, the system 100 may provide a user interface 4800 focusing on a particular user (e.g., a user selected by the present user). The user interface 4800 includes a section 4802 with a short summary of the selected user and options to connect with or send a message to the selected user, a section 4804 with profile data for the selected user, and a section 4806 that enables the present user to view posts from the selected user or posts in which the selected user has been mentioned. Referring now to FIG. 49, the system 100 may provide a user interface 4900 for a vendor marketplace. The user interface 4900 includes user interface elements 4902, 4904, 4906, 4908 for searching a list of vendors by name, groups, hashtags (e.g., topic designation data), category, language, and/or country.

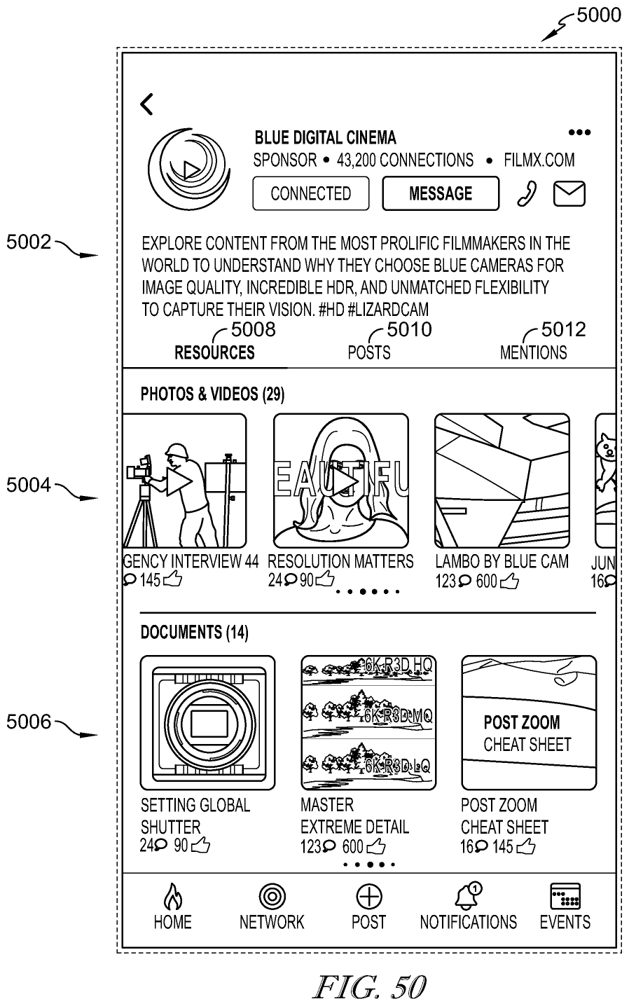

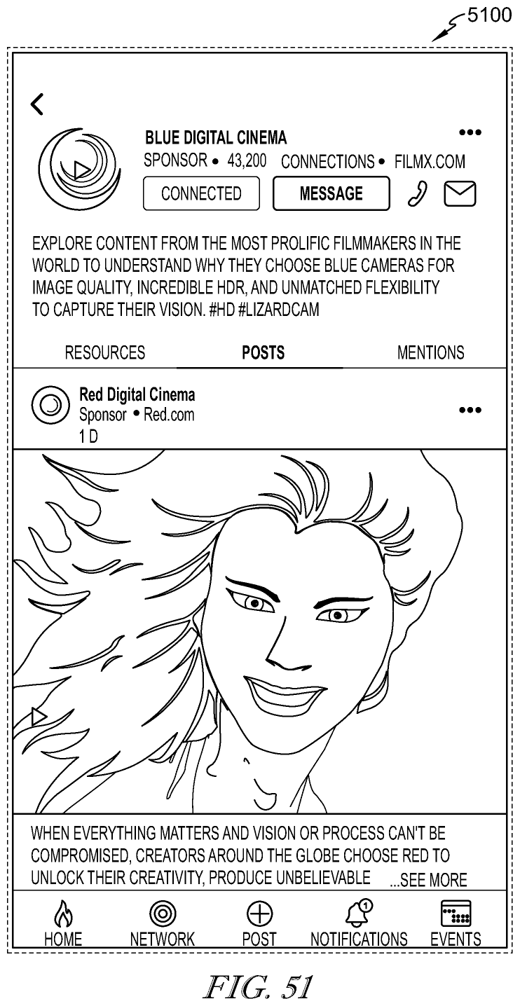

The resulting list of vendors matching the search criteria indicates whether the present user is already connected with a given vendor and if, not, provides a user interface element to connect with the vendor. In response to selection of a particular vendor, the system 100 may provide a user interface 5000 shown in FIG. 50 with additional information about the selected vendor (e.g., “BLUE DIGITAL CINEMA”). The user interface 5000 includes a short description of the vendor (e.g., in the user interface element 5002), a user interface element 5004 representing set of photos and videos uploaded by the vendor, and a user interface element 5006 representing a set of documents uploaded by the vendor. The user interface 5000 additionally includes user interface elements 5008, 5010, 5012 to switch between a view of resources (e.g., the photos, videos, and documents uploaded by the vendor), posts from the vendor, and mentions of the vendor in posts. A user interface 5100 shown in FIG. 51 includes posts from the vendor (e.g., in response to selection of the user interface element 5010 in FIG. 50).

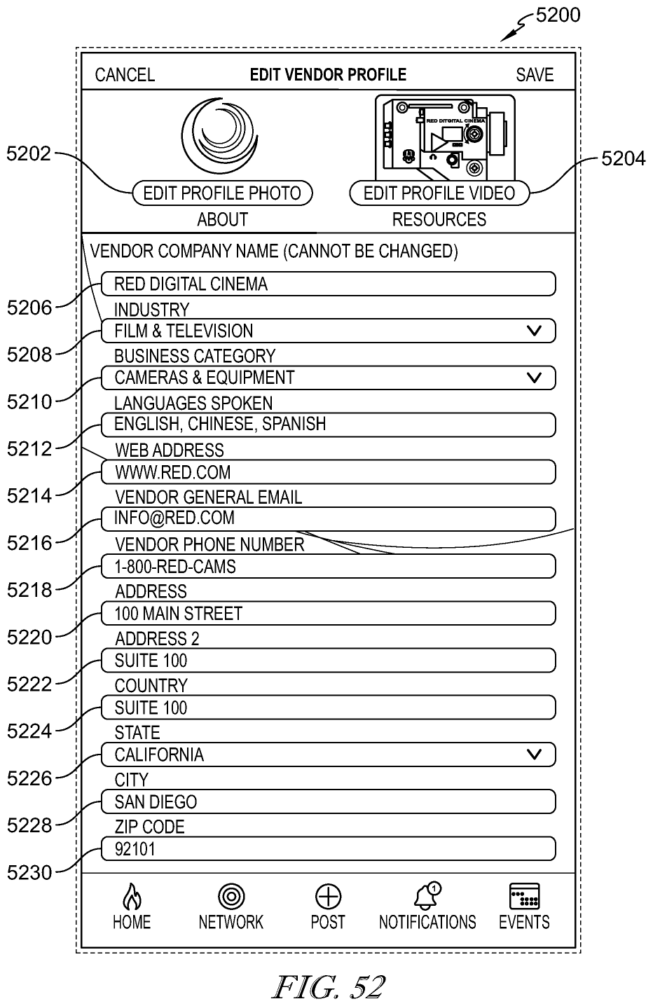

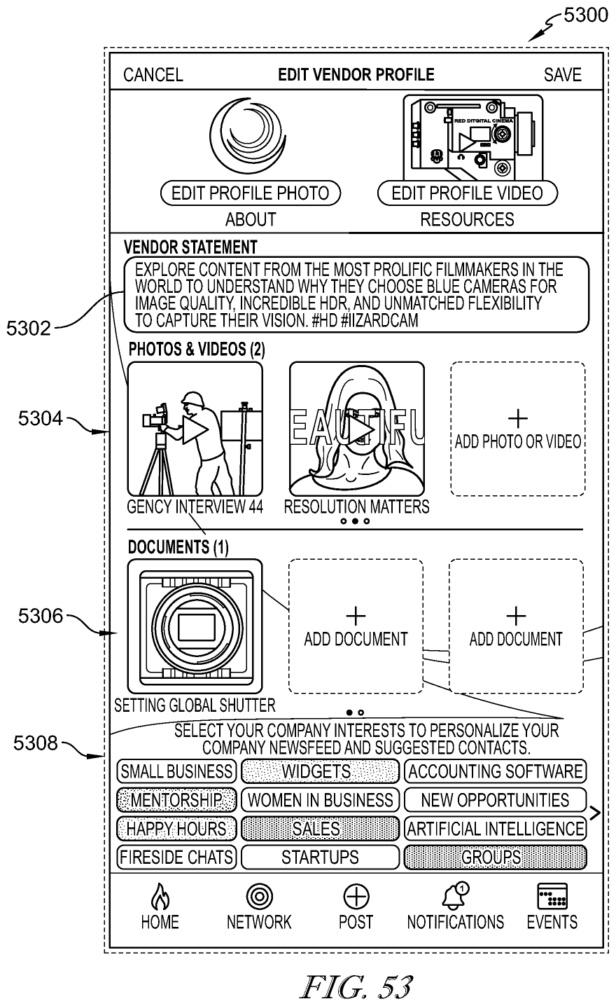

Referring now to FIG. 52, the system 100 may provide a user interface 5200 that includes user interface elements 5202, 5204, 5206, 5208, 5210, 5212, 5214, 5216, 5218, 5220, 5222, 5224, 5226, 5228, 5230 usable for viewing and/or editing profile data for a vendor. As shown, profile data that may be viewed and/or edited include a profile photo, a profile video, the vendor name, the industry that the vendor operates in, a business category of the vendor, languages spoken by the vendor, a web address of the vendor, an email address of the vendor, a phone number of the vendor, and address information for the vendor. Similarly, the system 100 may provide a user interface 5300, shown in FIG. 53 for viewing and editing additional information pertaining to the vendor. For example, a user interface element 5302 (e.g., a text box) enables the user (e.g., the vendor) to view and edit a short statement about the vendor, a user interface element 5304 represents a set of photos and videos associated with the vendor, a user interface element 5306 represents a set of documents associated with the vendor, and a user interface element 5308 represents a set of interests associated with the vendor. The items associated with the user interface elements 5302, 5304, 5306, 5308, in the illustrative embodiment may be viewed and edited (e.g., changed) by the user (e.g., vendor).

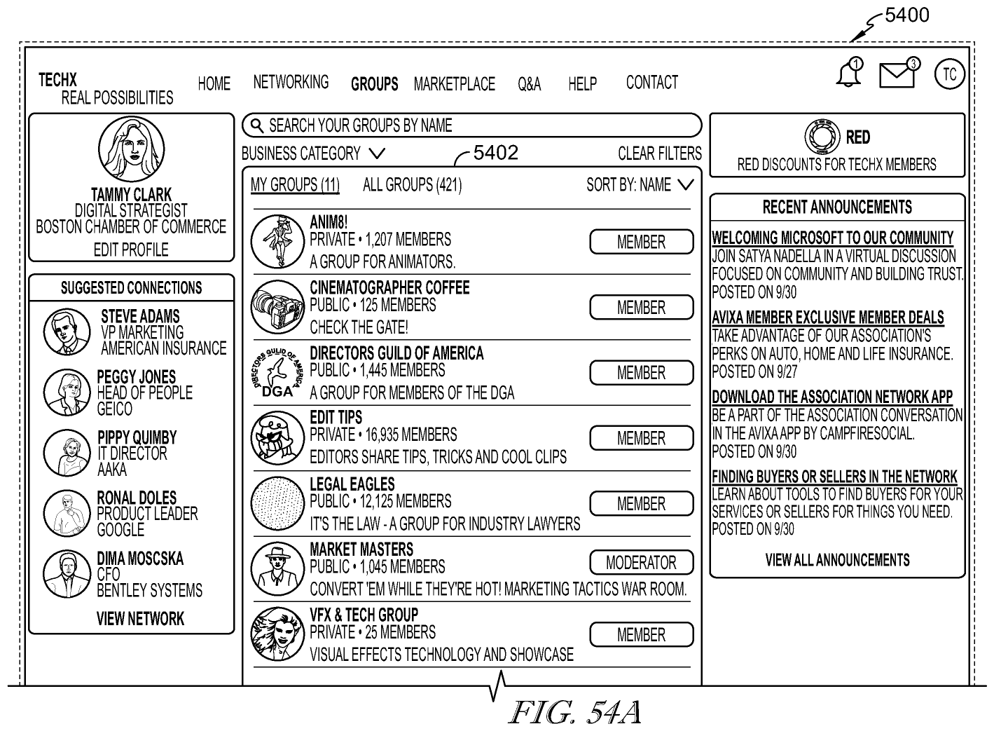

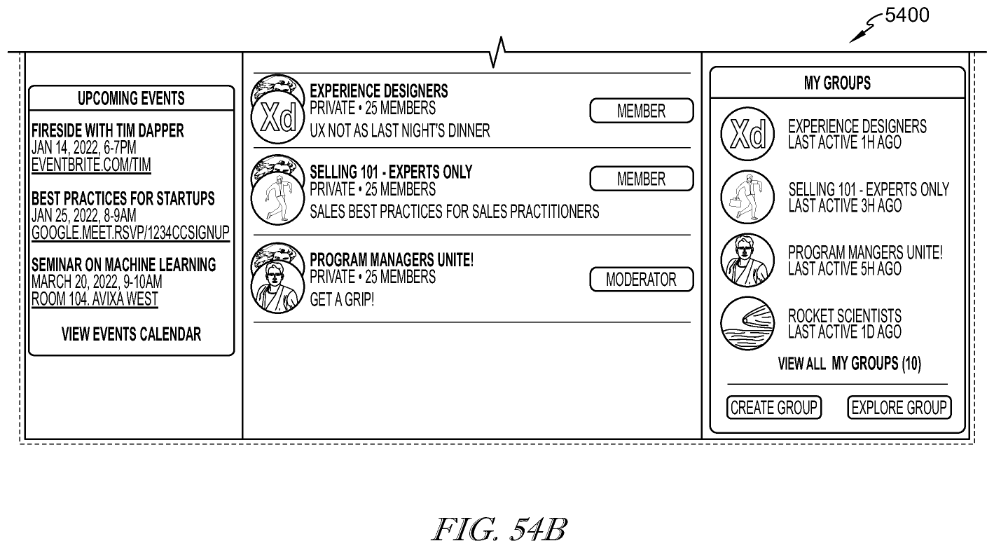

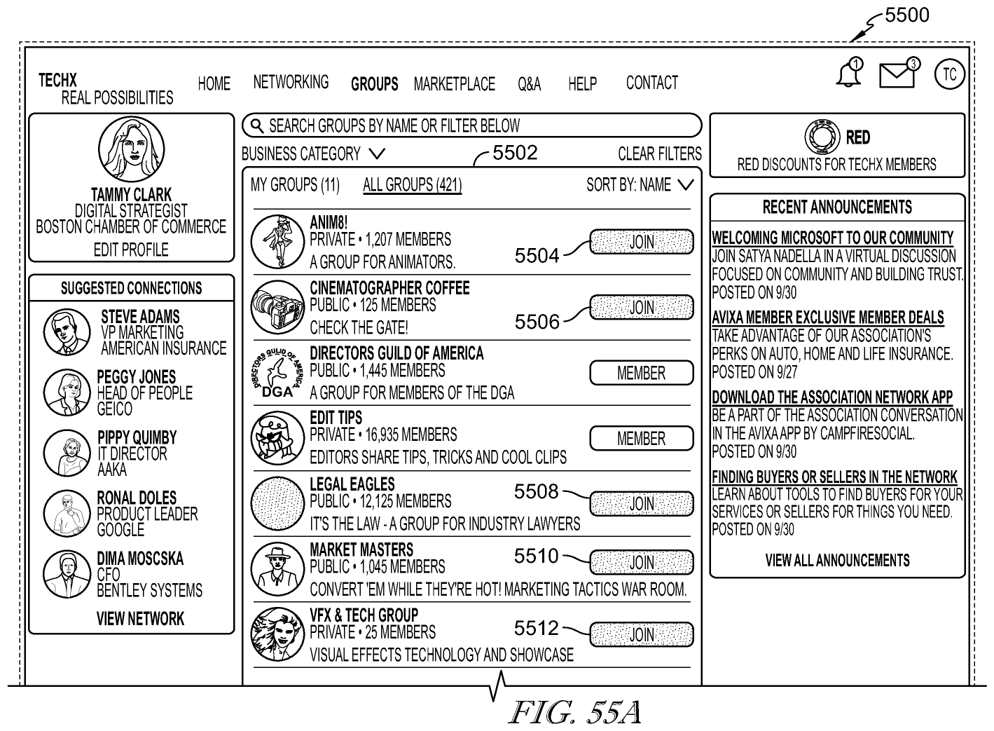

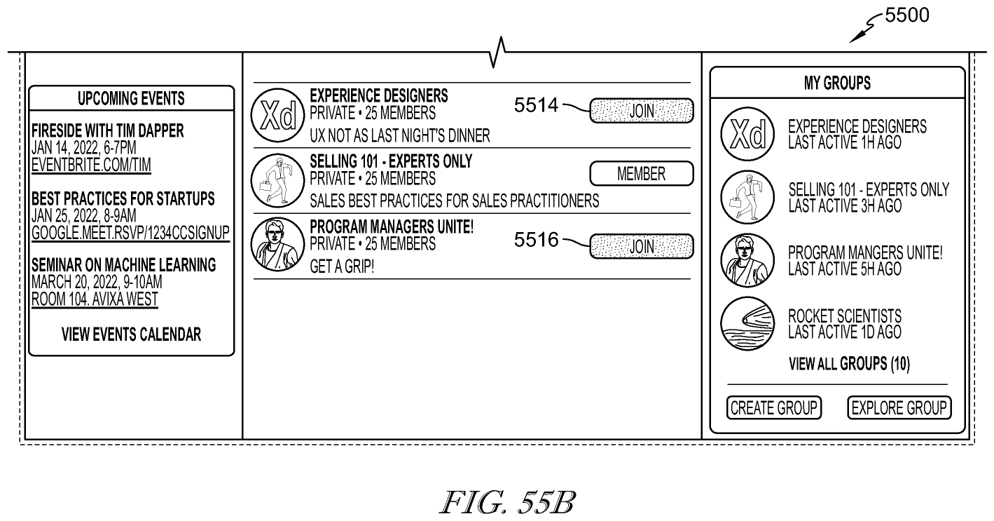

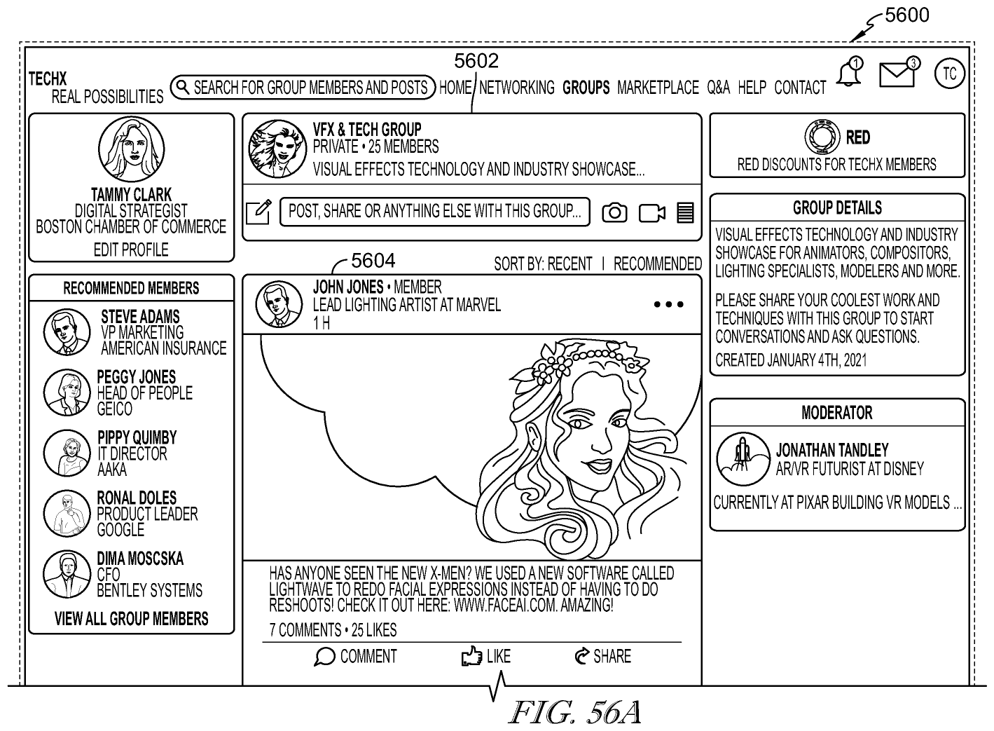

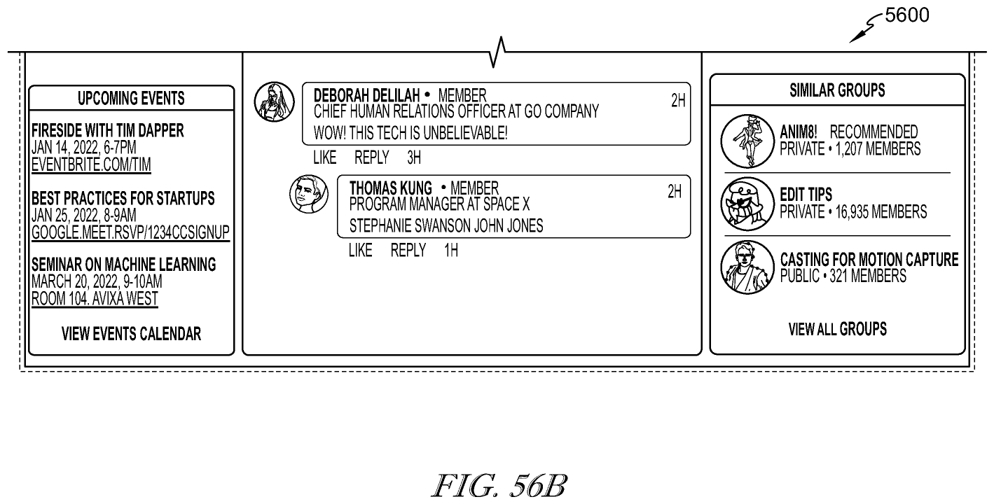

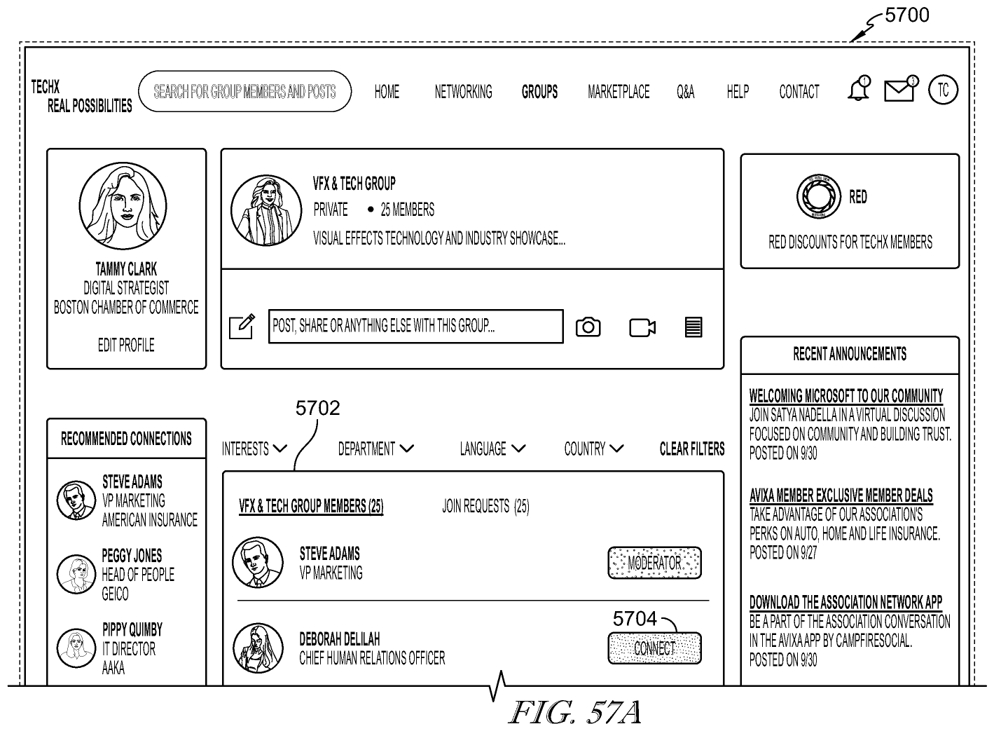

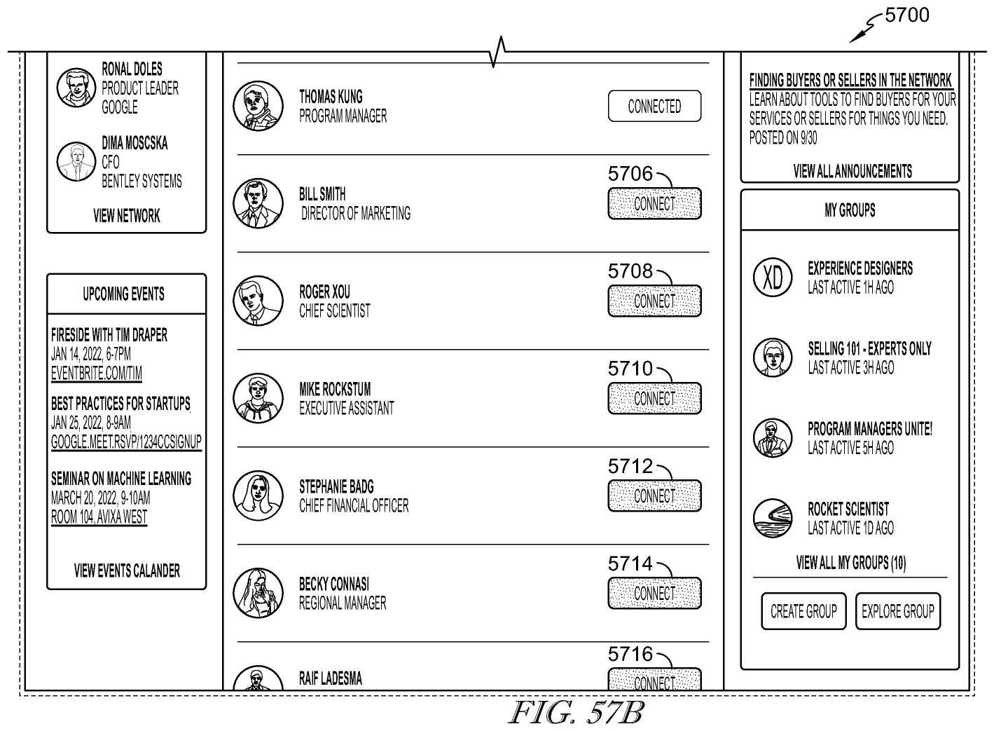

Referring now to FIGS. 54A and 54B, the system 100 may provide a user interface 5400 with a list of user groups 5402 that the present user is a member of. Alternatively, and referring now to FIGS. 55A and 55B, the system 100 may provide, in a user interface 5500, a list 5502 of all user groups (e.g., all user groups registered with the system 100 in association with a given simulated tradeshow experience associated with a particular hosting organization). For user groups that the present user in not already a member of, the list includes a corresponding user interface element 5504, 5506, 5508, 5510, 5512, 5514, 5516, to enable the user to request to join the user group. Referring now to FIGS. 56A and 56B, the system 100 may provide a user interface 5600 focusing on a particular user group (e.g., “VFX & THE GROUP”) selected by the user. In the user interface 5600, a user interface element 5602 includes the title of the group, an indication of the visibility of the group (e.g., private), the number of members in the group, a short description of the group, and options for posting or sharing content with the group (e.g., text, images, videos, documents, etc.). Additionally, the user interface 5600 includes a user interface element 5604 representing a list or feed of posts associated with the group. Referring now to FIGS. 57A and 57B, the system 100 may provide a user interface 5700 focusing on members within a selected group (e.g., “VFX & TECH GROUP”).

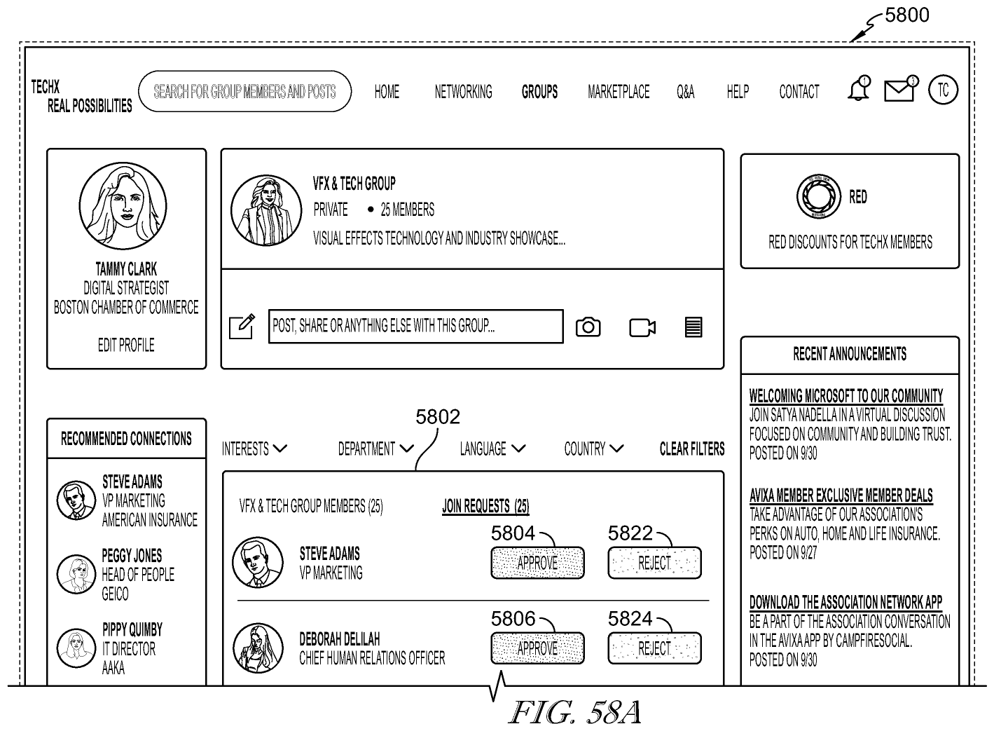

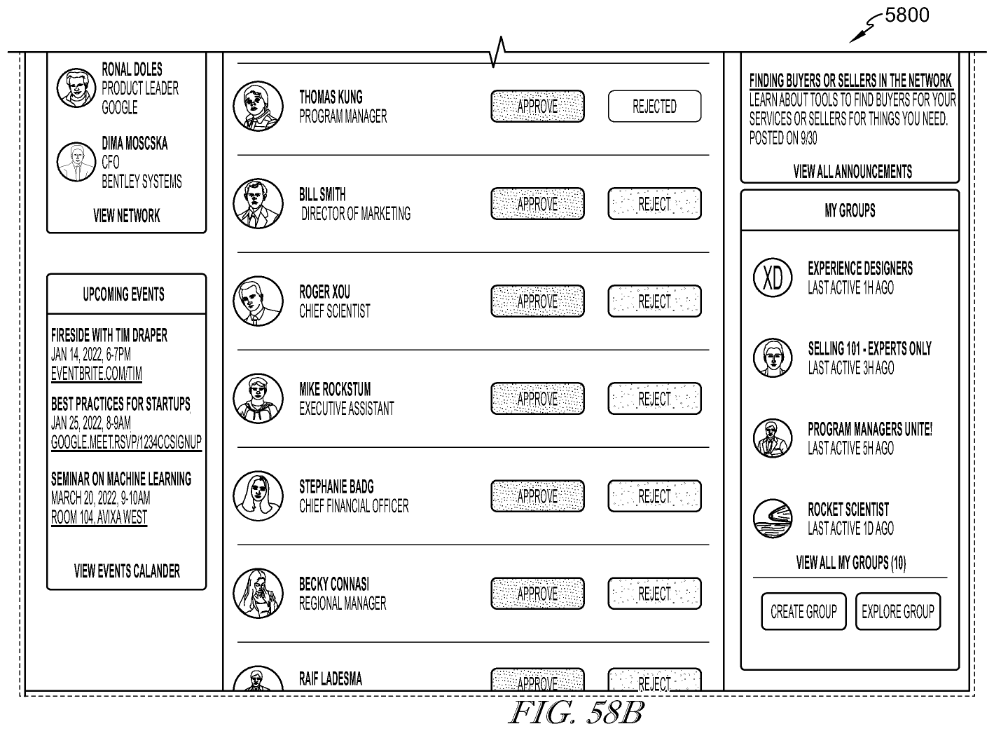

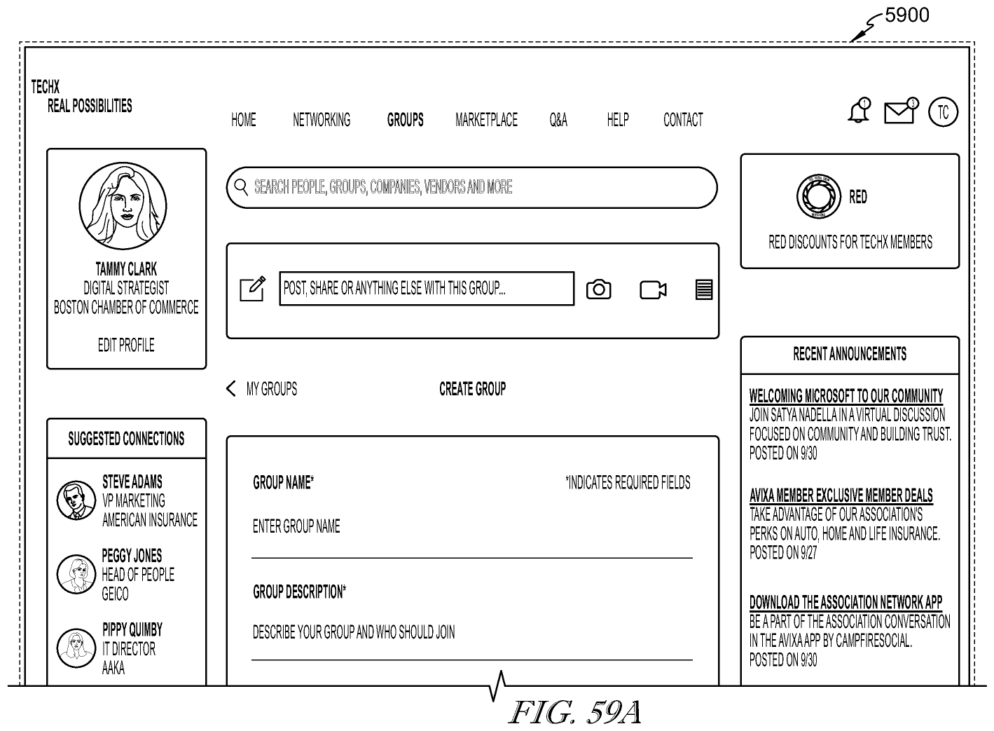

The user interface 5700 includes a user interface element 5702 representing a list of members within the selected group. The list may be filtered by various criteria, including interests, department, language, and/or country. Additionally, for each member that is not already connected with the present user, the list includes a corresponding user interface element 5704, 5706, 5708, 5710, 5712, 5714, 5716 that, when selected, causes a connection request to be sent to that member of the group. Relatedly, and as shown in FIGS. 58A and 58B, the system 100 may provide a user interface 5800 that includes a user interface element 5802 representing a list of join requests (e.g., requests to join the group) from users of the system 100. For each join request, the user interface 5800 includes a user interface element 5804, 5806, 5808, 5810, 5812, 5814, 5816, 5818, 5820 to approve the request (e.g., allowing the user to join the group) and a user interface element 5822, 5824, 5826, 5828, 5830, 5832, 5834, 5836, 5838 to reject the request (e.g., disallowing the user to join the group). Still focusing on user groups and with reference to FIGS. 59A and 59B, the system 100 may provide a user interface 5900 to enable a user to create a new user group. As shown, the user interface 5900 includes a set of user interface elements 5902, 5904, 5906, 5908, 5910, 5912, to collect data (e.g., to be submitted to the server compute device 110) to define properties of the user group, including the name of the group, a description of the group, interests associated with the group, one or more business categories associated with the group, a visibility of the group (e.g., public or private), and a photo to be associated with the group.

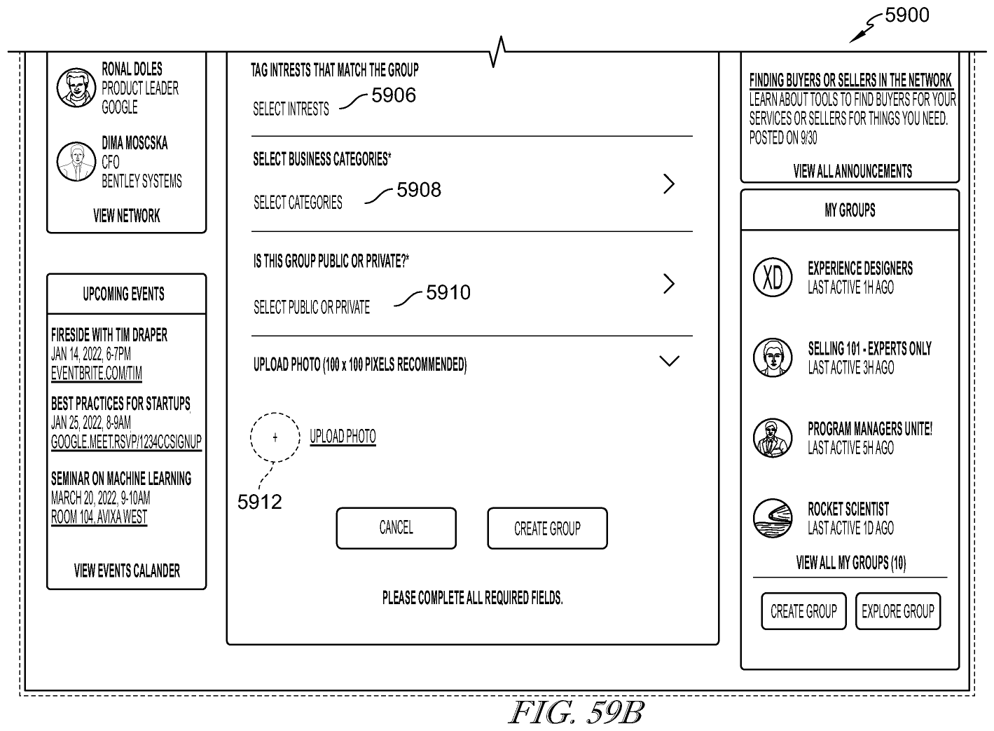

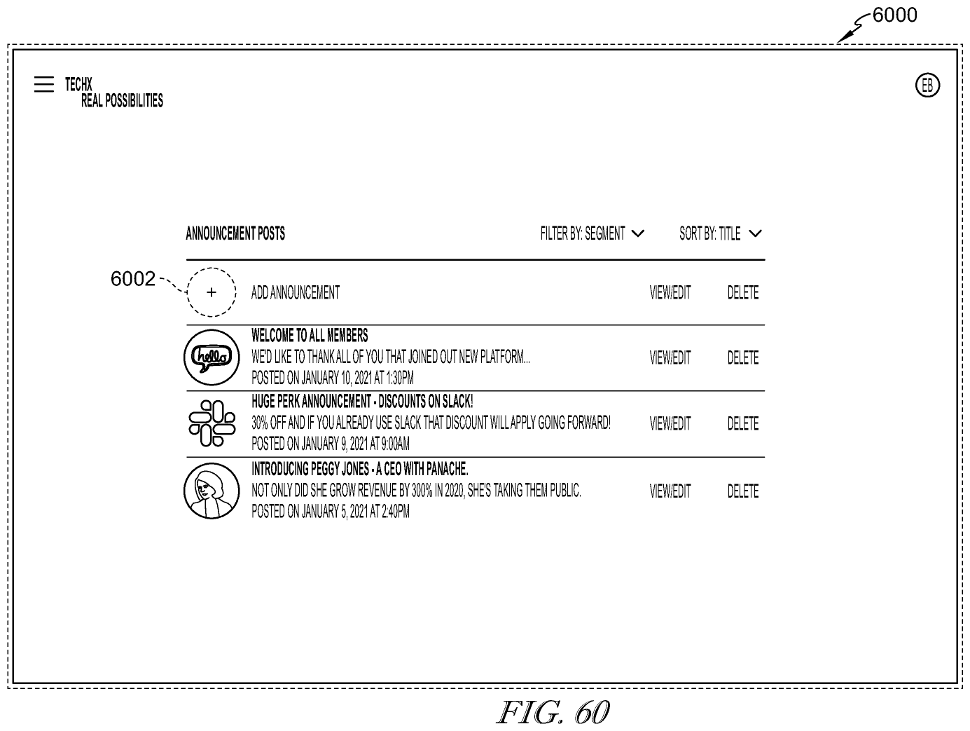

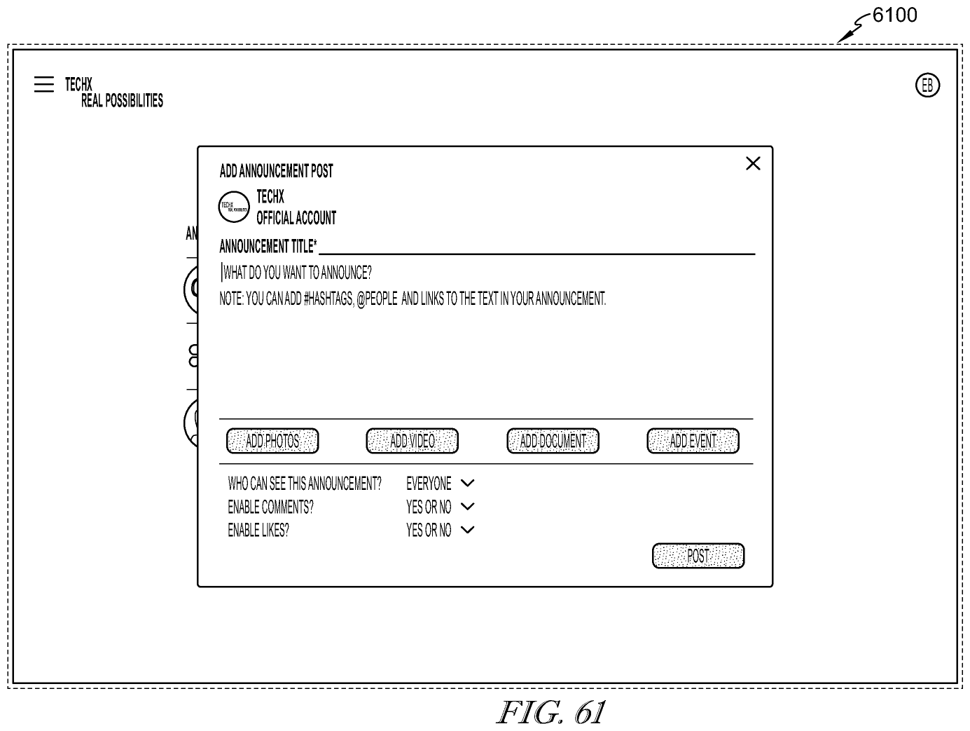

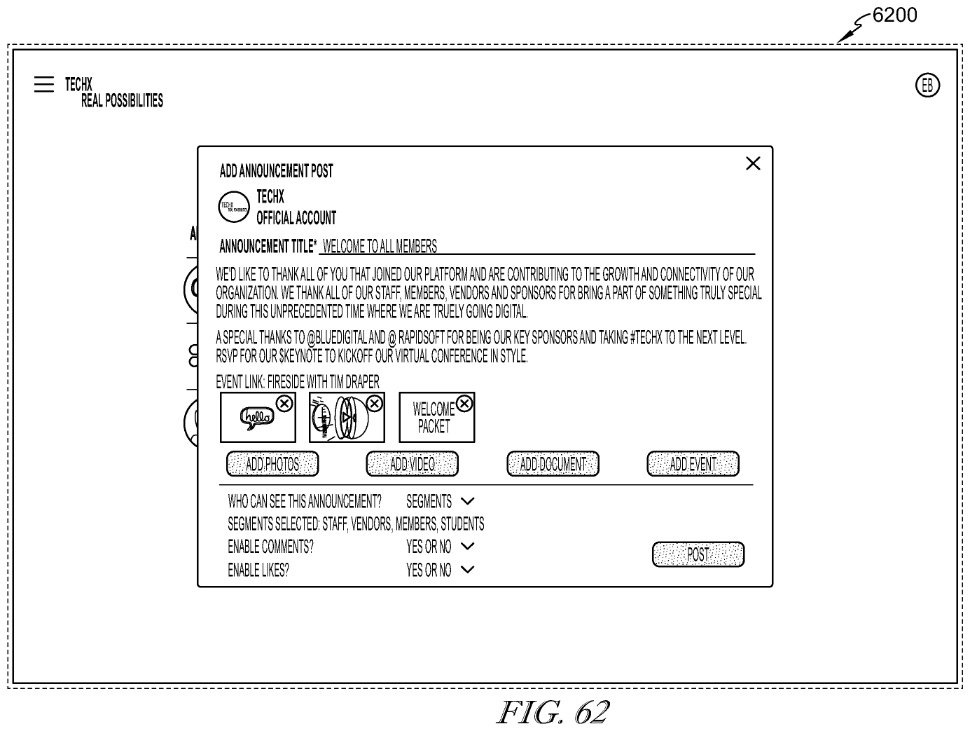

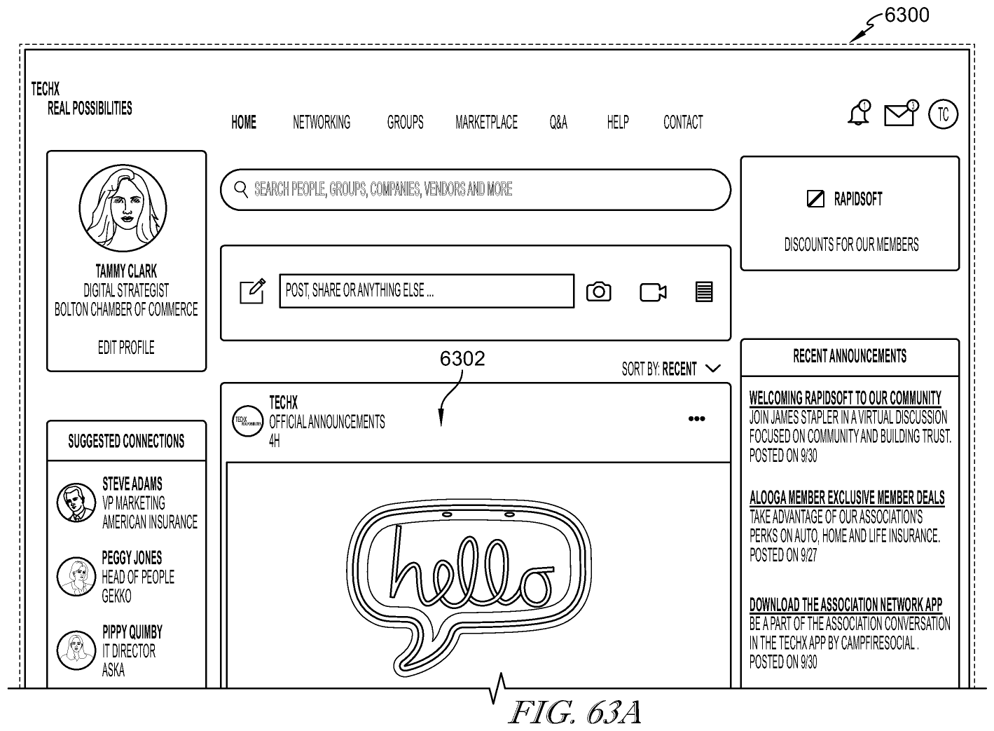

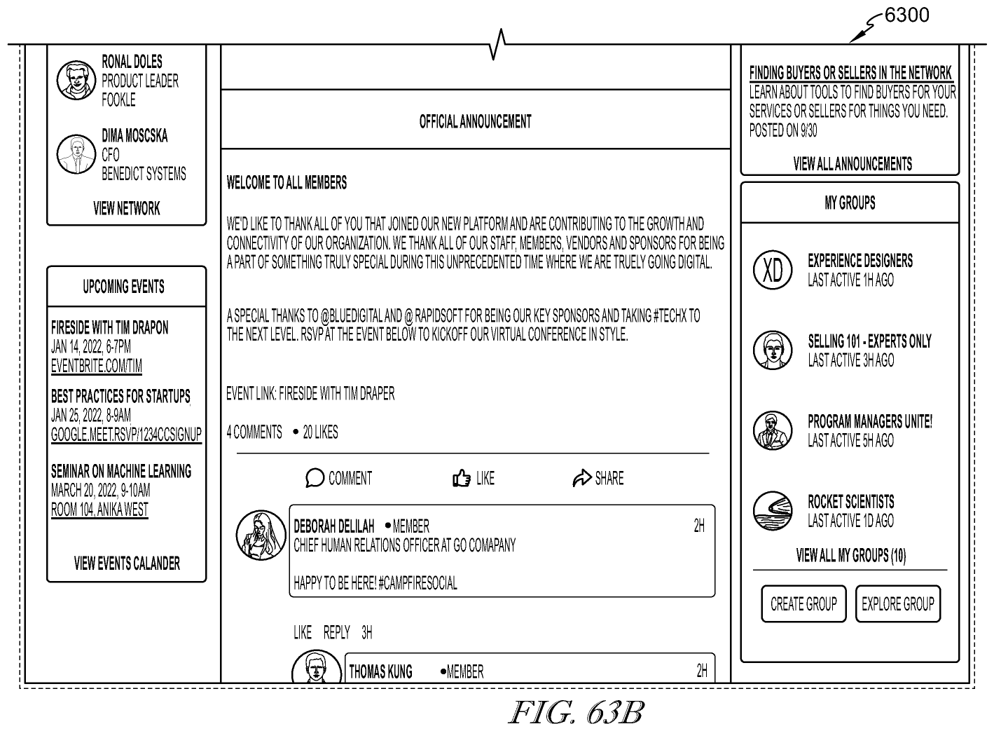

Referring now to FIG. 60, the system 100 may provide a user interface 6000 for managing announcements to users of the system 100. The user interface 6000 illustratively includes a list of announcements that have already been created and provides options to view, edit, and delete those announcements. The user interface 6000 also includes a user interface element 6002 for creating a new announcement. In response to a user's selection of the user interface element 6002, the system 100, in the illustrative embodiment, provides a user interface 6100 shown in FIG. 61, for defining properties of a new announcement. Referring now to FIG. 61, the user interface 6100 includes user interface elements 6102, 6104, 6106, 6108, 6110, 6112, 6114, 6116, 6118 for defining properties of the announcement, including the title, text associated with the announcement, any photos, videos, documents, or events to be associated with announcement, the visibility of the announcement, whether comments on the announcement will be allowed, and whether users will be allowed to indicate their approval (e.g., like) the announcement. Further, the user interface 6100 includes a user interface element 6120 to request that the announcement be posted (e.g., by the server compute device 110). Referring briefly to FIG. 62, a user interface 6200 is shown in which the properties of a new post have been defined and the announcement is ready to be posted. Referring now to FIG. 63, a user interface 6300 (e.g., a “home screen” user interface, similar to the user interface 2800 of FIGS. 28A and 28B) includes a feed in which the newly created post 6302 (e.g., from FIG. 62) is displayed.

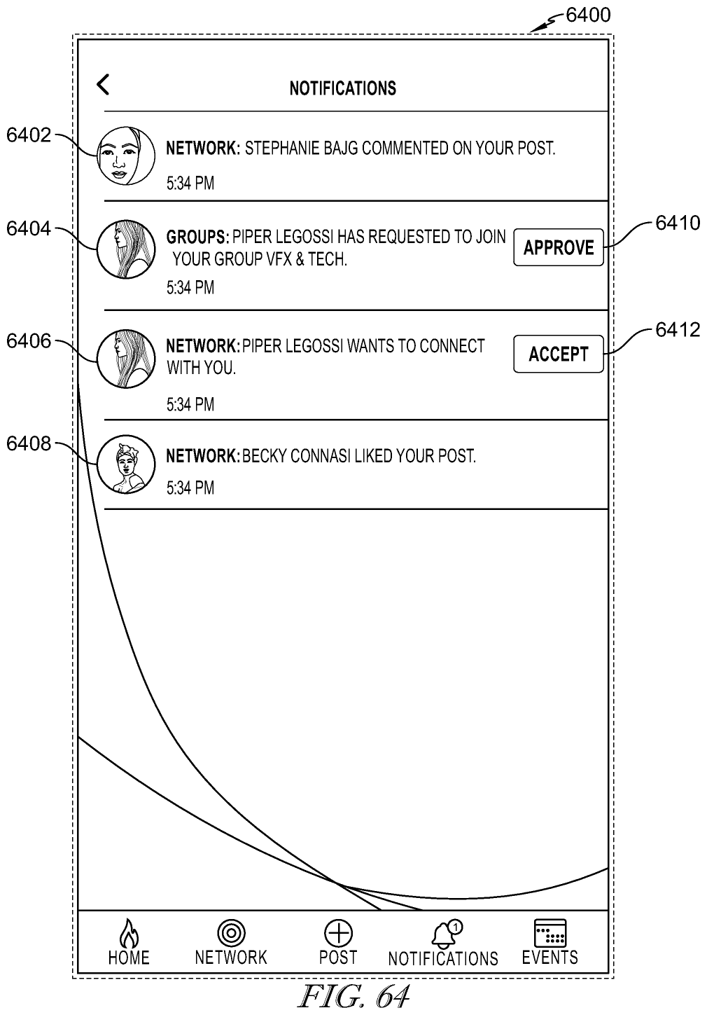

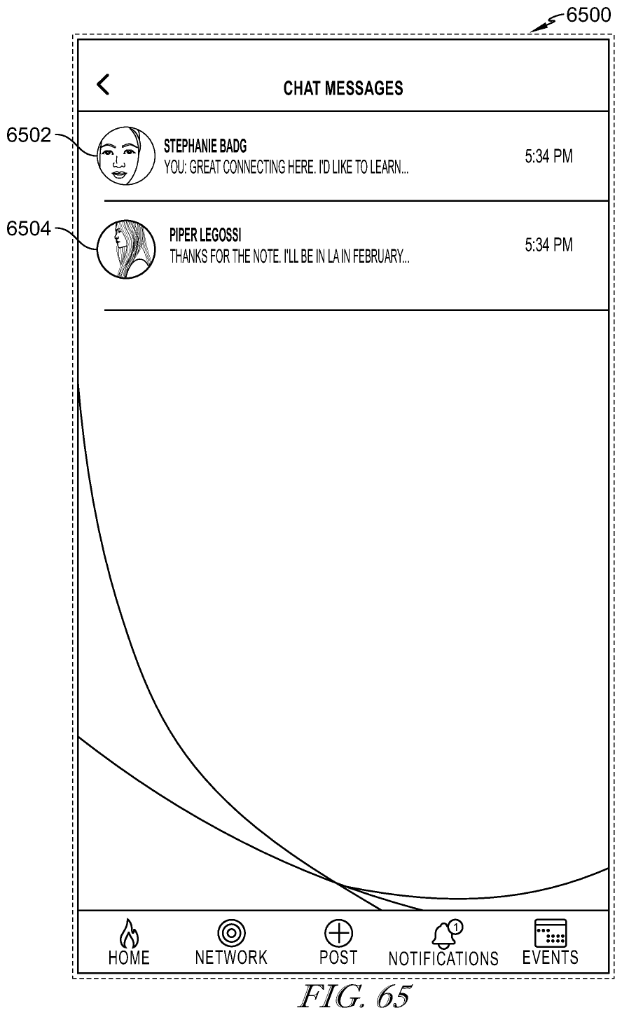

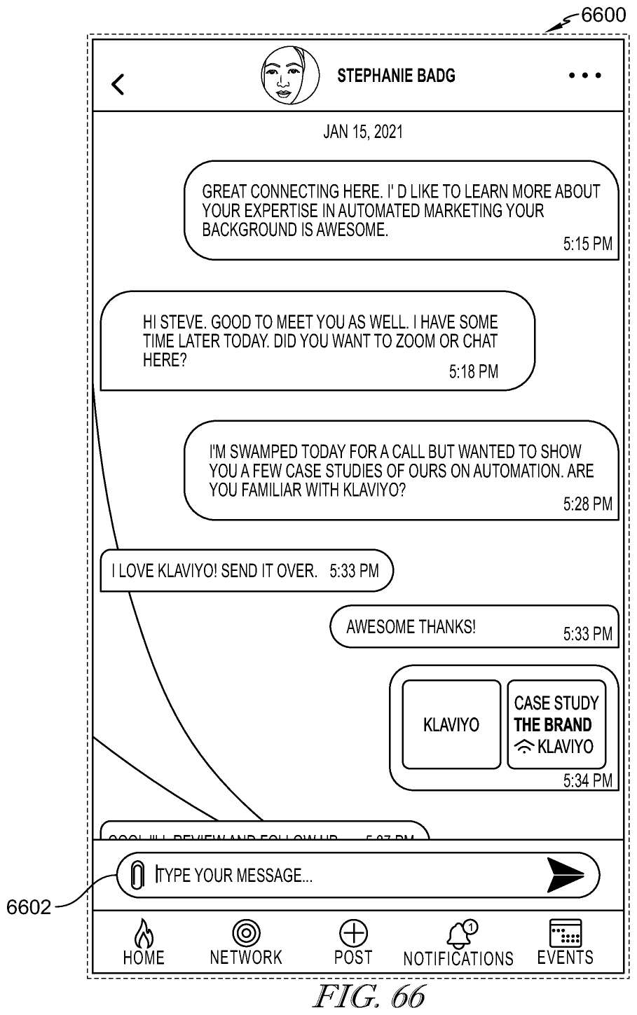

Referring now to FIG. 64, the system 100 may provide a user interface 6400 focusing on notifications for the present user. As shown, the user interface 6400 presents a set of notifications 6402, 6404, 6406, 6408 in a list and includes user interface elements 6410, 6412 to enable the user to act upon certain notifications. For example, the user interface element 6410, if selected, causes a user's request to join a user group to be approved and the user interface element 6412, if selected, causes a user's request to join the present user's network to be accepted (thereby causing the server compute device 110 to add that user to the present user's set of connections). Referring now to FIG. 65, the system 100 may provide a user interface 6500 that includes a list of chat messages 6502, 6504 received from other users. Each chat message 6502, 6504, in the illustrative embodiment is the latest message in a chat message thread with the corresponding user. In response to selection of a chat message (e.g., the chat message 6502), the system 100 provides a user interface 6600, shown in FIG. 66, that includes additional chat messages exchanged between users in the chat message thread, sorted in chronological order. A user interface element 6602 enables the present user to enter text and optionally include one or more attachments (e.g., photo(s), video(s), document(s)) for a new chat message.

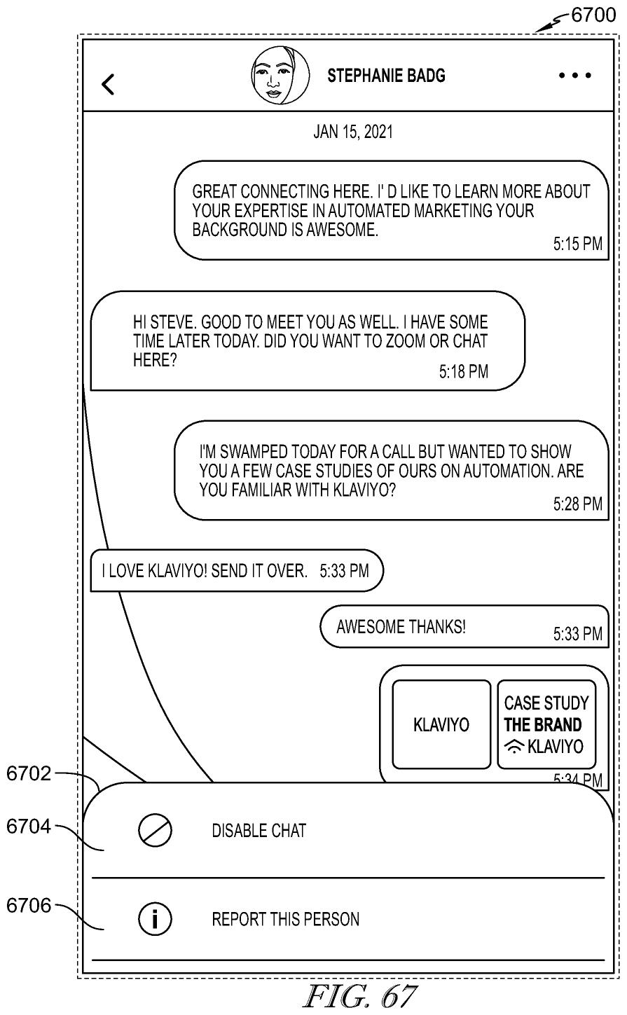

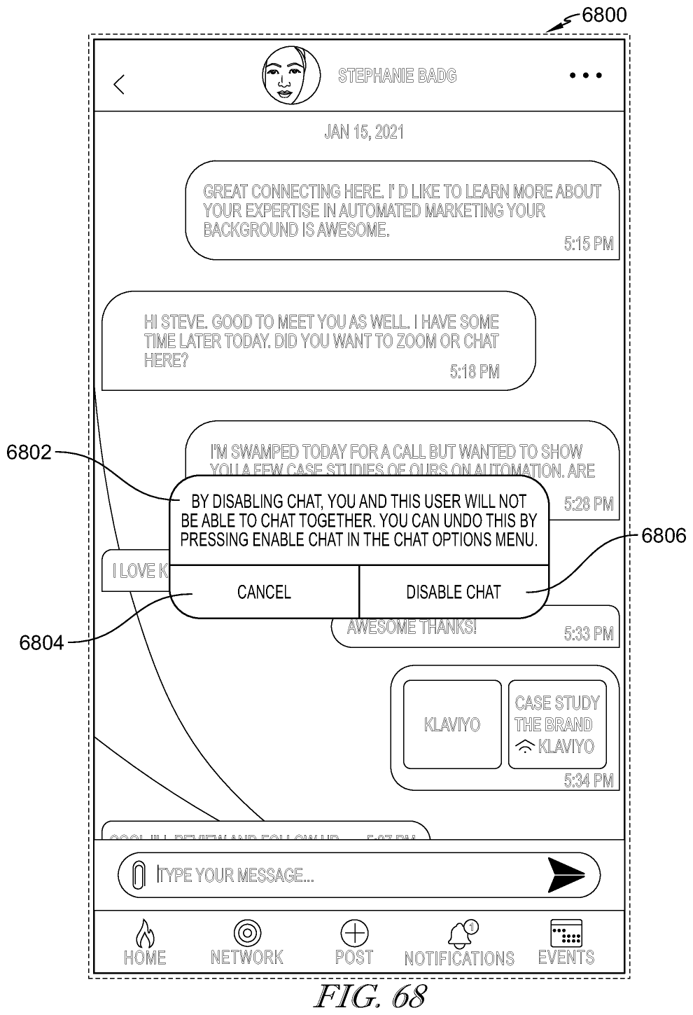

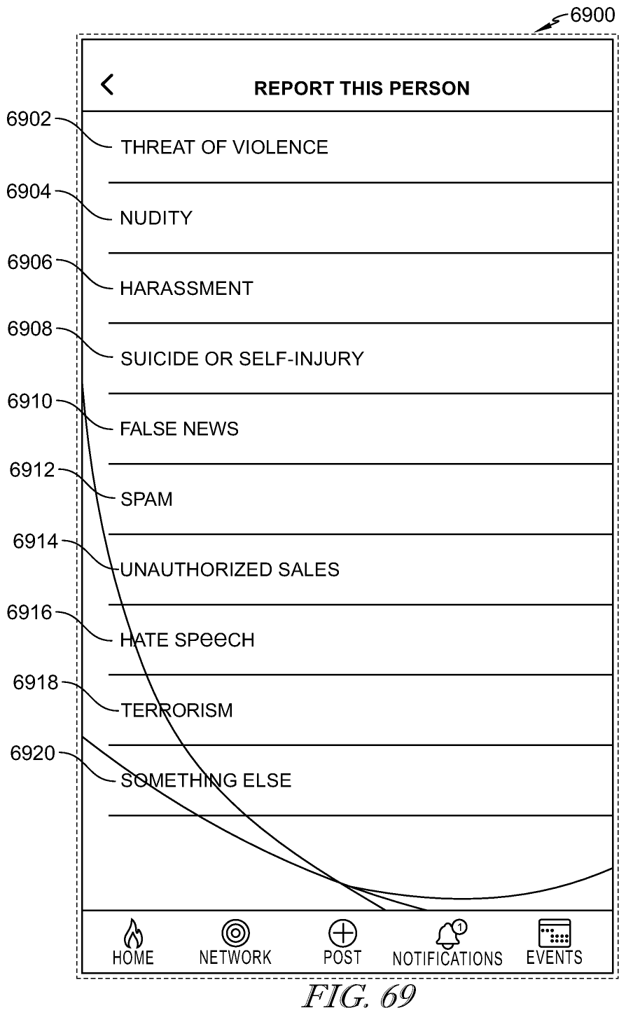

Still focusing on chats, the system 100 may provide a user interface 6700 having a user interface element 6702 with selectable options 6704, 6706 for disabling chat with a user and/or reporting a user. In response to selection of the option 6704 to disable chat with the user, the system 100, in the illustrative embodiment may provide a user interface 6800, shown in FIG. 68, having a user interface element 6802 in which a description of the implications of disabling chat is provided. Additionally, the user interface 6800 includes a user interface element 6804 for canceling a request to disable chat and another user interface element 6806 for confirming that chat with the user should be disabled. In response to the present user selecting to disable chat, the user will receive no further chat messages from the other user, unless and until the present user selects an option to enable chat with the other user. Referring back to FIG. 67, if the user selects the option 6706 to report the other person, the system 100 may provide a user interface 6900, shown in FIG. 69, providing a list of selectable reasons 6902, 6904, 6906, 6908, 6910, 6912, 6914, 6916, 6918, 6920 why the person is being reported. In the illustrative embodiment, data indicative of the selected reason is sent back to the server compute device 110 (e.g., for review by another user, such as an administrator) and the reported person's account with the system 100 may be removed, suspended, placed on a probationary status, and/or otherwise dealt with at the discretion of the reviewing user (e.g. administrator).

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. User interfaces for different form factors (e.g., relatively large screen, relatively small screen, etc.) are disclosed herein to demonstrate that the system 100 is capable of producing and adapting user interfaces to accommodate the features and limitations of the compute devices presenting them. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

1. A compute device comprising:
circuitry configured to:
obtain a set of roles for users to be associated with a platform for connections, content, and commerce, wherein the roles include a hosting organization, a vendor, and a professional; and
present, in a user interface that includes a visual reference to the hosting organization, content items provided by the vendor to be viewed by one or more professionals.

2. The compute device of claim 1, wherein to obtain a set of roles comprises to obtain a set of roles defined by the hosting organization.

3. The compute device of claim 1, wherein the circuitry is further configured to:
maintain, in a database, connection data indicative of connections among the users;
prevent communication of a chat message from a vendor to a professional in response to a determination that the connection data indicates that a connection does not exist between the vendor and the professional; and
communicate a chat message from the professional to the vendor regardless of whether a connection between the professional and the vendor is indicated in the connection data.

4. The compute device of claim 3, wherein the circuitry is further configured to enable the vendor to communicate a responsive chat message to the professional after the chat message from the professional has been communicated to the vendor.

5. The compute device of claim 3, wherein the circuitry is further configured to:
perform an analysis of an exchange of chat messages between the professional and the vendor; and
perform a sales transaction between the vendor and the professional based on the analysis of the exchange of chat messages between the professional and the vendor.

6. The compute device of claim 1, wherein the circuitry is further configured to:
analyze profile data associated with a set of the users, wherein the profile data is indicative of one or more professional interests of each corresponding user; and
provide, to a user of the set of users and as a function of the analysis of the profile data, (i) a recommendation to connect with another user, (ii) a recommendation to join a user group, or (iii) content that was submitted to the platform by another user.

7. The compute device of claim 1, wherein the circuitry is further configured to:
analyze a history of operations performed by a user of the platform; and
determine, as a function of the analysis of the history of operations performed by the user, an interest of the user.

8. The compute device of claim 7, wherein the circuitry is further to present to a user, in a feed, posts associated with a determined interest of the user.

9. The compute device of claim 1, wherein presenting content items comprises presenting one or more documents, images, videos, or descriptions of products or services sold by the vendor.

10. The compute device of claim 1, wherein the circuitry is further configured to provide, to a user, a user interface that includes a feed of posts associated with the platform.

11. The compute device of claim 1, wherein the circuitry is further configured to:
obtain, from a user, user group definition data indicative of a name for a user group and a set of professional interests associated with the user group; and
create, in response to obtaining the user group definition data, the corresponding user group.

12. The compute device of claim 11, wherein the circuitry is further to:
receive a post from a user in association with the user group;
store the received post in memory in association with the user group; and
provide the received post to other users of the user group.

13. The compute device of claim 1, wherein the circuitry is further to:
receive, from a user, a post to be communicated to other users in a feed; and
communicate the received post to other users in the feed.

14. The compute device of claim 13, wherein the received post includes topic designation data indicative of topic associated with the post.

15. The compute device of claim 14, wherein the topic designation data is a term prepended with a hashtag.

16. The compute device of claim 14, wherein the circuitry is further configured filter a feed as a function of topic designation data.

17. The compute device of claim 1, wherein the circuitry is further to:
enable the hosting organization to post an announcement and push a notification indicative of the announcement to one or more other users;
provide, to the users, an event listing;
enable a user to sponsor an event, a push notification, or a newsfeed;
embed a customer relationship management system to automate an onboarding process for a vendor or other user;
link to a learning management system of a hosting organization;
enable a user to create a request for proposals within the platform;
enable a user to submit a payment for a sponsorship within the platform;
scan a quick response (QR) code and download content associated with the QR code;
communicate with an electronic gift card company to send an electronic gift card from one user to another user in connection with a meeting invitation;
enable a user to pay membership fees to the hosting organization through the platform;
store, within a file system within a user dashboard of a user, chat(s) and/or video meeting(s) that occur through the platform among a set of users, and share the stored chat(s) and/or video meeting(s) with other users;
integrate video into content presented to users on the platform;
associate one or more project folders with a user group;
associate one or more user subgroups with a user group;
enable users to create a video group; and
provide vendor lead recommendations.

18. The compute device of claim 1, wherein the circuitry is further to:
present a first dashboard to a user, wherein the first dashboard provides data indicative of connections, vendor connections, progress notes regarding connections, trending content, key topics to follow, and influencers on the platform; and
present a second dashboard to a vendor, wherein the second dashboard provides data indicative of visitors to a digital storefront of the vendor, progress notes regarding connections, alerts to follow up on tasks, effectiveness of content provided by the vendor for viewing by other users, leads indicative of one or more users that the vendor is recommended to interact with based on a matchmaking algorithm, and platform search optimization data indicative of words to be embedded in a vendor profile to increase a search result ranking associated with the vendor.

19. A method comprising:
obtaining, by a compute device, a set of roles for users to be associated with a platform for connections, content, and commerce, wherein the roles include a hosting organization, a vendor, and a professional; and
presenting, by the compute device and in a user interface that includes a visual reference to the hosting organization, content items provided by the vendor to be viewed by one or more professionals.

20. One or more computer-readable storage media comprising a plurality of instructions that, when executed, cause a compute device to:
obtain a set of roles for users to be associated with a platform for connections, content, and commerce, wherein the roles include a hosting organization, a vendor, and a professional; and
present, in a user interface that includes a visual reference to the hosting organization, content items provided by the vendor to be viewed by one or more professionals.
